(19) United States
(12) Patent Application Publication
(10) Pub. No.: US 2026/0227510 A1
(43) Pub. Date: Aug. 6, 2026

(54) SYSTEM, METHOD, AND DEVICE FOR SUPPORTING COMMUNICATION AND SENSING

(71) Applicant: SAMSUNG ELECTRONICS CO., LTD., Suwon-si, Gyeonggi-do (KR)

(72) Inventors: Gibum KIM, Suwon-si (KR); Jinho CHOI, Suwon-si (KR); Kwonjong LEE, Suwon-si (KR)

(21) Appl. No.: 19/154,335

(22) PCT Filed: Feb. 8, 2024
(86) PCT No.: PCT/KR2024/001890

§ 371 Date: Aug. 6, 2025

(30) Foreign Application Priority Data
Feb. 8, 2023 (KR) 10-2023-0017048

(51) Int. Cl. G01S 17/00; G01S 13/06; H04W 72/0446; H04W 72/0453

(52) U.S. Cl. CPC G01S 17/003; G01S 13/06; H04W 72/0446; H04W 72/0453

(57) ABSTRACT

The present disclosure relates to a 5G or 6G communication system for supporting higher data transmission rates than 4G communication systems such as LTE. A method of a sensing management entity in a system supporting communication and sensing according to the present disclosure comprises the steps of: identifying a transmission role transmission and reception point (TRP) and a reception role TRP for a bistatic sensing operation and a monostatic TRP for a monostatic sensing operation; and transmitting sensing configuration information for configuration of a multistatic sensing operation to at least one of the transmission role TRP, the reception role TRP, and the monostatic TRP. The sensing configuration information comprises role information for the sensing and information on resource allocation for the sensing.

### TECHNICAL FIELD

The disclosure relates to a system, method, and device for supporting communication and sensing.

### BACKGROUND ART

Considering the development of wireless communication from generation to generation, the technologies have been developed mainly for services targeting humans, such as voice calls, multimedia services, and data services. Following the commercialization of 5G (5th-generation) communication systems, it is expected that the number of connected devices will exponentially grow. Increasingly, these will be connected to communication networks. Examples of connected things may include vehicles, robots, drones, home appliances, displays, smart sensors connected to various infrastructures, construction machines, and factory equipment. Mobile devices are expected to evolve in various form-factors, such as augmented reality glasses, virtual reality headsets, and hologram devices. In order to provide various services by connecting hundreds of billions of devices and things in the 6G (6th-generation) era, there have been ongoing efforts to develop improved 6G communication systems. For these reasons, 6G communication systems are referred to as beyond-5G systems.

6G communication systems, which are expected to be commercialized around 2030, will have a peak data rate of tera (1,000 giga)-level bps and a radio latency less than 100 μsec, and thus will be 50 times as fast as 5G communication systems and have the 1/10 radio latency thereof.

In order to accomplish such a high data rate and an ultra-low latency, it has been considered to implement 6G communication systems in a terahertz band (for example, 95 GHz to 3 THz bands). It is expected that, due to severer path loss and atmospheric absorption in the terahertz bands than those in mmWave bands introduced in 5G, technologies capable of securing the signal transmission distance (that is, coverage) will become more crucial. It is necessary to develop, as major technologies for securing the coverage, radio frequency (RF) elements, antennas, novel waveforms having a better coverage than orthogonal frequency division multiplexing (OFDM), beamforming and massive multiple input multiple output (MIMO), full dimensional MIMO (FD-MIMO), array antennas, and multiantenna transmission technologies such as large-scale antennas. In addition, there has been ongoing discussion on new technologies for improving the coverage of terahertz-band signals, such as metamaterial-based lenses and antennas, orbital angular momentum (OAM), and reconfigurable intelligent surface (RIS).

Moreover, in order to improve the spectral efficiency and the overall network performances, the following technologies have been developed for 6G communication systems: a full-duplex technology for enabling an uplink transmission and a downlink transmission to simultaneously use the same frequency resource at the same time; a network technology for utilizing satellites, high-altitude platform stations (HAPS), and the like in an integrated manner; an improved network structure for supporting mobile base stations and the like and enabling network operation optimization and automation and the like; a dynamic spectrum sharing technology via collision avoidance based on a prediction of spectrum usage; an use of artificial intelligence (AI) in wireless communication for improvement of overall network operation by utilizing AI from a designing phase for developing 6G and internalizing end-to-end AI support functions; and a next-generation distributed computing technology for overcoming the limit of UE computing ability through reachable super-high-performance communication and computing resources (such as mobile edge computing (MEC), clouds, and the like) over the network. In addition, through designing new protocols to be used in 6G communication systems, developing mechanisms for implementing a hardware-based security environment and safe use of data, and developing technologies for maintaining privacy, attempts to strengthen the connectivity between devices, optimize the network, promote softtwarization of network entities, and increase the openness of wireless communications are continuing.

It is expected that research and development of 6G communication systems in hyper-connectivity, including person to machine (P2M) as well as machine to machine (M2M), will allow the next hyper-connected experience. Particularly, it is expected that services such as truly immersive extended reality (XR), high-fidelity mobile hologram, and digital replica could be provided through 6G communication systems. In addition, services such as remote surgery for security and reliability enhancement, industrial automation, and emergency response will be provided through the 6G communication system such that the technologies could be applied in various fields such as industry, medical care, automobiles, and home appliances.

### DETAILED DESCRIPTION OF THE INVENTION

### Technical Problem

This disclosure relates to a method and device for providing multistatic sensing in a system supporting communication and sensing.

### Technical Problem

A method of a sensing management entity in a system supporting communication and sensing, according to an embodiment of the disclosure, comprises identifying a transmission role transmission and reception point (TRP) and a reception role TRP for a bistatic sensing operation, and a monostatic TRP for a monostatic sensing operation, and transmitting sensing configuration information for configuring a multistatic sensing operation to at least one of the transmission role TRP, the reception role TRP, or the monostatic TRP. The sensing configuration information includes role information for the sensing and information about resource allocation for the sensing.

A sensing management entity in a system supporting communication and sensing, according to an embodiment of the disclosure, comprises memory and a processor connected to the memory. The processor is configured to identify a transmission role transmission and reception point (TRP) and a reception role TRP for a bistatic sensing operation, and a monostatic TRP for a monostatic sensing operation, and transmit sensing configuration information for configuring a multistatic sensing operation to at least one of the transmission role TRP, the reception role TRP, or the monostatic TRP. The sensing configuration information includes role information for the sensing and information about resource allocation for the sensing.

### BRIEF DESCRIPTION OF DRAWINGS

FIG. 1 is a block diagram illustrating a communication system according to an embodiment of the disclosure.

FIG. 2A is a view illustrating a basic structure of a time-frequency domain in a wireless communication system according to an embodiment of the disclosure.

FIG. 2B is a view illustrating the structures of a frame, a subframe, and a slot in a wireless communication system according to an embodiment of the disclosure.

FIG. 3 illustrates a JCAS system according to an embodiment of the disclosure.

FIG. 4 illustrates a multistatic sensing structure of a JCAS system according to an embodiment of the disclosure.

FIG. 5A illustrates a sensing procedure in a JCAS system according to an embodiment of the disclosure.

FIG. 5B illustrates a sensing procedure in a JCAS system according to an embodiment of the disclosure.

FIGS. 6A and 6B illustrate an example of resource allocation for sensing according to an embodiment of the disclosure.

FIG. 7A is a view illustrating an example of interference generated in a multistatic sensing structure according to an embodiment of the disclosure.

FIG. 7B is a view illustrating an example of interference generated in a multistatic sensing structure according to an embodiment of the disclosure.

FIG. 7C illustrates an example of sensing resource allocation for removing interference according to an embodiment of the disclosure.

FIG. 7D illustrates an example of sensing resource allocation for removing interference according to an embodiment of the disclosure.

FIG. 8A illustrates an example of sensing configuration information according to an embodiment of the disclosure.

FIG. 8B illustrates an example of sensing configuration information according to an embodiment.

FIG. 8C illustrates an example of sensing configuration information for a periodic transmission mode according to an embodiment.

FIG. 8D illustrates an example of sensing configuration information according to an embodiment.

FIG. 9A illustrates a sensing configuration procedure according to an embodiment of the disclosure.

FIG. 9B illustrates a sensing configuration procedure according to an embodiment of the disclosure.

FIG. 10A illustrates a sensing configuration procedure according to an embodiment of the disclosure.

FIG. 10B illustrates a sensing configuration procedure according to an embodiment of the disclosure.

FIG. 11 illustrates a sensing configuration procedure according to an embodiment of the disclosure.

FIG. 12A illustrates a sensing configuration procedure using system information (SI) according to an embodiment of the disclosure.

FIG. 12B illustrates a sensing configuration procedure using system information (SI) according to an embodiment of the disclosure.

FIG. 13A illustrates an example of sensing resource allocation according to an embodiment of the disclosure.

FIG. 13B illustrates an example of sensing resource allocation according to an embodiment of the disclosure.

FIG. 13C illustrates an example of sensing resource allocation according to a periodic transmission mode according to an embodiment of the disclosure.

FIG. 14A illustrates a sensing procedure according to a periodic transmission mode according to an embodiment of the disclosure.

FIG. 14B illustrates a sensing procedure according to a periodic transmission mode according to an embodiment of the disclosure.

FIG. 15A illustrates a sensing configuration procedure according to an embodiment of the disclosure.

FIG. 15B illustrates a sensing configuration procedure according to an embodiment of the disclosure.

FIG. 16 illustrates a sensing result reporting procedure according to an embodiment of the disclosure.

FIG. 17A illustrates a sensing result reporting procedure according to an embodiment of the disclosure.

FIG. 17B illustrates a sensing result reporting procedure according to an embodiment of the disclosure.

FIG. 18 illustrates a sensing result reporting procedure according to an embodiment of the disclosure.

FIG. 19A illustrates a sensing result reporting procedure according to an embodiment of the disclosure.

FIG. 19B illustrates a sensing result reporting procedure according to an embodiment of the disclosure.

FIG. 20 illustrates a configuration of a sensing result report according to an embodiment of the disclosure.

FIG. 21A illustrates a configuration of a sensing result report according to an embodiment of the disclosure.

FIG. 21B illustrates a configuration of a sensing result report according to an embodiment of the disclosure.

FIG. 22 illustrates a sensing result reporting procedure for cooperative sensing according to an embodiment of the disclosure.

FIG. 23A illustrates a sensing result reporting procedure according to an embodiment of the disclosure.

FIG. 23B illustrates a sensing result reporting procedure according to an embodiment of the disclosure.

FIG. 24 is a view illustrating a downlink (DL) communication operation of a UE in a JCAS system according to an embodiment of the disclosure.

FIG. 25 is a view illustrating an uplink (UL) communication operation of a UE in a JCAS system according to an embodiment of the disclosure.

FIG. 26 illustrates a method of a sensing unit according to an embodiment of the disclosure.

FIG. 27 is a view illustrating an example configuration of a UE according to an embodiment of the disclosure.

FIG. 28 is a view illustrating an example configuration of a base station according to an embodiment of the disclosure.

FIG. 29 is a view illustrating an example configuration of a sensing unit according to an embodiment of the disclosure.

### MODE FOR CARRYING OUT THE INVENTION

In describing embodiments, the description of technologies that are known in the art and are not directly related to the present invention is omitted. This is for further clarifying the gist of the present disclosure without making it unclear.

For the same reasons, some elements may be exaggerated or schematically shown. The size of each element does not necessarily reflects the real size of the element. The same reference numeral is used to refer to the same element throughout the drawings.

Advantages and features of the present disclosure, and methods for achieving the same may be understood through the embodiments to be described below taken in conjunction with the accompanying drawings. However, the present invention is not limited to the embodiments disclosed herein, and various changes may be made thereto. The embodiments disclosed herein are provided only to inform one of ordinary skilled in the art of the category of the present disclosure. The present invention is defined only by the appended claims. The same reference numeral denotes the same element throughout the specification. When determined to make the subject matter of the present invention unclear, the detailed description of the known art or functions may be skipped. The terms as used herein are defined considering the functions in the present disclosure and may be replaced with other terms according to the intention or practice of the user or operator. Therefore, the terms should be defined based on the overall disclosure.

It should be appreciated that the blocks in each flowchart and combinations of the flowcharts may be performed by computer program instructions. Since the computer program instructions may be equipped in a processor of a general-use computer, a special-use computer or other programmable data processing devices, the instructions executed through a processor of a computer or other programmable data processing devices generate means for performing the functions described in connection with a block(s) of each flowchart. Since the computer program instructions may be stored in a computer-available or computer-readable memory that may be oriented to a computer or other programmable data processing devices to implement a function in a specified manner, the instructions stored in the computer-available or computer-readable memory may produce a product including an instruction means for performing the functions described in connection with a block(s) in each flowchart. Since the computer program instructions may be equipped in a computer or other programmable data processing devices, instructions that generate a process executed by a computer as a series of operational steps are performed over the computer or other programmable data processing devices and operate the computer or other programmable data processing devices may provide steps for executing the functions described in connection with a block(s) in each flowchart.

Further, each block may represent a module, segment, or part of a code including one or more executable instructions for executing a specified logical function(s). Further, it should also be noted that in some replacement embodiments, the functions mentioned in the blocks may occur in different orders. For example, two blocks that are consecutively shown may be performed substantially simultaneously or in a reverse order depending on corresponding functions.

As used herein, the term “unit” means a software element or a hardware element such as a field-programmable gate array (FPGA) or an application specific integrated circuit (ASIC). A unit plays a certain role. However, ‘unit’ is not limited to software or hardware. A ‘unit’ may be configured in a storage medium that may be addressed or may be configured to execute one or more processors. Accordingly, as an example, a ‘unit’ includes elements, such as software elements, object-oriented software elements, class elements, and task elements, processes, functions, attributes, procedures, subroutines, segments of program codes, drivers, firmware, microcodes, circuits, data, databases, data architectures, tables, arrays, and variables. Functions provided within the components and the ‘units’ may be combined into smaller numbers of components and ‘units’ or further separated into additional components and ‘units’. Further, the components and ‘units’ may be implemented to execute one or more CPUs in a device or secure multimedia card. According to embodiments, a “ . . . unit” may include one or more processors.

As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order).

For ease of description, some of the terms or names defined in the 3rd generation partnership project (3GPP) standards (standards for 5G, new radio (NR), long-term evolution (LTE), or similar systems) may be used. However, the disclosure is not limited by such terms and names and may be likewise applicable to systems conforming to other standards. Further, the disclosure is not limited to the terms used in the following embodiments, and the terms may be replaced with other terms denoting objects with equivalent technical meanings.

### [Communication System]

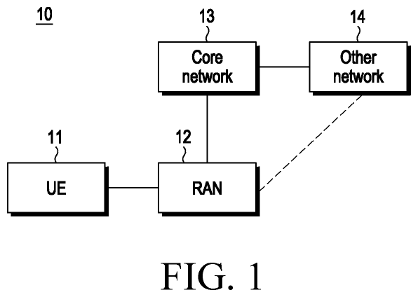

FIG. 1 is a block diagram illustrating a communication system according to an embodiment of the disclosure.

Referring to FIG. 1, a communication system 10 may include a user equipment (UE) 11, a radio access network (RAN) 12, a core network (CN) 13, and/or another network 14.

The UE 11 may be a user device capable of performing communication functions. For example, the UE 11 may include a user equipment (UE), a mobile station (MS), a wireless transmit/receive unit (WTRU), a cellular phone, a smartphone, a machine type communication (MTC) device, a computer, a wireless sensor, a vehicle, an IoT device, and/or other electronic devices capable of performing communication functions. The UE 11 may communicate with other UEs or with one or more network nodes within the radio access network 12.

The radio access network 12 is a next-generation radio access network (e.g., 6G, or later radio access network, etc.) or a legacy radio access network (e.g., 5G (NR), 4G (e.g., LTE), 3G, etc.). The radio access network 12 (or network node(s) within the radio access network 12) may communicate with one or more network nodes in the core network 13 and the UE 11. Further, the radio access network 12 may optionally communicate with another network 13.

The radio access network 12 may include one or more network nodes (e.g., base station (BS)). The base station is an entity that performs resource allocation of the UE 11, and may be a radio base station, a nodeB, an evolved node B (eNodeB or eNB), a next-generation node B (gNodeB or gNB), a radio access unit, a network node, a network device, a node on a network, a base station controller, a transmission point (TP), an access point (AP), a relay station, a base band unit (BBU), a remote radio unit (RU), a remote radio head (RH), or a transmit and receive point (TRP). As an embodiment, the base station may be divided into a central unit (CU) and at least one distribute unit (DU) controlled/managed by the CU. In the disclosure, downlink (DL) refers to a wireless transmission path of signal transmitted from the base station to the UE 11, and uplink (UL) refers to a wireless transmission path of signal transmitted from the UE 11 to the base station. In the disclosure, the base station or a component (e.g., CU or DU) of the base station may be referred to as a TRP. In the disclosure, the operation of the base station itself or a divided component (e.g., CU or DU) of the base station may be understood of the operation of the base station.

The core network 13 is part of the communication system 10 and may be dependent on or independent from the radio access technology (RAT) used in the communication system 10.

According to an embodiment, the core network 13 may be a 5G core network (5GC). According to an embodiment, the 5GC may include an access and mobility management function (AMF) for managing access and mobility of the UE 11, a session management function (SMF) for managing a packet data unit (PDU) session of the UE 11, a user plane function (UPF) connected to a data network (DN) to perform a data transfer role, a policy control function (PCF) for providing a policy control function, a user data management (UDM) for providing data management functions such as subscriber data and policy control data, a unified data repository (UDR) for storing data of various network functions (NFs), a network slice selection function (NSSF) for selecting network slice instances for servicing the UE 11, and/or a network slice admission control function (NSACF) for monitoring and controlling the number of registered UEs and PDU sessions.

According to an embodiment, the core network 13 may be a core network (e.g., 6G core network, 4G (LTE) core network, etc.) other than 5GC. In this case, the core network 13 may include a network function (node) that performs the same or similar functions as the network functions (nodes) of the 5GC described above.

The other network 14 is a network other than the core network 13 and may communicate with at least one network node within the core network 13. Further, the other network 14 may communicate with at least one network node of the radio access network 12. As an embodiment, the other network 14 may be a data network, a network providing an application function (AF) that provides an application service, or an Internet network.

### [Time-Frequency Resource]

The frame structure of a wireless communication system (e.g., a 5G system) is described below in more detail with reference to the drawings.

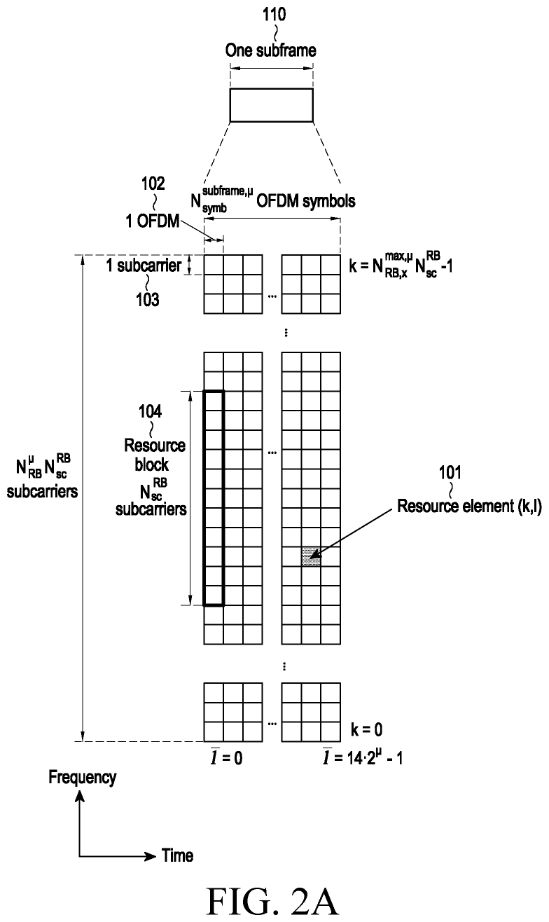

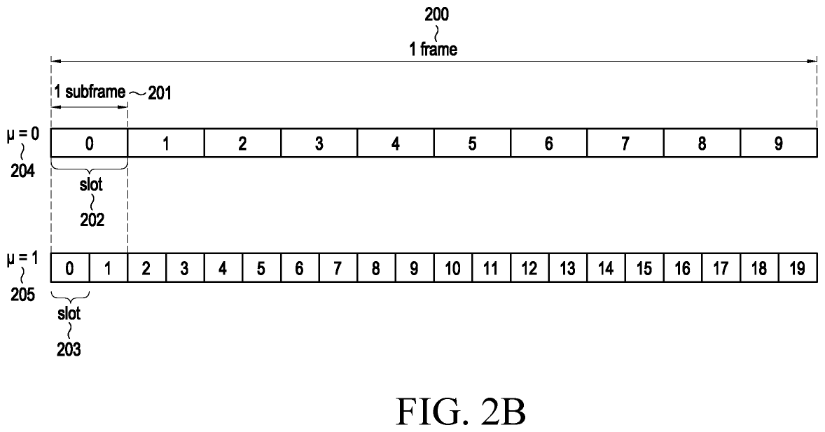

FIG. 2A is a view illustrating a basic structure of a time-frequency domain in a wireless communication system according to an embodiment of the disclosure.

In FIG. 2A, the horizontal axis refers to the time domain, and the vertical axis refers to the frequency domain. A basic unit of a resource in the time and frequency domain is a resource element (RE) 101, which may be defined by one orthogonal frequency division multiplexing (OFDM) symbol 102 on the time axis, and by one subcarrier 103 on the frequency axis. In the frequency domain.

$${N}_{SC}^{RB} ( e . g . , 12 )$$

consecutive REs may constitute one resource block (RB) 104. In FIG. 2A,

$${N}_{symb}^{subframe , μ}$$

is the number of OFDM symbols per subframe 110 for subcarrier spacing setting (u).

FIG. 2B is a view illustrating the structures of a frame, a subframe, and a slot in a wireless communication system according to an embodiment of the disclosure.

FIG. 2B illustrates example structures of a frame 200, a subframe 201, and a slot 202. One frame 200 may be defined as 10 ms. One subframe 201 may be defined as 1 ms, and thus, one frame 200 may consist of a total of 10 subframes 201. One slot 202 or 203 may be defined as 14 OFDM symbols (that is, the number

$$( {N}_{symb}^{slot} )$$

of symbols per slot=14). One subframe 201 may be composed of one or more slots 202 and 203, and the number of slots 202 and 203 per subframe 201 may differ depending on u (204 or 205), which is a set value for the subcarrier spacing. FIG. 2 illustrates an example in which the subcarrier spacing setting value μ=0 (204) and an example in which the subcarrier spacing setting value μ=1 (205). When μ=0 (204), one subframe 201 may consist of one slot 202, and when μ=1 (205), one subframe 201 may consist of two slots (203). In other words, according to the set subcarrier spacing value u, the number

$$( {N}_{symb}^{subframe , μ} )$$

of slots per subframe may vary, and accordingly, the number

$$( {N}_{slot}^{frame , μ} )$$

of slots per frame may differ. According to each subcarrier spacing μ,

$${N}_{symb}^{subframe , μ} and {N}_{slot}^{frame , μ}$$

may be defined in Table 1 below.

TABLE 1

| μ | ${N}_{symb}^{slot}$ | ${N}_{slot}^{frame , μ}$ | ${N}_{slot}^{subframe , μ}$ |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |
| 5 | 14 | 320 | 32 |

### [Joint Communications and Sensing (JCAS) System/Network]

Below, a system that performs both communication and sensing is described. For example, a system that integrates communication and sensing functions into a single system is described. The system that performs both communication and sensing may be referred to as a JCAS system, but the term denoting the system is not limited thereto. For example, the JCAS system may be referred to by other terms, such as an integrated sensing and communication (ISAC) system, a joint sensing and communications (JSAC) system, a radar and communication (Radcom) system, or a dual functional radar communication (DFRC) system.

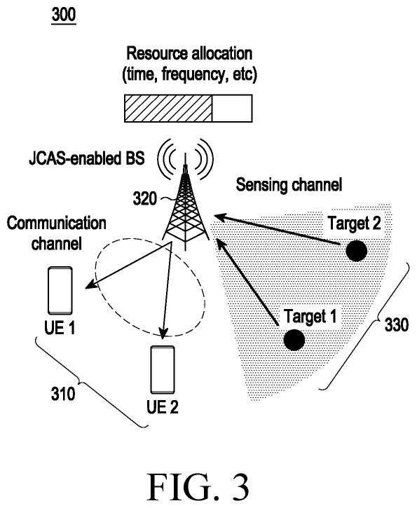

FIG. 3 illustrates a JCAS system according to an embodiment of the disclosure.

The JCAS system 300 of FIG. 3 may not only provide a communication function provided by the communication system 10 of FIG. 1, but may also provide an additional function for providing sensing and an additional function for providing communication and sensing together.

Referring to FIG. 3, the JCAS system 300 may include at least one UE 310 (e.g., UE1, UE2, etc.), at least one base station 320, and/or at least one target 330 (e.g., target 1, target 2, etc.).

The UE 310 may be an electronic device supporting a communication function and/or a sensing function. As an embodiment, the UE 310 may include a UE, an MS, a wireless transmit/receive unit, a cellular phone, a smartphone, an MTC device, a computer, a wireless sensor, a vehicle, an IoT device, and/or an electronic device capable of performing other communication functions and/or sensing functions.

The UE 310 according to an embodiment may communicate with another UE or may communicate with a network (JCAS network) of the JCAS system 300 using a communication function. For example, like, e.g., the UE 11 of FIG. 1, the UE 310 may communicate with another UE or may communicate with one or more network nodes (e.g., the base station 320) in the radio access network of the JCAS system 300. For example, the UE 310 may receive a communication signal (DL signal) from the base station 320 through a communication channel and may transmit the communication signal (UL signal) to the base station 320.

The UE 310 according to an embodiment may further support a sensing function. For example, the UE 310 may receive a sensing signal from the base station 320 through a sensing channel and may perform a sensing operation based on the sensing signal. For example, the UE 310 may transmit the sensing signal through the sensing channel. For example, the UE 310 may receive a reflection of the sensing signal transmitted from the base station 320 or another UE through the sensing channel, and may perform a sensing operation based on the received reflection (reflection signal).

According to an embodiment, the UE 310 may be a device registered in the JCAS network.

The base station 320 may be a network node that integrates and supports communication and sensing functions. The base station 320 that integrates and supports such communication and sensing functions may be referred to as a JCAS-enabled BS, a JSAC-enabled BS, or an ISAC-enabled BS. In an embodiment, the base station 320 is an entity performing resource allocation for communication and sensing of the UE 310 and may be a wireless base station, a NodeB, an eNB, a radio access unit, a network node, a network device, a node on a network, a base station controller, a TP, an AP, a relay station, a BBU, an RRU, an RRH, a CU, a DU, or a TRP.

According to an embodiment, the base station 320 may communicate with the UE 310 or may communicate with a core network or another network of the JCAS system 300 using a communication function. For example, the base station 320 may transmit a communication signal (DL signal) to the UE 310 through a communication channel and may receive the communication signal (UL signal) from the UE 310. The core network of the JCAS system 300 may include at least one network node for supporting a communication function (service) and a sensing function (service). According to an embodiment, the core network of the JCAS system 300 may be the 5G core network 5GC. As an embodiment, the 5GC may include an AMF, an SMF, a UPF, a PCF, a UDM, a UDR, an NSSF, and/or an NSACF, and the description of each NF may refer to the description of FIG. 1. According to an embodiment, the core network of the JCAS system 300 may be a core network (e.g., a 6G core network, a 4G (LTE) core network, etc.) other than 5GC. In this case, the corresponding core network may include a network function (node) that performs the function identical or similar to those of the network functions (nodes) of the 5GC described above.

The base station 320 according to an embodiment may support a sensing function. For example, the base station 320 may transmit information (e.g., resource allocation information (e.g., time resource allocation information and/or frequency resource allocation information) of the sensing signal) required to perform sensing. For example, the base station 320 may transmit a sensing signal through a sensing channel. For example, the base station 320 may receive a reflection of the sensing signal transmitted from itself, another base station, or the UE 310 through a sensing channel, and may perform a sensing operation based on the received reflection (reflection signal).

The target 330 is an entity to be sensed and may be a UE (e.g., the UE 11 of FIG. 1 or the UE 310 of FIG. 3) having a communication function or an object (e.g., a person, a thing, a building, a vehicle, etc.) not having a communication function. The base station 320 (or the UE 310) may transmit a sensing signal to the target 330 through a sensing channel. The base station 320 (or the UE 310) may receive a reflection (reflection signal) reflected from the target 330 and may perform a sensing operation based on the reflection signal. In this case, the reflection signal may be a reflection of a sensing signal transmitted by itself or a reflection of a sensing signal transmitted by another device (e.g., another base station or another UE).

According to an embodiment, sensing may be performed by, e.g., an individual device such as a single base station 320 or a single UE 310 (monostatic case). According to an embodiment, sensing may be performed jointly by a plurality of devices, e.g., a base station pair, a UE pair, or a UE/base station pair (bistatic case). According to an embodiment, sensing may be performed by an individual device and/or a combination of a plurality of devices jointly performing sensing (multistatic case).

According to an embodiment, the sensing signal (reflection signal) reflected from the target 330 may be used to generate sensing data for the target 330.

The sensing data may include information (sensing information) that may be derived from the reflection signal. According to an embodiment, the sensing information may include information that may be measured from a signal strength, a delay, a timing, an angle of arrival (AoA), a time of flight (ToF), and/or other reflection signals.

Further, the sensing data may further include a description of the sensing data, information for identifying a purpose of sensing, information for identifying a source of sensing, and/or information (e.g., target identification information, target location information, etc.) on a target associated with the sensing data.

According to an embodiment, sensing data (or sensing information) may be used to generate a sensing result for the target. According to an embodiment, the sensing result may include information about a distance, a location, and/or a speed (doppler) with respect to the target.

Table 2 shows an example of an element and a formula for determining a distance and a speed through sensing.

TABLE 2

| Metric | Category | Determined by | Formula |
|---|---|---|---|
| Range | Maximum | FFT SIZE: | R [symbol] = R [symbol] · N_{FFT} |
| | Resolution | Bandwidth | R [symbol] = [symbol] · BW) |
| Doppler | Maximum | interval between adjacent OFDM symbol | $\text{?}$ |
| | Resolution | Accumulated duration of OFDM symbols for Doppler processing | $\text{?}$ |

[symbol]

indicates data missing or illegible when filed

Referring to Table 2, a resolution (Rres) of a range that may be measured through a sensing operation may be determined based on a bandwidth (BW). The maximum range (max range) of the range that may be measured through the sensing operation may be determined based on the resolution (Rres) and/or the FFT size (NFFT). Referring to Equation 2 of Table 2, as the bandwidth BW increases, the maximum range/range resolution may be enhanced. Meanwhile, sensing processing requires a continuous frequency/bandwidth due to its characteristics. Accordingly, the maximum continuous frequency/bandwidth available in the base station 320 needs to be used for sensing.

Referring to Table 2, the maximum value of the speed (doppler) that may be measured through a sensing operation may be determined based on the interval

$$( {T}_{sens}^{sym} )$$

between adjacent OFDM symbols allocated for sensing. For example, as the interval

$$( {T}_{sens}^{sym} )$$

decreases, the maximum speed (maximum doppler) may be enhanced. The resolution of the speed that may be measured through the sensing operation may be determined based on the duration

$$( {T}_{sens}^{accum} )$$

of the accumulated OFDM symbols for Doppler processing. Referring to the equation in Table 2, as the duration

$$( {T}_{sens}^{accum} )$$

increases, the speed resolution (doppler resolution) may be enhanced. Therefore, considering the doppler requirements, an appropriate sensing signal transmission period needs to be set. As an embodiment, the duration

$$( {T}_{sens}^{accum} )$$

may be associated with the number of symbols for Doppler processing.

According to an embodiment, the processing chain (e.g., PHY processing chain) for communication (communication signal) may be the same as, or different from, the processing chain for sensing (sensing signal). For example, the same modulation parameter, coding parameter, and/or waveform parameter may be used for communication and sensing. For example, different modulation parameters, coding parameters and/or waveform parameters may be used for communication and sensing.

According to an embodiment, the RAT for communication may be the same as, or different from, the RAT for sensing.

According to an embodiment, the same carrier (frequency carrier) or different carriers may be used for communication and sensing.

According to an embodiment, different signal formats (structures) may be used for communication and sensing. For example, the sensing signal structure may be different from the communication signal structure.

According to an embodiment, separate PHY channels or a common PHY channel may be used for communication and sensing. For example, separate PHY control channels (e.g., PDCCH and PUCCH) and separate PHY data channels (e.g., PDSCH and PUSCH) may be used for communication and sensing, respectively. For example, a common PHY control channel (e.g., PDCCH or PUCCH) may be used for communication and sensing. When a common PHY control channel is used for communication and sensing, the PHY data channel (e.g., PDSCH or PUSCH) may be used separately or commonly used for communication and sensing.

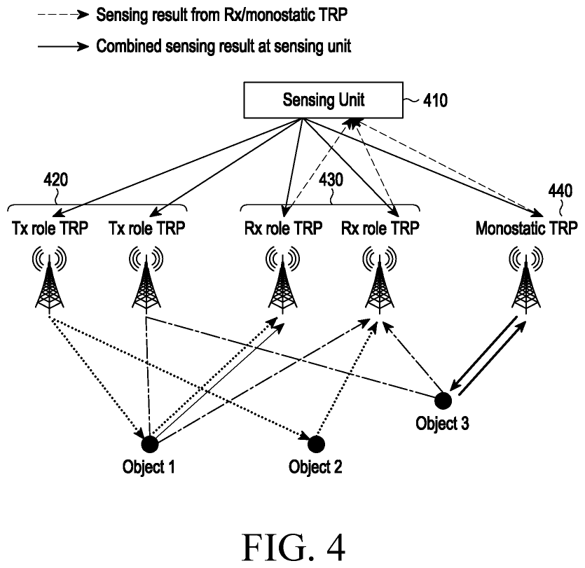

FIG. 4 illustrates a multistatic sensing structure of a JCAS system according to an embodiment of the disclosure.

The sensing structure of the JCAS system may be classified into the following sensing structures according to geometry.

The monostatic sensing structure corresponds to a sensing structure in which the transmission function and the reception function for sensing are disposed in the same device (or position). In a monostatic sensing structure according to an embodiment, a transmitter transmitting a sensing signal and a receiver receiving the sensing signal may be included in the same device (e.g., a base station). In the case of a monostatic sensing structure according to an embodiment, one device may transmit a sensing signal, receive a sensing signal reflected from a target, and perform a sensing operation based on the same. In the case of such a monostatic sensing structure, the transmitted sensing signal may act as self-interference. Thus, a method for canceling self-interference needs to be considered.

The bistatic sensing structure corresponds to a sensing structure in which a transmission function and a reception function for sensing are disposed in different devices (or positions). In the bistatic sensing structure according to an embodiment, a transmitter transmitting a sensing signal and a receiver receiving the sensing signal may be included in different devices (e.g., a base station or a DU). In the case of a bistatic sensing structure according to an embodiment, a first device may transmit a sensing signal, and a second device different from the first device may receive the sensing signal reflected from the target, and the first device and/or the second device may perform a sensing operation based on the same. In the case of such a bistatic sensing structure, it is necessary to consider a method for synchronization between two devices that respectively perform the transmission/reception function of sensing signals. Hereinafter, various embodiments of the disclosure are described based on two devices being synchronized with each other. In the disclosure, in the bistatic sensing structure, a device that performs a role of transmitting a sensing signal is referred to as a transmission (Tx) role device or a transmission role TRP, and a device that receives a sensing signal may be referred to as a reception (Rx) role device or a reception role TRP. In the disclosure, a sensing mode following the bistatic sensing structure may be referred to as a bistatic sensing mode.

The multistatic sensing structure corresponds to a sensing structure in which a plurality of transmission functions and a plurality of reception functions for sensing are disposed in different devices (or positions). The multistatic sensing structure according to an embodiment may be a combination of monostatic and bistatic sensing structures. For example, a JCAS system using a multistatic sensing structure may include at least one monostatic TRP, at least one transmission role TRP, and at least one reception role TRP. In the case of a multistatic sensing structure, cooperative sensing using the plurality of TRPs is possible, and through this, robustness for sensing may be secured. However, in the case of a multistatic sensing structure, a plan for more complex synchronization compared to a bistatic sensing structure needs to be considered. Hereinafter, various embodiments of the disclosure are described based on synchronization being established between JCAS systems using a multistatic sensing structure. In the disclosure, a sensing mode following the multistatic sensing structure may be referred to as a multistatic sensing mode.

Referring to FIG. 4, a JCAS system 400 using a multistatic sensing structure/mode may include a sensing unit (SU) 410, at least one transmission role TRP 420, at least one reception role TRP 430, and/or at least one monostatic TRP 440. However, embodiments are not limited thereto, and the types and numbers of TRPs included in the JCAS system 400 for multistatic sensing may vary.

The JCAS system 400 according to an embodiment is an example of the JCAS system 300 of FIG. 3, supports all or some of functions of the JCAS system 300, and may further support additional functions for a multistatic sensing mode.

According to an embodiment, the transmission role TRP 420, the reception role TRP 430, and the monostatic TRP 440 of the JCAS system 400 fully or partially support functions supported by the TRP/base station 320 of the JCAS system 300 of FIG. 3, and may further support additional functions for the multistatic sensing mode.

In the multistatic sensing structure, the sensing unit 410 is a higher-level component of the TRP and may designate the role of the TRP according to the type of sensing operation (e.g., monostatic type or bistatic type).

According to an embodiment, the sensing unit 410 may designate at least one monostatic TRP 440 for performing a monostatic type sensing operation/mode.

In the monostatic sensing structure/mode, the monostatic TRP 440 may transmit a sensing signal, receive a sensing signal reflected from a target (e.g., object 3), and obtain a sensing result and/or sensing data based on the received sensing signal. The monostatic TRP 440 may transmit the sensing result and/or sensing data to the sensing unit 410.

According to an embodiment, the monostatic TRP 440 may be a base station-level (e.g., gNB-level) device or a device at a lower level (e.g., DU-level) than the base station.

According to an embodiment, the sensing unit 410 may designate at least one transmission role TRP 420 and at least one reception role TRP 430 for performing a bistatic type sensing operation/mode. As an embodiment, the sensing unit 410 may associate one transmission role TRP 420 with a plurality of reception role TRPs 430 for bistatic sensing. As an embodiment, the sensing unit 410 may associate a plurality of transmission role TRPs 420 with one reception role TRP 430 for bistatic sensing.

In the bistatic sensing structure/mode, the transmission role TRP 420 may transmit a sensing signal. The reception role TRP 430 may receive a sensing signal reflected from a target (e.g., objects 1 and 2), and may obtain a sensing result and/or sensing data based on the received sensing signal. The reception role TRP 430 may transmit a sensing result and/or sensing data to the sensing unit 410.

According to an embodiment, the transmission role TRP 420 and the reception role TRP 430 may be base station-level devices (e.g., gNB-level). In this case, in one bistatic sensing structure, a base station (transmission role base station (e.g., Tx role gNB)) corresponding to the transmission role TRP 420 and a base station (reception role base station (e.g., Rx role gNB)) corresponding to the reception role TRP 430 may be different base stations.

According to an embodiment, the transmission role TRP 420 and the reception role TRP 430 may be lower-level (e.g., DU-level) devices of the base station. In this case, in one bistatic sensing structure, a DU (transmission role DU) corresponding to the transmission role TRP 420 and a DU (reception role DU) corresponding to the reception role TRP 430 may be DUs belonging to the same base station. For example, the transmission role DU and the reception role DU may be separate DUs (e.g., separate DUs present at different positions) controlled/managed by one CU.

According to an embodiment, the sensing unit 410 may generate sensing configuration information and notify designated TRPs of the generated sensing configuration information.

According to an embodiment, the sensing unit 410 may receive a sensing result from TRPs and transmit the corresponding sensing result or a combined sensing result to the TRPs. For example, the sensing unit 410 may receive a sensing result from the reception role TRP 430 and transmit the sensing result to the transmission role TRP 420 associated with the reception role TRP 430. For example, the sensing unit 410 may receive sensing results from the reception role TRP 430 and the monostatic TRP 440 respectively, and transmit the combined sensing result to all of the TRPs.

The sensing unit 410 according to an embodiment may be a CU. For example, when the transmission role TRP 420, the reception role TRP 430, and the monostatic TRP 440 are DUs belonging to the same base station (or CU, or gNB), the sensing unit 410 may be a CU that manages/controls the DUs.

The sensing unit 410 according to an embodiment may be an entity at a higher level than the base station. For example, when the transmission role TRP 420, the reception role TRP 430, and the monostatic TRP 440 are base station-level devices, the sensing unit 410 may be a higher-level entity of the base station. The higher-level entity of the base station may be an entity of the core network connected to the base station (e.g., AMF or a newly defined network function (NF)). When a new NF for performing a function of the sensing unit 410 is defined, the NF may request the AMF to transfer the notification/report when the notification/report is required.

The sensing unit 410 according to an embodiment may be a specific base station. For example, if the transmission role TRP 420, the reception role TRP 430, and the monostatic TRP 440 are base station-level devices, it may be one of the transmission role TRP 420, the reception role TRP 430, and the monostatic TRP 440.

Hereinafter, various embodiments of the multi-sensing structure/mode are described with reference to each drawing. For example, in the multistatic sensing structure/mode, a method for setting the role of TRP for sensing is described. Further, a method for generating sensing configuration information for multistatic sensing and providing it to TRP and/or UE is described. Further, a method for transferring a sensing result and/or sensing data by the TRP to a sensing unit is described. Further, the operation of the UE in the multistatic sensing structure/mode is described.

### [Sensing Procedure]

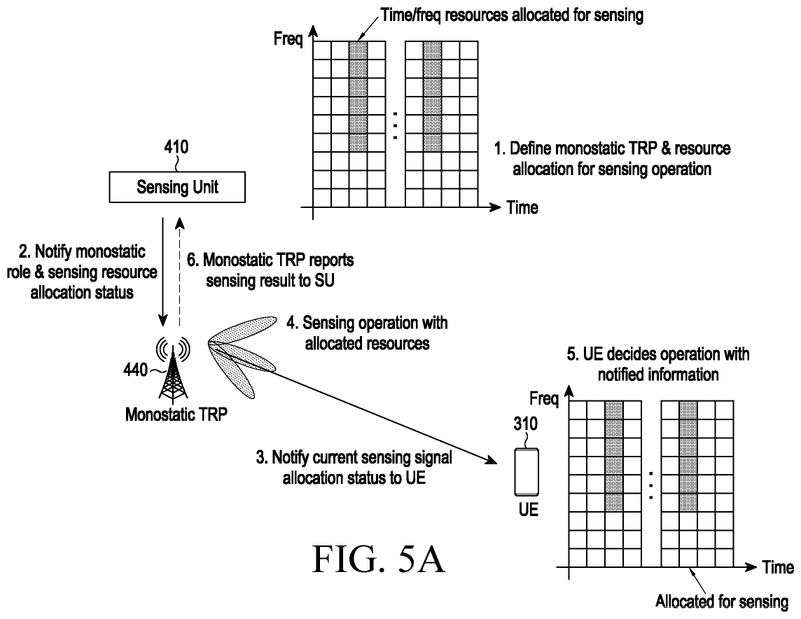

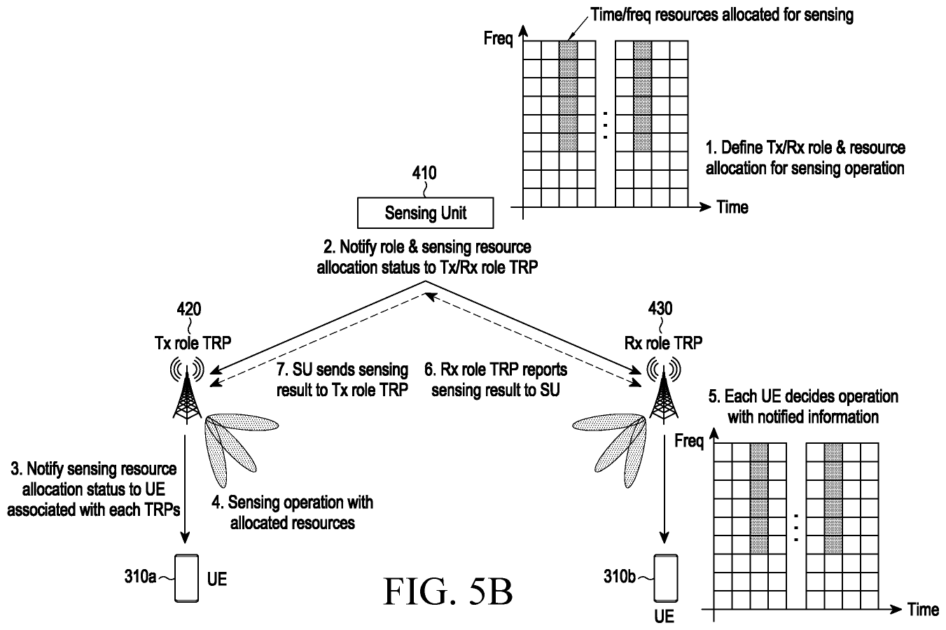

FIG. 5A illustrates a sensing procedure in a JCAS system according to an embodiment of the disclosure.

FIG. 5A may illustrate an example of a sensing procedure (monostatic sensing procedure in a multistatic sensing structure) through the monostatic TRP 440 in the multistatic sensing structure.

The monostatic sensing procedure in the multistatic sensing structure may include at least one of the following operating features:

The SU 410 may designate at least one monostatic TRP 440. The SU 410 may allocate resources for sensing.

The SU 410 may notify the designated monostatic TRP 440 of information about resource allocation (sensing resource allocation information) for sensing together with role information.

The monostatic TRP 440 may notify at least one UE 310 of sensing resource allocation information. In this case, unlike a general communication system (e.g., the communication system 10 of FIG. 1), the UE 310 may perform an operation different from the existing communication operation in the resource area (or section) allocated for sensing using the notified sensing resource allocation information.

The monostatic TRP 440 may transmit a sensing signal, receive a sensing signal reflected from a target, and obtain sensing data and/or a sensing result based on the sensing signal.

The monostatic TRP 440 may transfer the sensing data and/or the sensing result to the SU 410.

Hereinafter, an example sensing procedure in a JCAS system is described with reference to FIG. 5A.

Referring to FIG. 5A, in operation 1, a SU 410 may designate a monostatic TRP 440 for monostatic sensing.

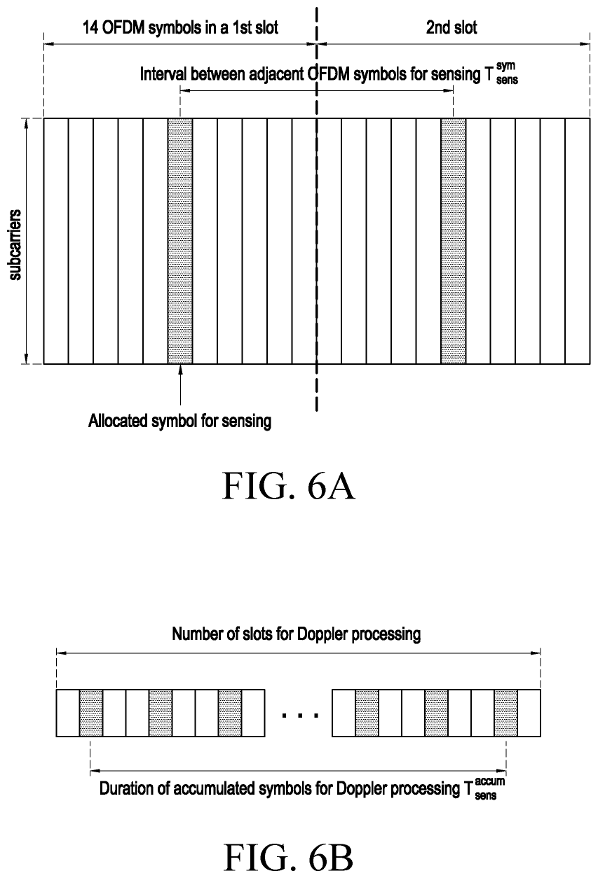

Further, the SU 410 may perform resource allocation for sensing. For example, the SU 410 may allocate time and frequency resources for sensing (or sensing signals). An example of allocation of time and frequency resources for sensing may be as illustrated in FIGS. 6A and 6B. According to an embodiment, the sensing resource may not overlap the communication resource.

In operation 2, the SU 410 may notify the monostatic TRP 440 of information about a monostatic TRP role (role information) and information about resource allocation for sensing (sensing resource allocation information). According to an embodiment, the SU 410 may transmit sensing configuration information including role information and sensing resource allocation information to the monostatic TRP 440. The role information may include information indicating that the corresponding TRP is designated as a monostatic TRP.

In operation 3, the monostatic TRP 440 may notify the UE 310 of sensing resource allocation information. For example, the monostatic TRP 440 may transmit sensing configuration information including sensing resource allocation information to the UE 310. As an embodiment, the sensing resource allocation information may include information about time and frequency resources for sensing (or sensing signal) allocated in operation 1. Accordingly, the UE 310 may be notified of a current sensing signal allocation status for the sensing signal.

In operation 4, the monostatic TRP 440 may perform a sensing operation using resources (e.g., time and frequency resources) allocated for sensing. For example, the monostatic TRP 440 may transmit a sensing signal using time and frequency resources allocated for sensing. As an embodiment, the monostatic TRP 440 may transmit the sensing signal through at least one beam. The monostatic TRP 440 may receive a reflection (reflection signal) of the sensing signal (reflection signal) reflected from the target (e.g., the UE 310 or the target 330 of FIG. 3) and may obtain sensing data and/or a sensing result based on the reflection signal.

In operation 5, the UE 310 may determine an operation to be performed using the received/notified information (e.g., sensing resource allocation information, sensing configuration information, etc.). For example, the UE 310 may identify the time and frequency resources allocated for sensing based on the sensing resource allocation information, and may perform an operation (e.g., a communication operation and/or a sensing operation) based on the identified time and frequency resources.

According to an embodiment, the UE 310 may disregard time and frequency resources (or signals received through the corresponding resources) allocated for sensing.

According to an embodiment, the UE 310 may perform a communication operation using time and frequency resources other than the time and frequency resources allocated for sensing. For example, the UE 310 may receive a communication signal (DL signal) using the time and frequency resources allocated for DL communication, rather than the time and frequency resources allocated for sensing. For example, the UE 310 may transmit a communication signal (UL signal) using the time and frequency resources allocated for UL communication, rather than the time and frequency resources allocated for sensing. As an embodiment, information about time and frequency resources allocated for communication may be transferred from the base station 320 to the UE 310 through communication configuration information (e.g., PDCCH/DCI).

According to an embodiment, when the UE 310 supports a sensing function, the UE 310 may receive a sensing signal using time and frequency resources allocated for sensing, and may perform a sensing operation based on the received sensing signal. The UE 310 may perform a sensing operation to obtain sensing data and/or a sensing result.

In operation 6, the monostatic TRP440 may transmit a report (sensing result report) including the sensing data and/or the sensing result to the SU 410. As an embodiment, the monostatic TRP440 may transmit the sensing result report to the SU410 when the cooperative sensing mode is applied.

Meanwhile, according to an embodiment, some of the above-described operations 1 to 6 may be omitted, and/or additional operations may be further performed. Further, the operations may be performed in a different order from the illustrated/described order, or multiple operations may be performed simultaneously.

Meanwhile, in FIG. 5A, for convenience of description, a procedure between the base station/TRP and one UE has been described as an example, but embodiments are not limited thereto. For example, a plurality of UEs may be connected to the TRP. In this case, each UE may perform the same procedure as described above between the TRP and the UE, with the corresponding TRP.

FIG. 5B illustrates a sensing procedure in a JCAS system according to an embodiment of the disclosure.

FIG. 5B may illustrate an example of a sensing procedure (a bistatic sensing procedure in a multistatic sensing structure) through the transmission role TRP 420 and the reception role TRP 430 in the multistatic sensing structure.

The bistatic sensing procedure in the multistatic sensing structure may include at least one of the following operating features:

The SU 410 may designate at least one transmission role TRP 420 and at least one reception role TRP 430. The SU 410 may allocate resources for sensing.

The SU 410 may notify the designated transmission role TRP 420 and reception role TRP 430 of information (sensing resource allocation information) about resource allocation for sensing together with role information.

The transmission role TRP 420 and the reception role TRP 430 may notify each of the at least one related UE 310a and 310b of the sensing resource allocation information. In this case, unlike a general communication system (e.g., the communication system 10 of FIG. 1), UEs 310a and 310b may perform different operations from the existing communication operations in the resource area (or section) allocated for sensing using notified sensing resource allocation information. The first UE 310a and the second UE 310b may perform all or some of functions supported by the UE 300 of FIG. 3. In the disclosure, the first UE 310a and the second UE 310b may be collectively referred to as the UE 310.

The transmission role TRP 420 may transmit a sensing signal.

The reception role TRP 430 may receive a sensing signal reflected from the target and obtain sensing data and/or a sensing result based on the sensing signal.

The reception role TRP 430 may transfer the sensing data and/or the sensing result to the SU 410.

The SU 410 may transmit the sensing data and/or the sensing result to the transmission role TRP 420.

Hereinafter, an example sensing procedure in the JCAS system is described with reference to FIG. 5B.

Referring to FIG. 5B, in operation 1, the SU 410 may designate a transmission role TRP 420 and a reception role TRP 430 for bistatic sensing.

Further, the SU 410 may perform resource allocation for sensing. For example, the SU 410 may allocate time and frequency resources for sensing (or sensing signals). Resource allocation (e.g., time/frequency resource allocation) for sensing may be performed. An example of allocation of time and frequency resources for sensing may be as illustrated in FIGS. 6A and 6B. According to an embodiment, the sensing resource may not overlap the communication resource.

In operation 2, the SU 410 may notify the transmission role TRP 420 and the reception role TRP 430 of information (role information) about the role of the bistatic TRP and information (sensing resource allocation information) about resource allocation for sensing. According to an embodiment, the SU 410 may transmit sensing configuration information including role information and sensing resource allocation information to the transmission role TRP 420 and the reception role TRP 430. The role information may include information indicating that the corresponding TRP is designated as a transmission role TRP or a reception role TRP for bistatic sensing.

In operation 3, the transmission role TRP 410 and the reception role TRP 420 may transmit sensing resource allocation information to at least one UE 310a and 310b respectively associated therewith.

For example, the transmission role TRP 410 may transmit sensing configuration information including sensing resource allocation information to at least one first UE 310a connected to the transmission role TRP 410, and the reception role TRP 420 may transmit sensing configuration information including sensing resource allocation information to at least one second UE 310b connected to the reception role TRP 420.

As an embodiment, the sensing resource allocation information may include information about time and frequency resources for sensing (or sensing signal) allocated in operation 1. Accordingly, the UE 310 may be notified of a current resource allocation status for the sensing signal. In the disclosure, the sensing resource allocation information may be referred to as sensing resource allocation status information.

In operation 4, the transmission role TRP 420 and the reception role TRP 430 may perform a sensing operation using resources (e.g., time and frequency resources) allocated for sensing.

According to an embodiment, the transmission role TRP 420 may transmit a sensing signal using time and frequency resources allocated for sensing. In an embodiment, the transmission role TRP 420 may transmit a sensing signal through at least one beam.

According to an embodiment, the reception role TRP 430 may receive a sensing signal (reflection signal) reflected from a target (e.g., the UE 310 of FIG. 3, the UEs 310a and 310b of FIG. 4, or the target 330 of FIG. 3) and obtain sensing data and/or a sensing result based on the reflection signal. According to an embodiment, the reception role TRP 420 may receive a sensing signal through at least one beam.

In operation 5, the UEs 310a and 310b may determine an operation to be performed using the received/notified information (e.g., sensing resource allocation information, sensing configuration information, etc.). For example, the UEs 310a and 310b may identify time and frequency resources allocated for sensing based on sensing resource allocation information and perform operations (e.g., communication operations and/or sensing operations) based on the identified time and frequency resources. The UEs 310a and 310b may perform all or some of the functions supported by the UE 300 of FIG. 3.

According to an embodiment, the UEs 310a and 310b may ignore the time and frequency resources (or signals received through the corresponding resources) allocated for sensing.

According to an embodiment, the UEs 310a and 310b may perform a communication operation using time and frequency resources other than the time and frequency resources allocated for sensing. For example, the UEs 310a and 310b may receive communication signals (DL signals) using time and frequency resources allocated for DL communication rather than time and frequency resources allocated for sensing. For example, the UEs 310a and 310b may transmit communication signals (UL signals) using time and frequency resources allocated for UL communication rather than time and frequency resources allocated for sensing. In an embodiment, information about the time and frequency resources allocated for communication may be transferred from the transmission role TRP 420 and the reception role TRP 430 to the UEs 310a and 310b through communication configuration information (e.g., PDCCH/DCI).

According to an embodiment, when the UEs 310a and 310b support a sensing function, the UEs 310a and 310b may receive a sensing signal using the time and frequency resources allocated for sensing and perform a sensing operation based on the received sensing signal. The UEs 310a and 310b may perform a sensing operation to obtain sensing data and/or a sensing result.

In operation 6, the reception role TRP 430 may transfer a report (sensing result report) including the sensing result and/or the sensing data to the SU 410. As an embodiment, the reception role TRP 430 may transmit a sensing result report to the SU 410 regardless of whether the sensing mode is a cooperative sensing mode.

In operation 7, the sensing result report of the SU 410 may be transferred to the reception role TRP 420.

Meanwhile, according to an embodiment, some of the above-described operations 1 to 6 may be omitted, and/or additional operations may be further performed. Further, the operations may be performed in a different order from the illustrated/described order, or multiple operations may be performed simultaneously.

Meanwhile, in FIG. 5B, for convenience of description, a procedure between the base station/TRP and one UE has been described as an example, but embodiments are not limited thereto. For example, a plurality of UEs may be connected to the TRP base station. In this case, each UE may perform the same procedure as described above between the TRP and the UE, with the corresponding TRP.

### [Allocation of Sensing Resources]

FIGS. 6A and 6B illustrate an example of resource allocation for sensing according to an embodiment of the disclosure.

In the embodiments of FIGS. 6A and 6B, for convenience of description, it is assumed that the time-frequency domain structure follows the time-frequency domain structure of FIG. 2A, and the frame, subframe, and slot structure follow the frame, subframe, and slot structure of FIG. 2B, but the embodiments are not limited thereto.

As an embodiment, in the time domain, at least one OFDM symbol may be allocated for sensing. For example, as illustrated in FIG. 6A, a first OFDM symbol (e.g., a sixth OFDM symbol (symbol index=5) in a first slot (e.g., a first slot (1st slot) of a frame or a period) and a second OFDM symbol (e.g., a sixth OFDM symbol (symbol index=5) in a second slot (e.g., a second slot (2nd slot) of the frame or period) following the first slot may be allocated for sensing.

As an embodiment, in the time domain, symbols (sensing symbols) for sensing may be allocated at preset intervals. For this purpose, the interval

$$( {T}_{sens}^{sym} )$$

between adjacent OFDM symbols for sensing may be set by the base station 320 (or transmission role TRP 410 or CU). Thus, OFDM symbols for sensing may be allocated in the time domain at the same interval.

As an embodiment, in the time domain, OFDM symbols and/or slots corresponding to a preset number (or duration) for Doppler processing may be allocated. For this purpose, the number of slots for Doppler processing or the duration

$$( {T}_{sens}^{accum} )$$

of the accumulated symbols (OFDM symbols) for Doppler processing may be set by the base station 320 (or transmission role TRP 410 or CU). Thus, as shown in FIG. 6B, a preset number of OFDM symbols in the time domain may be allocated for sensing. As an embodiment, the duration

$$( {T}_{sens}^{accum} )$$

may be associated with the number of symbols for Doppler processing.

As an embodiment, the base station 320 (or transmission role TRP 410 or CU) may set the interval

$$( {T}_{sens}^{sym} ) ,$$

the number of slots and/or duration

$$( {T}_{sens}^{accum} )$$

for Doppler processing. For example, the base station 320 (or transmission role TRP 410 or CU) may allocate OFDM symbols for sensing in the time domain, based on the interval

$$( {T}_{sens}^{sym} ) ,$$

the number of slots and/or the duration

$$( {T}_{sens}^{accum} )$$

for Doppler processing. The base station 320 (or transmission role TRP 410 or CU) may transmit information (sensing time resource information) about the time resource allocated for sensing to the UE 310. As an embodiment, the sensing time resource information may include at least one of the interval

$$( {T}_{sens}^{sym} ) ,$$

the number of slots for Doppler processing, the number of symbols for Doppler processing, or duration

$$( {T}_{sens}^{accum} ) .$$

Thus, the UE 310 may be notified of the OFDM symbol allocation status for sensing. The UE 310 may perform an operation based on the notified information. Meanwhile, the duration

$$( {T}_{sens}^{accum} )$$

is information that is sufficient for the receiving device (e.g., base station 320) of the sensing signal to know, and the UE 310 may not be notified of the duration.

As an embodiment, in the frequency domain, all or some of the subcarriers of the OFDM symbol allocated for sensing may be allocated for sensing. For example, as shown in FIG. 6A, all of the subcarriers associated with the OFDM symbol allocated for sensing may be allocated for sensing. For example, as shown in FIG. 5A/B, some of the subcarriers associated with the OFDM symbol allocated for sensing may be allocated for sensing. In this case, the allocated subcarriers may be contiguous subcarriers.

### [Interference Management]

In the case of a multistatic sensing structure, interference between TRPs may occur according to a sensing operation. Interference may occur, e.g., when the plurality of TRPs transmit sensing signals using the same sensing resource (e.g., time/frequency resource).

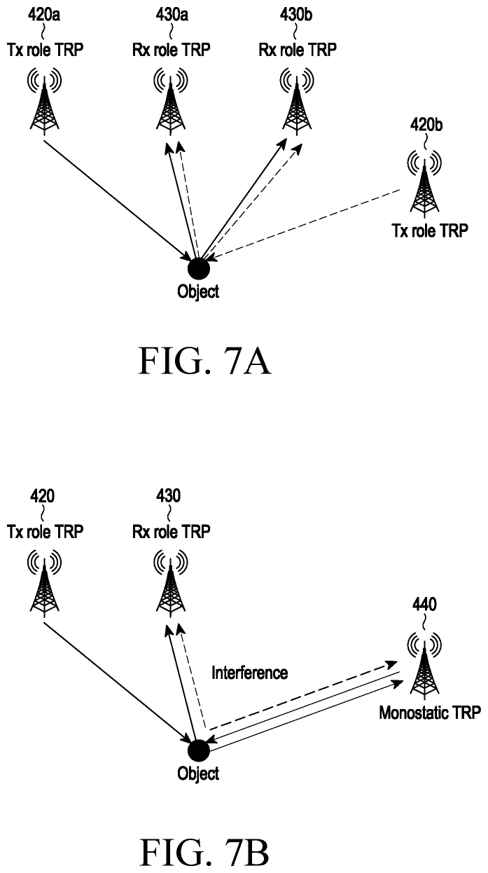

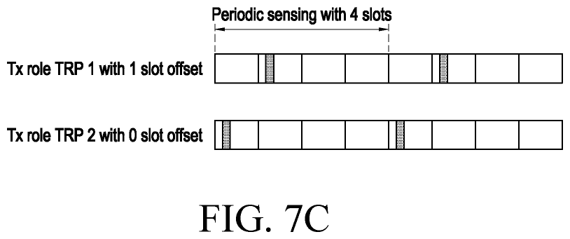

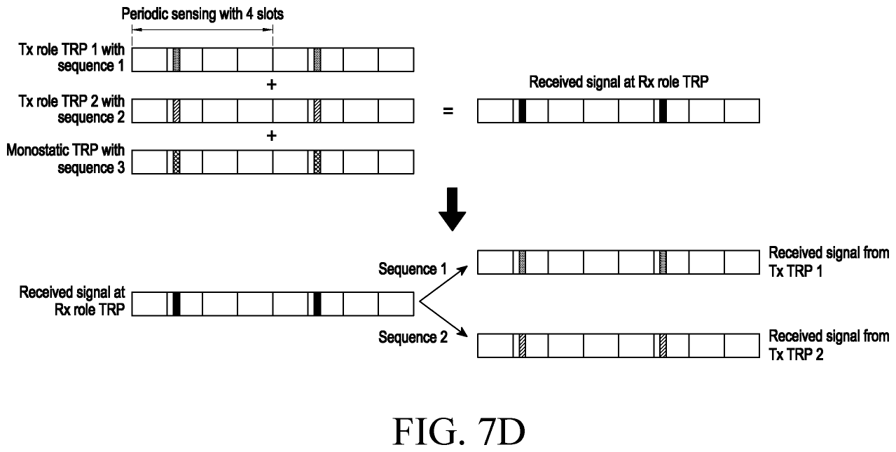

FIG. 7A is a view illustrating an example of interference generated in a multistatic sensing structure according to an embodiment of the disclosure.

FIG. 7A may illustrate an example of interference that occurs when a plurality of transmission role TRPs are configured for bistatic sensing in a multistatic sensing structure.

In the embodiment of FIG. 7A, it is assumed that the first transmission TRP 420a and the first reception TRP 430a are associated, and the second transmission TRP 420b and the second reception TRP 430b are associated with each other.

Referring to FIG. 7A, each of the reception role TRPs 430a and 430b may receive sensing signals transmitted from a plurality of transmission role TRPs 420a and 420b together (or simultaneously). In this case, when the first sensing signal transmitted from the first TRP 420b and the second sensing signal transmitted from the first TRP 420b are allocated to the same sensing resource (time/frequency resource), the sensing signal transmitted from the unrelated transmission TRP may act as an interference with the corresponding reception TRP. For example, the second sensing signal of the second transmission TRP 420b transmitted through the same sensing resource as the first sensing signal of the first transmission TRP 420a may interfere with the first reception TRP 430a. Further, when the first sensing signal and the second sensing signal are not distinguished, the bistatic sensing operation may also be affected.

FIG. 7B is a view illustrating an example of interference generated in a multistatic sensing structure according to an embodiment of the disclosure.

FIG. 7B may illustrate an example of interference between a transmission role TRP and a monostatic TRP for bistatic sensing in a multistatic sensing structure.

Referring to FIG. 7B, the monostatic TRP 440 may receive a sensing signal transmitted from the transmission role TRP 420 together (or simultaneously) with the sensing signal that it transmitted on its own. In this case, when the sensing signal transmitted from the transmission role TRP 420 and the own sensing signal are allocated to the same sensing resource (time/frequency resource), the sensing signal transmitted from the transmission role TRP 420 may act as an interference with the monostatic TRP 440.

The reception role TRP 430 may receive the sensing signal transmitted from the monostatic TRP 440 together (or simultaneously) with the sensing signal transmitted from the transmission role TRP 420. In this case, when the sensing signal transmitted from the transmission role TRP 420 and the sensing signal transmitted from the monostatic TRP 440 are allocated to the same sensing resource (time/frequency resource), the sensing signal transmitted from the monostatic TRP 440 may act as an interference with the reception role TRP 430.

FIG. 7C illustrates an example of sensing resource allocation for removing interference according to an embodiment of the disclosure.

The embodiment of FIG. 7C may be an embodiment of allocating sensing resources that do not overlap each other for each TRP (e.g., transmission role TRP, monostatic TRP) that transmits sensing signals to eliminate interference in the multistatic sensing structure/mode.

According to an embodiment, sensing resource allocation for each TRP may be performed by an SU.

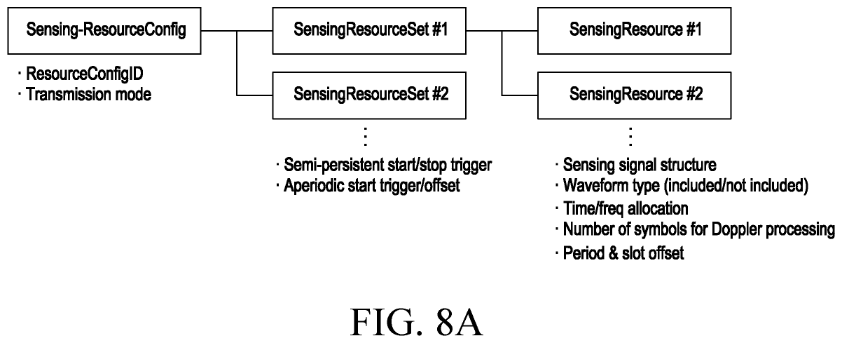

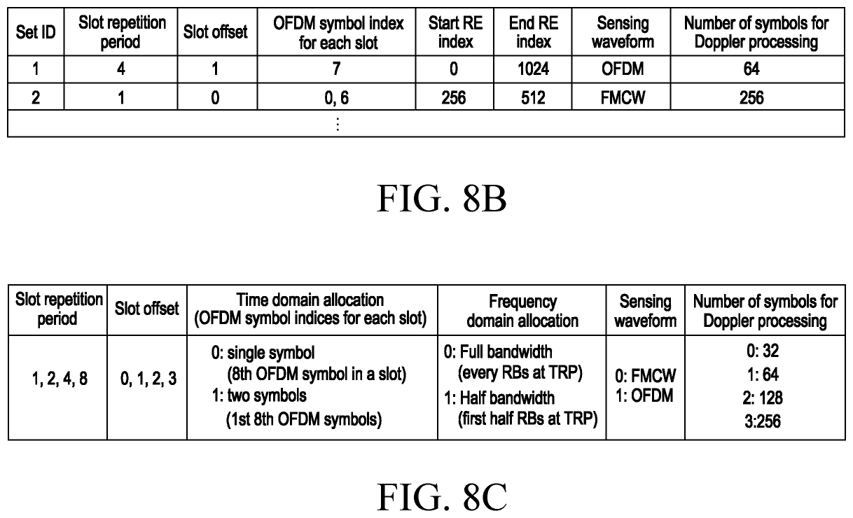

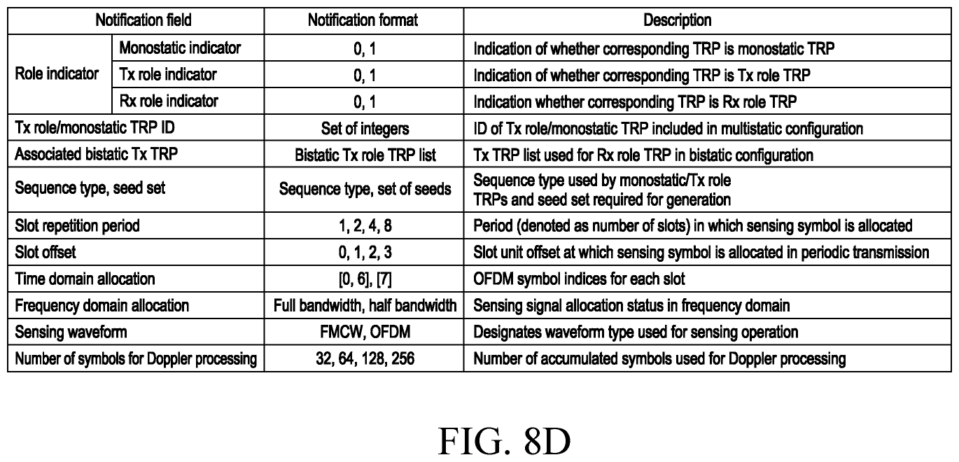

According to an embodiment, allocation of sensing resources for each transmission TRP may be performed at a time/frequency domain-level. As an embodiment, resource allocation at the time/frequency domain level may be performed based on time domain allocation information (e.g., time domain allocation information of FIG. 8D) and/or frequency domain allocation information (e.g., frequency domain allocation information of FIG. 8D).

According to an embodiment, the allocation of sensing resources for each transmission TRP may be performed at a slot-level having a different offset (slot offset). For example, as illustrated in FIG. 7c, the sensing resource for the first transmission role TRP (transmission role TRP 1) may be allocated to have a first slot offset (slot offset 1), and the sensing resource for the first transmission role TRP (transmission role TRP 2) may be allocated to have a second slot offset (slot offset 0). Accordingly, slots that do not overlap each other may be allocated for each transmission TRP. As an embodiment, slot-level resource allocation may be performed based on slot repetition period information (e.g., slot repetition period information of FIG. 8D) and/or slot offset information (e.g., slot offset information of FIG. 8D).

According to an embodiment, the SU may transmit information about sensing resource allocation set for each transmission TRP to TRPs (e.g., transmission role TRP, reception role TRP, and monostatic TRP).

According to an embodiment, each TRP may transmit information about sensing resource allocation set for each transmission TRP to each of at least one UE. Accordingly, the UE may identify sensing resources configured/allocated for each transmission TRP and perform an operation based on the same.

On the other hand, as in the embodiment of FIG. 7C, when sensing resources are separately allocated for each transmission TRP in order to remove interference, sensing overhead may increase and communication resources may be decreased.

FIG. 7D illustrates an example of sensing resource allocation for removing interference according to an embodiment of the disclosure.

The embodiment of FIG. 7D may be an embodiment where different sensing sequences are allocated for each TRP (transmission TRP) (e.g., transmission role TRP, monostatic TRP) that transmits sensing signals to eliminate interference in the multistatic sensing structure/mode. In this case, a plurality of TRPs may perform a sensing operation without interference using the same sensing resource.

According to an embodiment, sequence allocation and sensing resource allocation for each TRP may be performed by an SU. According to an embodiment, the SU may provide information about sequence allocation and sensing resource allocation for each TRP to each TRP using sensing configuration information (e.g., sensing configuration information of FIG. 8D).

According to an embodiment, a sequence allocated for each TRP may be generated based on a pseudo random noise (PN) sequence or an orthogonal sequence.

Referring to FIG. 7D, the same sensing resource may be allocated for a plurality of TRPs. For example, as illustrated, the same time/frequency resources may be allocated as sensing resources for the first transmission role TRP (transmission role TRP1), the second transmission role TRP (transmission role TRP2), and the monostatic TRP. In this case, a different sensing sequence may be configured for each of the first transmission role TRP, the second transmission role TRP, and the monostatic TRP. For example, as illustrated, the first sequence may be configured for the first transmission role TRP, the second sequence may be configured for the second transmission role TRP, and the third sequence may be configured for the monostatic TRP.

According to an embodiment, each of the first transmission role TRP, the second transmission role TRP, and the monostatic TRP may transmit a sensing signal in the same sensing resource using its own sequence.

According to an embodiment, the SU may transmit sequence information to the TRPs (e.g., transmission role TRP, reception role TRP, and monostatic TRP). The sequence information may include information about the sequence configured for the first transmission role TRP, the sequence configured for the second transmission role TRP, and/or the sequence configured for the monostatic TRP. The sequence information may be, e.g., in the form of sequence information of FIG. 8D.

The reception TRP (e.g., the reception role TRP and the monostatic TRP) receiving the sensing signal according to an embodiment may receive the sensing signal using the sensing resource allocated for sensing. For example, the reception TRP may receive the sensing signal transmitted from the first transmission role TRP, the sensing signal transmitted from the second transmission role TRP, and the sensing signal transmitted from the monostatic TRP using the same sensing resource allocated for sensing.

According to an embodiment, the reception TRP may distinguish each received sensing signal based on the received sequence information. For example, the reception TRP may separate the sensing signal transmitted from the first transmission role TRP, the sensing signal transmitted from the second transmission role TRP, and the sensing signal transmitted from the monostatic TRP based on the received sequence information. Accordingly, the reception TRP may perform a sensing operation without interference.

### [Sensing Configuration Information]

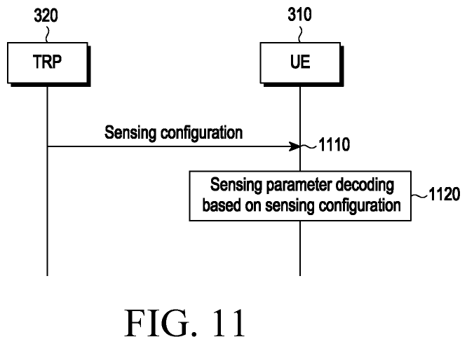

Hereinafter, a configuration of information (sensing configuration information) for a configuration for sensing is described. Parameters included in the sensing configuration information of FIGS. 8A to 8D and 11 to be described below may be combined, changed, or replaced with each other as long as they are not contradictory.

According to an embodiment, the sensing configuration information may be used for SU-TRP notification. The sensing configuration information according to an embodiment may be used for TRP-UE notification.

FIG. 8A illustrates an example of sensing configuration information according to an embodiment of the disclosure.

In the embodiment of FIG. 8A, the sensing configuration information may have a hierarchical structure.

Referring to FIG. 8A, the sensing configuration information may include at least one piece of sensing resource configuration information (e.g., Sensing-ResourceConfig).

The sensing resource configuration information may include resource configuration ID information (e.g., ResourceConfigID), transmission mode information (e.g., Transmission mode), and/or at least one sensing resource set information (e.g., SensingResourceSet #1,SensingResourceSet #2,etc.).

The resource configuration ID information may indicate the ID of the sensing resource configuration information.

The transmission mode information may indicate a transmission mode of a sensing signal (or a sensing sequence) in a sensing configuration to which the sensing resource configuration information is applied. As an embodiment, the transmission mode may be one of a periodic transmission mode, a semi-persistent transmission mode, and an aperiodic transmission mode. As an embodiment, the multi-static sensing structure/mode may be limited as using only the periodic transmission mode and, in this case, the transmission mode information may not be included in the sensing configuration information (or the sensing resource configuration information).

As an embodiment, the resource configuration ID information and the transmission mode information may be information of the sensing resource configuration information-level which is a higher level of the sensing resource set information-level, and a separate resource configuration ID (or sensing resource configuration information identified by the resource configuration ID) may be allocated for each transmission mode indicated by the transmission mode information. For example, the resource configuration ID of the sensing resource configuration information for the periodic transmission mode may be different from the resource configuration ID of the sensing resource configuration information for the aperiodic transmission mode. As described above, by configuration the resource configuration ID information and the transmission mode information as the information of the highest level of the sensing resource configuration information, it is possible to configure separate sensing resource set information/sensing resource information for each transmission mode.

The sensing resource set information may include at least one piece of sensing resource information (e.g., SensingResource #1 and SensingResource #2).

The sensing resource set information may further include sensing resource set information-level information that differs according to the transmission mode. For example, when the transmission mode is the semi-persistent transmission mode, the sensing resource set information may include trigger information (semi-persistent start trigger) for starting the semi-persistent transmission mode for the corresponding sensing resource set (e.g., SensingResourceSet #1) and/or trigger information (semi-persistent stop trigger) for stopping the semi-persistent transmission mode. For example, when the transmission mode is the aperiodic transmission mode, the sensing resource set information may include trigger information (aperiodic start trigger) and/or offset information (aperiodic offset) for starting the aperiodic transmission mode for the corresponding sensing resource set (e.g., SensingResourceSet #1). The sensing resource set information level may be a higher level of the sensing resource information-level.

The sensing resource information may include information about a sensing resource according to a sensing requirement or an application requirement. As an embodiment, a plurality of sensing resource information configured for each sensing requirement (or application) may be included in one piece of sensing resource set information. For example, SensingResource #1 configured according to the first sensing requirement (or the first application) and SensingResource #2 configured according to the second sensing requirement (or the second application) may be included in one piece of sensing resource set information (e.g., SensingResourceSet #1). As an embodiment, a plurality of sensing resource set information configured for each sensing requirement (or first application) may be included in one piece of sensing resource configuration information. For example, SensingResourceSet #1 configured according to the first sensing requirement (or the first application) and SensingResourceSet #2 configured according to the second sensing requirement (or the second application) may be included in one piece of sensing resource configuration information.

The sensing resource information according to an embodiment may include information about a sensing signal structure, information about a waveform type, information for measuring a range, and/or information for Doppler processing. As an embodiment, the information for measuring the range may include frequency resource allocation information for sensing. As an embodiment, the information for Doppler processing may include time resource allocation information for sensing, information about a period for transmitting a sensing signal, information about an offset (e.g., a slot offset) for transmitting a sensing signal, and/or information about the number of symbols required for Doppler processing (symbol count information for Doppler processing). As an embodiment, when the same waveform is used for sensing and communication, information about the waveform type may not be included in the sensing resource information.

According to an embodiment, the SU 410 may transmit the sensing configuration information to the transmission role TRP 420, the reception role TRP 430, and/or the monostatic TRP 440 using a preconfigured interface (e.g., an F1 interface or an X2 interface).

According to an embodiment, the base station 320 (or the transmission role TRP 420, the reception role TRP 430, or the monostatic TRP 440) may transmit sensing configuration information to the UE 310 through higher layer signaling and/or PHY layer signaling.

For example, base station 320 (or the transmission role TRP 420, the reception role TRP 430, or the monostatic TRP 440) may transmit the sensing configuration information through a radio resource control (RRC) message which is higher layer signaling. As an embodiment, the RRC message may include the whole or part of the information included in the sensing configuration information.

For example, the base station 320 (or the transmission role TRP 420, the reception role TRP 430, or the monostatic TRP 440) may transmit the sensing configuration information using system information (e.g., SIB) which is higher layer signaling. As an embodiment, the SIB may include part of the information included in the sensing configuration information.

For example, the base station 320 (or the transmission role TRP 420, the reception role TRP 430, or the monostatic TRP 440) may transmit the sensing configuration information using the MAC control element (CE) which is higher layer signaling. As an embodiment, the MAC CE may include the whole or part of information included in the sensing configuration information.

For example, base station 320 (or the transmission role TRP 420, the reception role TRP 430, or the monostatic TRP 440) may transmit the sensing configuration information through a DCI which is PHY layer signaling. As an embodiment, the DCI may include the whole or part of the information included in the sensing configuration information.

FIG. 8B illustrates an example of sensing configuration information according to an embodiment.

The sensing configuration information of FIG. 8B may be used for the periodic transmission mode.

The sensing configuration information of FIG. 8B may be used for the TRP (e.g., the transmission role TRP 420, the reception role TRP 430, or the monostatic TRP 440) to transfer a sensing configuration to the UE, but is not limited thereto.

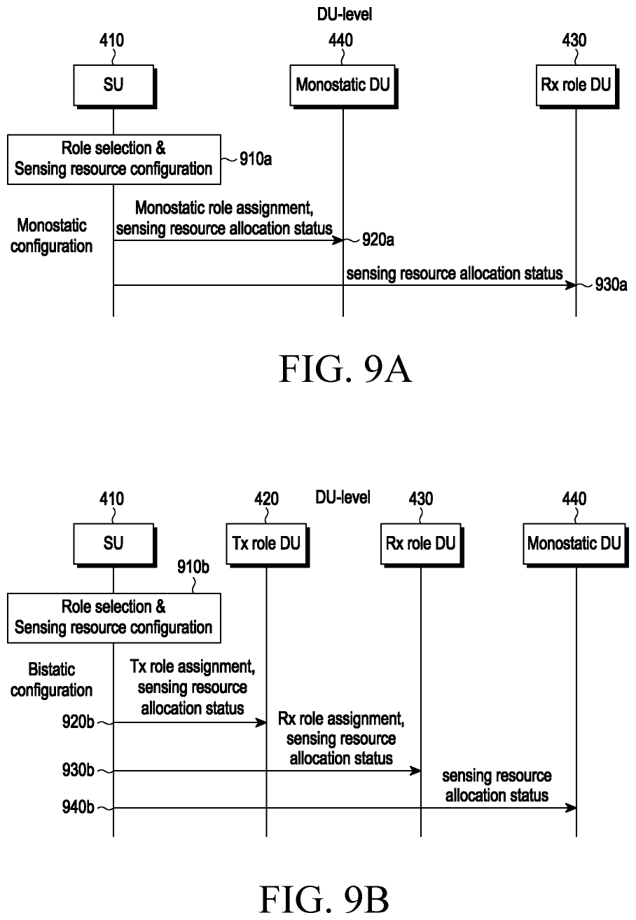

Referring to FIG. 8B, the sensing configuration information may have a form of a predefined table. For example, a configuration table for a sensing parameter set, such as the table of FIG. 9B, may be predefined. In the table, the setting values of the sensing parameters included in the sensing parameter set may be set to differ for each set ID indicated by the set ID information. For example, as illustrated in FIG. 8B, the setting values of the sensing parameters included in the sensing parameter set for the first set ID (set ID=1) may be different from the setting values of the sensing parameters included in the sensing parameter set for the second set ID (set ID=2).

As an embodiment, the sensing parameter set may include at least one sensing parameter. For example, as illustrated in FIG. 8B, the sensing parameter set may include a slot repetition period parameter/information, a slot offset parameter/information, an OFDM symbol index parameter/information for each slot, a start RE index parameter/information, an end RE index parameter/information, a sensing waveform parameter/information, and/or a symbol count parameter/information for Doppler processing.

The slot repetition period information, the slot offset, and the OFDM symbol index information for each slot may be used for time resource allocation for sensing.

The slot repetition period information may specify a period (slot repetition period) in which the OFDM symbol (sensing symbol) where a sensing sequence (or sensing data) is transmitted is allocated. As an embodiment, the slot repetition period information may indicate the period in which the sensing symbol is allocated as the number of slots. In the disclosure, the slot repetition period information may be referred to as repetition period information and period information.

The slot offset information may designate the offset from the start time of the period designated by the slot repetition period information to the start time of the slot (sensing slot) where the sensing symbol is allocated. As an embodiment, the slot offset information may designate an offset on a per-slot basis. In the disclosure, the slot offset information may be referred to as offset information.

The OFDM symbol index information for each slot may specify the index of the OFDM symbol corresponding to the sensing symbol in each slot where the sensing symbol is allocated. When a plurality of sensing symbols are allocated in the corresponding slot, the OFDM symbol index information for each slot may designate an OFDM symbol index for each of the plurality of sensing symbols. In the disclosure, OFDM symbol index information for each slot may be referred to as sensing symbol index information.

The start RE index information and the end RE index information may be used for frequency resource allocation for sensing.

The start RE index information may specify the index of the start RE for continuous frequency allocation. The end RE index information may specify the index of the end RE for continuous frequency allocation. Continuous frequency resources designated by the start RE index information and the end RE index information may be used for sensing.

The sensing waveform information may designate a type of waveform to be used for sensing (or sensing operation). For example, the sensing waveform information may be one-bit information set to either a first value (e.g., 0) indicating that the type of waveform is FMCW-based waveform or a second value (e.g., 1) indicating that the type of waveform is OFDM-based waveform.

The number of symbols for Doppler processing may designate the number of accumulated symbols (OFDM symbols) (e.g., 32, 64, 128, 256) required for Doppler processing.

As an embodiment, the setting value of parameters included in the sensing parameter set for each value of the set ID in the table of Table 9B may be a fixed value (e.g., a value defined in the standard) or a value shared in advance between devices for sensing. Therefore, the devices for sensing (e.g., base station 320, UE 310, SU 410, transmission role TRP 420, reception role TRP 430, and monostatic TRP 440) may know the setting values (e.g., table values in Table 9B) of parameters included in the sensing parameter set for each value of the set ID in advance. Therefore, the base station 320 (or the transmission role TRP 420, the reception role TRP 430, and the monostatic TRP 440) may transmit (or broadcast) only the value of the set ID information to be used as sensing configuration information to the UE 310 for sensing resource allocation. Accordingly, signaling overhead may be reduced. In this case, the UE 310 may obtain setting values of parameters included in the sensing parameter set corresponding to the set ID, based on the set ID of the set ID information, and may perform an operation (e.g., the communication operation and/or the sensing operation) based on the setting values.

According to an embodiment, the base station 320 (or the transmission role TRP 420, the reception role TRP 430, and the monostatic TRP 440) may transmit set ID information (or sensing configuration information including set ID information) to the UE 310 through higher layer signaling (e.g., SIB, RRC message and/or MAC CE) or PHY layer signaling (e.g., DCI). For example, the base station 320 (the transmission role TRP 420, the reception role TRP 430, and the monostatic TRP 440) may broadcast the SIB including the set ID information. For example, the base station 320, the transmission role TRP 420, the reception role TRP 430, and the monostatic TRP 440 may transmit an RRC message including set ID information to the UE 310. For example, the base station 320 (or the transmission role TRP 420, the reception role TRP 430, and the monostatic TRP 440) may transmit a MAC CE including set ID information to the UE 310. For example, the base station 320 (or the transmission role TRP 420, the reception role TRP 430, and the monostatic TRP 440) may transmit a DCI including set ID information to the UE 310.

According to an embodiment, the SU 410 may transmit set ID information to the transmission role TRP 420, the reception role TRP 430, and/or the monostatic TRP 440 using a preset interface (e.g., an F1 interface, an X2 interface).

FIG. 8C illustrates an example of sensing configuration information for a periodic transmission mode according to an embodiment.

The sensing configuration information of FIG. 8C may be used for the periodic transmission mode.

The sensing configuration information of FIG. 8C may be used by the TRP (e.g., the transmission role TRP 420, the reception role TRP 430, or the monostatic TRP 430) to transfer sensing configuration to the UE, but the disclosure is not limited thereto.

Referring to FIG. 8C, the sensing configuration information may have a form of a bitmap. For example, the configuration for the sensing parameter set may be configured in the form of a bitmap.

As an embodiment, the sensing parameter set may include at least one sensing parameter. For example, as illustrated in FIG. 8C, the sensing parameter set may include a slot repetition period parameter/information, a slot offset parameter/information, a time domain allocation parameter/information, a frequency domain allocation parameter/information, a sensing waveform parameter/information, and/or a symbol count parameter/information for Doppler processing.

The slot repetition period information, the slot offset, and the time domain allocation information may be used for time resource allocation for sensing.

The slot repetition period information may specify a period (slot repetition period) in which the OFDM symbol (sensing symbol) where a sensing sequence (or sensing data) is transmitted is allocated. As an embodiment, the slot repetition period information may indicate the period in which the sensing symbol is allocated as the number of slots. As an embodiment, the slot repetition period information may be set to the two-bit value that specifies the period (e.g., 1, 2, 4, 8) in which the sensing symbol is allocated.

The slot offset information may designate the offset from the start time of the period designated by the slot repetition period information to the start time of the slot where the sensing symbol is allocated. As an embodiment, the slot offset information may designate an offset on a per-slot basis. As an embodiment, the slot offset information may be set to a two-bit value that specifies the slot offset (e.g., 0, 1, 2, 3).

The time domain allocation information may be set to one of predefined values to designate the index of the OFDM symbol corresponding to the sensing symbol in each slot where the sensing symbol is allocated. For example, the time domain allocation information may be one-bit information set to one of a first value (e.g., 0) indicating that one OFDM symbol is allocated as the sensing symbol in the corresponding slot or a second value (e.g., 1) indicating that two OFDM symbols are allocated as the sensing symbol in the corresponding slot.

When the time domain allocation information is set to the first value (e.g., 0) indicating that one OFDM symbol is allocated as the sensing symbol, the value of the OFDM symbol index of the corresponding sensing symbol may be a preset value (e.g., the OFDM symbol index value corresponding to the eighth OFDM symbol).

When the time domain allocation information is set to the second value (e.g., 1) indicating that two OFDM symbols are allocated as the sensing symbol, the values of the OFDM symbol indexes of the corresponding two sensing symbols may be preset values (e.g., the OFDM symbol index value corresponding to the first OFDM symbol and the OFDM symbol index value corresponding to the eighth OFDM symbol).

The frequency domain allocation information may include information for continuous frequency allocation. As an embodiment, the frequency domain allocation information may be one-bit information set to one of the first value (e.g., 0) indicating the full bandwidth (e.g., all RBs (e.g., the total system bandwidth) available/configurable in the base station) or the second value (e.g., 1) indicating the half bandwidth (e.g., the first half RBs (e.g., the first half of the total system bandwidth) of all RBs available/configurable in the base station).

The sensing waveform information may designate a type of waveform to be used for sensing (or sensing operation). For example, the sensing waveform information may be one-bit information set to either a first value (e.g., 0) indicating that the type of waveform is FMCW-based waveform or a second value (e.g., 1) indicating that the type of waveform is OFDM-based waveform.

The number of symbols for Doppler processing may designate the number of accumulated symbols (OFDM symbols) (e.g., 32, 64, 128, 256) required for Doppler processing. For example, the symbol count information for Doppler processing may be two-bit information set to one of a first value (e.g., 0) indicating the number of accumulated symbols required for Doppler processing is 32, a second value (e.g., 1) indicating that the number of accumulated symbols required for Doppler processing is 64, a third value (e.g., 2) indicating that the number of accumulated symbols required for Doppler processing is 128, and a fourth value (e.g., 3) indicating that the number of accumulated symbols required for Doppler processing is 256.

As an embodiment, the bitmap of the sensing parameter set may be set to a total of 9 bits. For example, as illustrated in 8C, among the nine bits, the two least significant bits (LSBs) may be used to set the slot repetition period information, the next two bits may be used to set the slot offset information, the next one bit may be used to set the time domain allocation information, the next one bit may be used to set the frequency domain allocation information, the next one bit may be used to set the sensing waveform information, and the two most significant bits (MSBs) may be used to set the symbol count information for Doppler processing. However, this is merely an example of a bitmap of a sensing parameter set, and embodiments are not limited thereto.

For example, it is also possible to use a bitmap in which the parameters (information) of the sensing parameter set are configured in a different order from the order illustrated in FIG. 8C.

For example, some parameters (information) of the sensing parameter set may be omitted, or a bitmap further including additional parameters (information) may be used. In this case, the length of the bitmap may be longer or shorter than 9 bits.

According to an embodiment, the type and order of the parameters (information) included in the sensing parameter set configured in the form of the bitmap, and bitmap length may be fixed values (e.g., values defined in the standards), or may be values previously shared between devices for sensing. Therefore, the base station 320 (or the transmission role TRP 420, the reception role TRP 430, and the monostatic TRP 440) may transmit (or broadcast) only the bitmap (sensing parameter bitmap) of the sensing parameter set to the UE 310 for sensing resource allocation. Accordingly, signaling overhead may be reduced. In this case, the UE 310 may obtain the setting values of the parameters included in the sensing parameter set corresponding to the sensing parameter bitmap, based on the setting values of the sensing parameter bitmap, and may perform an operation (e.g., a communication operation and/or a sensing operation) based thereon.

According to an embodiment, the base station 320 (or the transmission role TRP 420, the reception role TRP 430, or the monostatic TRP 440) may transmit the sensing parameter bitmap (or sensing configuration information including the sensing parameter bitmap) to the UE 310 through higher layer signaling (e.g., SIB, RRC message and/or MAC CE) or PHY layer signaling (e.g., DCI). For example, the base station 320 (or the transmission role TRP 420, the reception role TRP 430, and the monostatic TRP 440) may broadcast the SIB including the sensing parameter bitmap. For example, the base station 320, the transmission role TRP 420, the reception role TRP 430, and the monostatic TRP 440 may transmit an RRC message including the sensing parameter bitmap to the UE 310. For example, the base station 320 (or the transmission role TRP 420, the reception role TRP 430, and the monostatic TRP 440) may transmit a MAC CE including the sensing parameter bitmap to the UE 310. For example, the base station 320 (or the transmission role TRP 420, the reception role TRP 430, and the monostatic TRP 440) may transmit a DCI including the sensing parameter bitmap to the UE 310.

According to an embodiment, the SU 410 may transmit the sensing parameter bitmap to the transmission role TRP 420, the reception role TRP 430, and/or the monostatic TRP 440 using a preconfigured interface (e.g., an F1 interface or an X2 interface).

Meanwhile, the sensing parameters in the sensing parameter set of FIG. 8B and the sensing parameters in the sensing parameter set of FIG. 8C may be combined or replaced with each other.

For example, some or all of the parameters in the sensing parameter set of FIG. 8C may be used to configure the configuration table of FIG. 8B, together with, or instead of, some or all of the parameters in the sensing parameter set of FIG. 8B. For example, some or all of the parameters in the sensing parameter set of FIG. 8B may be used to configure the sensing parameter bitmap of FIG. 8C, together with, or instead of, some or all of the parameters in the sensing parameter set of FIG. 8C.

For example, the sensing symbol index information (OFDM symbol index for each slot) of FIG. 8B may be replaced with the time domain allocation information of FIG. 8C and used, or vice versa. For example, the start RE index information and the end RE index information of FIG. 8B may be replaced with the frequency domain allocation information of FIG. 8C and used, or vice versa.

FIG. 8D illustrates an example of sensing configuration information according to an embodiment.

The sensing configuration information of FIG. 8D may be an example of sensing configuration information used for the multistatic sensing structure/mode.

The sensing configuration information of FIG. 8D may be used for transferring a sensing configuration to the transmission role TRP 420, the reception role TRP 430, or the monostatic TRP 440.

Referring to FIG. 8d, the sensing configuration information may include at least one sensing parameter field/information. For example, the sensing configuration information may include role indicator information, TRP ID information, associated bistatic transmission (Tx) TRP information, sequence information, slot repetition period information, slot offset information, time domain allocation information, frequency domain allocation information, sensing waveform information, and/or symbol count information for Doppler processing.

The role indicator information may be used to designate a role of the TRP. As an embodiment, the role indicator information may include monostatic indicator information, transmission role indicator information, and/or reception role indicator information. As an embodiment, the role indicator information may be set for each TRP.

The monostatic indicator information may indicate whether the TRP is a monostatic TRP. As an embodiment, the monostatic indicator information may be set to either a first value (e.g., 0) indicating that the corresponding TRP is a monostatic TRP or a second value (e.g., 1) indicating that the corresponding TRP is not a monostatic TRP.

The transmission role indicator information may indicate whether the TRP is a TRP performing a transmission role (transmission role TRP). As an embodiment, the transmission role indicator information may be set to either a first value (e.g., 0) indicating that the corresponding TRP is a transmission role TRP or a second value (e.g., 1) indicating that the corresponding TRP is not a transmission role TRP.

The reception role indicator information may indicate whether the corresponding TRP is a TRP performing a reception role (reception role TRP). As an embodiment, the reception role indicator information may be set to one of a first value (e.g., 0) indicating that the corresponding TRP is a reception role TRP or a second value (e.g., 1) indicating that the corresponding TRP is not a reception role TRP.

According to an embodiment, whether the corresponding TRP is the monostatic TRP, the transmission role TRP, or the reception role TRP may be indicated by one piece of role indicator information. For example, the role indicator information may be set to one of a first value (e.g., 0) indicating that the TRP is a monostatic TRP, a second value (e.g., 1) indicating that the TRP is a transmission role TRP, and a third value (e.g., 2) indicating that the TRP is a reception role TRP.

The TRP ID information may designate an ID of the transmission role TRP(s) and/or monostatic TRP(s) included in the multistatic configuration. The TRP ID information may be referred to as Tx role/monostatic TRP ID information.

The associated bistatic transmission TRP information may include a list of the transmission role TRPs associated with the reception role TRP of the bistatic configuration. The associated bistatic transmission TRP information may include a list of transmission role TRPs used by (or associated with) the corresponding reception role TRP (e.g., a list including the ID of at least one transmission role TRP).

The sequence information may include sequence type information designating the type of a sequence (sensing sequence) used by the transmission role TRP and/or the monostatic TRP and/or seed set information designating a set of seeds necessary for generating the sequence. According to an embodiment, the TRP ID may be used as a seed for generating a sequence of a transmission TRP having the corresponding TRP ID, and in this case, the seed set information may not be included in the sequence information.

The slot repetition period information, the slot offset, and the time domain allocation information may be used for time resource allocation for sensing.

The slot repetition period information may specify a period (slot repetition period) in which the OFDM symbol (sensing symbol) where a sensing sequence (or sensing data) is transmitted is allocated. As an embodiment, the slot repetition period information may indicate the period in which the sensing symbol is allocated as the number of slots. For example, the slot repetition period information may be set to the two-bit value that specifies the period (e.g., 1, 2, 4, 8) in which the sensing symbol is allocated.

The slot offset information may designate the offset from the start time of the period designated by the slot repetition period information to the start time of the slot where the sensing symbol is allocated. As an embodiment, the slot offset information may designate an offset on a per-slot basis. For example, the slot offset information may be set to a two-bit value that specifies the slot offset (e.g., 0, 1, 2, 3).

The time domain allocation information may be set to one of predefined values to designate the index of at least one OFDM symbol corresponding to the sensing symbol in each slot where the sensing symbol is allocated. For example, the time domain allocation information may be one-bit information set to one of a first value (e.g., 0) indicating that one OFDM symbol (e.g., an OFDM symbol with [OFDM symbol index=7]) is allocated as the sensing symbol in the corresponding slot or a second value (e.g., 1) indicating that two OFDM symbols (e.g., two OFDM symbols with [OFDM symbol index=0.6]) are allocated as the sensing symbol in the corresponding slot. Meanwhile, according to an embodiment, the time domain allocation information may be replaced with the sensing symbol index information (OFDM symbol index for each slot) of FIG. 8B.

The frequency domain allocation information may include information for continuous frequency allocation. As an embodiment, the frequency domain allocation information may be one-bit information set to one of the first value (e.g., 0) indicating the full bandwidth (e.g., all RBs (e.g., the total system bandwidth) available/configurable in the base station) or the second value (e.g., 1) indicating the half bandwidth (e.g., the first half RBs (e.g., the first half of the total system bandwidth) of all RBs available/configurable in the base station). Meanwhile, according to an embodiment, the frequency domain allocation information may be replaced by a combination of the start RE index information and the end RE index information of FIG. 8B.

As an embodiment, when sensing resources are separately allocated for each transmission TRP (e.g., transmission role TRP/monostatic TRP) to eliminate interference, slot repetition period information, slot offset information, time domain allocation information, and frequency domain allocation information may be set for each transmission TRP. Alternatively, the slot repetition period information, time domain allocation information, and frequency domain allocation information may be identically set for the transmission TRPs, and only slot offset information may be set differently for each transmission TRP.

The sensing waveform information may designate a type of waveform to be used for sensing (or sensing operation). For example, the sensing waveform information may be one-bit information set to either a first value (e.g., 0) indicating that the type of waveform is FMCW-based waveform or a second value (e.g., 1) indicating that the type of waveform is OFDM-based waveform.

The number of symbols for Doppler processing may designate the number of accumulated symbols (OFDM symbols) (e.g., 32, 64, 128, 256) required for Doppler processing. For example, the symbol count information for Doppler processing may be two-bit information set to one of a first value (e.g., 0) indicating the number of accumulated symbols required for Doppler processing is 32, a second value (e.g., 1) indicating that the number of accumulated symbols required for Doppler processing is 64, a third value (e.g., 2) indicating that the number of accumulated symbols required for Doppler processing is 128, and a fourth value (e.g., 3) indicating that the number of accumulated symbols required for Doppler processing is 256.

According to an embodiment, the SU 410 may transmit the sensing configuration information to the transmission role TRP 420, the reception role TRP 430, and/or the monostatic TRP 440 using a preconfigured interface (e.g., an F1 interface or an X2 interface).

### [Sensing Configuration Procedure]

FIG. 9A illustrates a sensing configuration procedure according to an embodiment of the disclosure.

The sensing configuration procedure of FIG. 9A represents an example of a sensing configuration procedure for a monostatic configuration between SU-TRPs (DUs) according to the TRP type (e.g., DU-level TRP type) at the lower level (e.g., DU-level) of the base station in the multistatic sensing structure.

Referring to FIG. 9A, in operation 910a, the SU 410 may select a role and configure a sensing resource.

According to an embodiment, the SU 410 may select at least one of the DUs as the transmission role TRP 420, select at least one other DU as the reception role TRP 430, and select at least one other DU as the monostatic TRP 440. In the disclosure, the DU selected as the transmission role TRP may be referred to as a transmission role DU, and the DU selected as the reception role TRP may be referred to as a reception role DU.

According to an embodiment, the SU 410 may allocate sensing resources (e.g., time/frequency resources) for multistatic sensing (or monostatic sensing). As an embodiment, an example of allocation of sensing resources for multistatic sensing (or monostatic sensing) may be, e.g., as illustrated in FIG. 7C or FIG. 7D.

In operation 920a, the SU 410 may transmit information about a monostatic role assignment (monostatic role assignment information) and information about sensing resource allocation to the monostatic DU/TRP 440.

According to an embodiment, the SU 410 may transmit monostatic role assignment information and information about sensing resource allocation to the monostatic DU using a predefined interface. As an embodiment, the monostatic role assignment information may be information for indicating that the corresponding DU is selected/set as a monostatic TRP. For example, the monostatic role assignment information may be the monostatic indicator information or the role indicator information described in connection with FIG. 8D.

According to an embodiment, the SU 410 may transmit sensing configuration information including monostatic role assignment information and information about sensing resource allocation to the monostatic DU. In an embodiment, the sensing configuration information may include all or some of the information included in FIGS. 8A, 8B, 8C, and/or 8D.

In operation 930a, the SU 410 may transmit information about sensing resource allocation to the reception role DU/TRP 430. Operations 920a and 930a may be performed simultaneously.

According to an embodiment, the SU 410 may transmit information about sensing resource allocation to the reception role DU using a predefined interface.

According to an embodiment, the SU 410 may transmit sensing configuration information including information about sensing resource allocation to the reception role DU. In an embodiment, the sensing configuration information may include all or some of the information included in FIGS. 8A, 8B, 8C, and/or 8D.

FIG. 9B illustrates a sensing configuration procedure according to an embodiment of the disclosure.

The sensing configuration procedure of FIG. 9B represents an example of a sensing configuration procedure for bistatic configuration between SU-TRPs (DUs) according to the TRP type (e.g., DU-level TRP type) of the lower level (e.g., DU-level) of the base station in the multistatic sensing structure.

Referring to FIG. 9B, in operation 910B, the SU 410 may select a role and configure a sensing resource.

According to an embodiment, the SU 410 may select at least one of the DUs as the transmission role TRP 420, select at least one other DU as the reception role TRP 430, and select at least one other DU as the monostatic TRP 440. In the disclosure, the DU selected as the transmission role TRP may be referred to as a transmission role DU, and the DU selected as the reception role TRP may be referred to as a reception role DU.

According to an embodiment, the SU 410 may allocate sensing resources (e.g., time/frequency resources) for multistatic sensing (or bistatic sensing). As an embodiment, an example of allocation of sensing resources for multistatic sensing (or bistatic sensing) may be, e.g., as illustrated in FIG. 7C or FIG. 7D.

In operation 920b, the SU 410 may transmit information about transmission role assignment (transmission role assignment information) and information about sensing resource allocation to the transmission role DU/TRP 420.

According to an embodiment, the SU 410 may transmit transmission role assignment information and information about sensing resource allocation to the transmission role DU using a predefined interface. As an embodiment, the transmission role assignment information may be information for indicating that the corresponding DU is selected/set as a transmission role DU (or, a transmission role TRP). For example, the transmission role assignment information may be the transmission role indicator information or the role indicator information described in connection with FIG. 8D.

According to an embodiment, the SU 410 may transmit sensing configuration information including transmission role assignment information and information about sensing resource allocation to the transmission role DU. In an embodiment, the sensing configuration information may include all or some of the information included in FIGS. 8A, 8B, 8C, and/or 8D.

In operation 930b, the SU 410 may transmit information about reception role assignment (reception role assignment information) and information about sensing resource allocation to the reception role DU/TRP 430. Operations 920b and 930b may be performed simultaneously.

According to an embodiment, the SU 410 may transmit reception role assignment information and information about sensing resource allocation to the reception role DU using a predefined interface. As an embodiment, the reception role assignment information may be information for indicating that the corresponding DU is selected/set as a reception role DU (or reception role TRP). For example, the reception role assignment information may be the reception role indicator information or the role indicator information of FIG. 8D.

According to an embodiment, the SU 410 may transmit sensing configuration information including reception role assignment information and information about sensing resource allocation to the reception role DU. In an embodiment, the sensing configuration information may include all or some of the information included in FIGS. 8A, 8B, 8C, and/or 8D.

In operation 940b, the SU 410 may transmit information about sensing resource allocation to the monostatic DU/TRP 440. Operation 940b may be performed simultaneously with operation 920b and operation 930b.

According to an embodiment, the SU 410 may transmit information about sensing resource allocation to the monostatic DU using a predefined interface.

According to an embodiment, the SU 410 may transmit sensing configuration information including information about sensing resource allocation to the monostatic DU. In an embodiment, the sensing configuration information may include all or some of the information included in FIGS. 8A, 8B, 8C, and/or 8D.

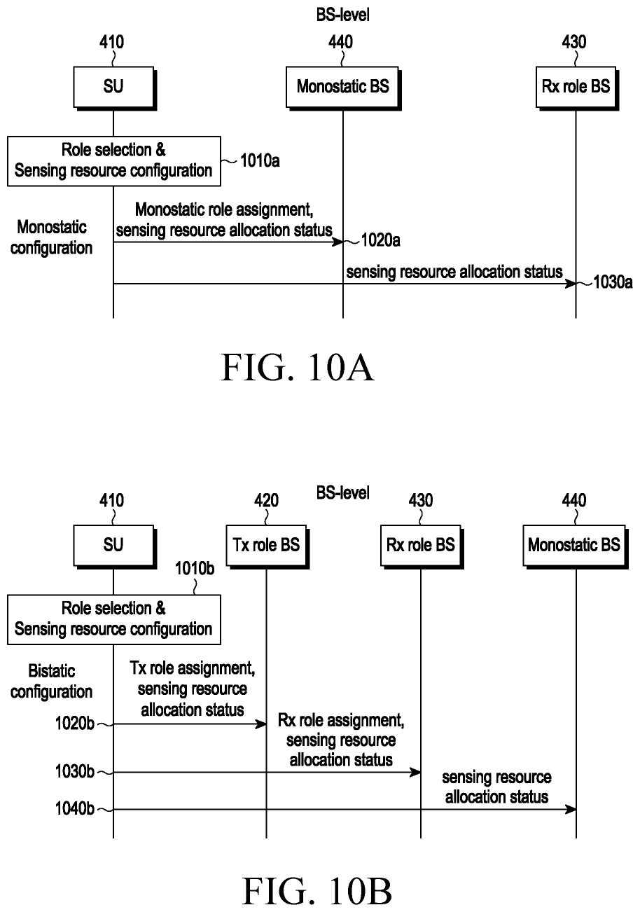

FIG. 10A illustrates a sensing configuration procedure according to an embodiment of the disclosure.

The sensing configuration procedure of FIG. 10A represents an example of a sensing configuration procedure for a monostatic configuration between SU-TRPs (base stations) according to the TRP type (e.g., base station-level TRP type) at the base station level (e.g., gNB-level) in the multistatic sensing structure.

Referring to FIG. 10A, in operation 1010b, the SU 410 may select a role and configure a sensing resource.

According to an embodiment, the SU 410 may select at least one of the base stations (e.g., gNB) as the transmission role TRP 420, select at least one other base station as the reception role TRP 430, and select at least one other base station as the monostatic TRP 440. In the disclosure, the base station selected as the transmission role TRP may be referred to as a transmission role base station, and the base station selected as the reception role TRP may be referred to as a reception role base station.

According to an embodiment, the SU 410 may allocate sensing resources (e.g., time/frequency resources) for multistatic sensing (or monostatic sensing). As an embodiment, an example of allocation of sensing resources for multistatic sensing (or monostatic sensing) may be, e.g., as illustrated in FIG. 7C or FIG. 7D.

In operation 1020a, the SU 410 may transmit information about a monostatic role assignment (monostatic role assignment information) and information about sensing resource allocation to the monostatic base station/TRP 440.

According to an embodiment, the SU 410 may transmit monostatic role assignment information and information about sensing resource allocation to the transmission role base station using a predefined interface. According to an embodiment, the monostatic role assignment information may be information for indicating that the corresponding base station is selected/set as the monostatic TRP. For example, the monostatic role assignment information may be the monostatic indicator information or the role indicator information described in connection with FIG. 8D.

According to an embodiment, the SU 410 may transmit sensing configuration information including monostatic role assignment information and information about sensing resource allocation to the monostatic base station. In an embodiment, the sensing configuration information may include all or some of the information included in FIGS. 8A, 8B, 8C, and/or 8D.

In operation 1030a, the SU 410 may transmit information about sensing resource allocation to the reception role base station/TRP 430. Operation 9020a and operation 9030a may be performed simultaneously.

According to an embodiment, the SU 410 may transmit information about sensing resource allocation to the reception role base station using a predefined interface.

According to an embodiment, the SU 410 may transmit sensing configuration information including information about sensing resource allocation to the reception role base station. In an embodiment, the sensing configuration information may include all or some of the information included in FIGS. 8A, 8B, 8C, and/or 8D.

FIG. 10B illustrates a sensing configuration procedure according to an embodiment of the disclosure.

The sensing configuration procedure of FIG. 10B represents an example of a sensing configuration procedure for bistatic configuration between SU-TRPs (base stations) according to the TRP type (e.g., DU-level TRP type) of the base station level (e.g., gNB-level) in a multistatic sensing structure.

Referring to FIG. 10B, in operation 1010B, the SU 410 may select a role and configure a sensing resource.

According to an embodiment, the SU 410 may select at least one of the base stations (e.g., gNB) as the transmission role TRP 420, select at least one other base station as the reception role TRP 430, and select at least one other base station as the monostatic TRP 440. In the disclosure, the base station selected as the transmission role TRP may be referred to as a transmission role base station, and the base station selected as the reception role TRP may be referred to as a reception role base station.

According to an embodiment, the SU 410 may allocate sensing resources (e.g., time/frequency resources) for multistatic sensing (or bistatic sensing). As an embodiment, an example of allocation of sensing resources for multistatic sensing (or bistatic sensing) may be, e.g., as illustrated in FIG. 7C or FIG. 7D.

In operation 1020b, the SU 410 may transmit information about transmission role assignment (transmission role assignment information) and information about sensing resource allocation to the transmission role base station/TRP 420.

According to an embodiment, the SU 410 may transmit transmission role assignment information and information about sensing resource allocation to the transmission role base station using a predefined interface. As an embodiment, the transmission role assignment information may be information for indicating that the corresponding base station is selected/set as a transmission role base station (or a transmission role TRP). For example, the transmission role assignment information may be the transmission role indicator information or the role indicator information described in connection with FIG. 8D.

According to an embodiment, the SU 410 may transmit sensing configuration information including transmission role assignment information and information about sensing resource allocation to the transmission role base station. In an embodiment, the sensing configuration information may include all or some of the information included in FIGS. 8A, 8B, 8C, and/or 8D.

In operation 1030b, the SU 410 may transmit information about reception role assignment (reception role assignment information) and information about sensing resource allocation to the reception role base station/TRP 430. Operation 9020a and operation 9030a may be performed simultaneously.

According to an embodiment, the SU 410 may transmit reception role assignment information and information about sensing resource allocation to the reception role base station using a predefined interface. As an embodiment, the reception role assignment information may be information for indicating that the corresponding DU is selected/set as a reception role base station (or reception role TRP). For example, the reception role assignment information may be the reception role indicator information or the role indicator information of FIG. 8D.

According to an embodiment, the SU 410 may transmit sensing configuration information including reception role assignment information and information about sensing resource allocation to the reception role base station. In an embodiment, the sensing configuration information may include all or some of the information included in FIGS. 8A, 8B, 8C, and/or 8D.

In operation 1040b, the SU 410 may transmit information about sensing resource allocation to the monostatic base station/TRP 440. Operation 1040b may be performed simultaneously with operation 1020b and operation 1030b.

According to an embodiment, the SU 410 may transmit information about sensing resource allocation to the monostatic base station using a predefined interface.

According to an embodiment, the SU 410 may transmit sensing configuration information including information about sensing resource allocation to the monostatic base station. In an embodiment, the sensing configuration information may include all or some of the information included in FIGS. 8A, 8B, 8C, and/or 8D.

FIG. 11 illustrates a sensing configuration procedure according to an embodiment of the disclosure.

FIG. 11 may illustrate a sensing configuration procedure between the base station/TRP 320 and the UE 310. In an embodiment of FIG. 11, the TRP 320 may be a transmission role TRP 420, a reception role TRP 430, or a monostatic TRP 440.

Referring to FIG. 11, in operation 1110, the TRP 320 may transmit sensing configuration information for sensing configuration to at least one UE 310. As an embodiment, the transmission role TRP 420, the reception role TRP 430, and the monostatic TRP 440 may transmit the same sensing configuration information to at least one UE associated with the transmission role TRP 420.

In operation 1120, the UE 310 may obtain (or decode) sensing parameter(s) based on sensing configuration information. Thereafter, the TRP 320 and the UE 310 may perform a communication operation and/or a sensing operation based on sensing configuration information.

According to an embodiment, the TRP 320 may transmit sensing configuration information to the UE 310 through higher layer signaling (e.g., SIB, RRC message, MAC CE, etc.) or PHY layer signaling (e.g., DCI, etc.). For example, the TRP 320 may transmit an RRC message including sensing configuration information to the UE 310. For example, the TRP 320 may transmit a MAC CE including sensing configuration information to the UE 320. For example, the TRP 320 may broadcast an SIB including sensing configuration information. For example, the TRP 320 may transmit a DCI including sensing configuration information to the UE 320.

According to an embodiment, the sensing configuration information may include all or some of information included in the sensing configuration information of FIGS. 8A, 8B, 8C, and/or 8D.

The sensing configuration information according to an embodiment may include resource allocation information (sensing resource allocation information), transmission mode information, and/or transmission parameter information.

The resource allocation information (sensing resource allocation information) may include frequency resource allocation information and/or time resource allocation information.

As an embodiment, the frequency resource allocation information may include information about continuous frequencies allocated for sensing. For example, the frequency resource allocation information may include a combination of start RE index information and end RE index information of FIG. 9B, or frequency domain allocation information of FIG. 9C.

As an embodiment, the time resource allocation information may include OFDM symbol index information specifying the index of at least one OFDM symbol allocated for sensing. For example, the time resource allocation information may include sensing symbol index information of FIG. 9B or time domain allocation information of FIG. 9C.

The transmission mode information may indicate the transmission mode of the sensing signal. As an embodiment, the transmission mode may be one of a periodic transmission mode, a semi-persistent transmission mode, and an aperiodic transmission mode. As an embodiment, the multi-static sensing structure/mode may be limited as using only the periodic transmission mode and, in this case, the transmission mode information may not be included in the sensing configuration information.

The transmission parameter information may include at least one piece of parameter information for transmission of the sensing signal. For example, the transmission parameter information may include period information (e.g., slot repetition period information of FIG. 8B/C/D), slot offset information (e.g., slot offset information of FIG. 8B/C/D), and/or symbol count information for Doppler processing (e.g., symbol count information for Doppler processing of FIG. 8A/B/C/D).

According to an embodiment, the sensing configuration information may include a periodic sensing stop trigger. As an embodiment, the periodic sensing stop trigger may be transferred to the UE when the corresponding trigger occurs in the corresponding TRP 320 or when the corresponding trigger is transferred from another TRP 320.

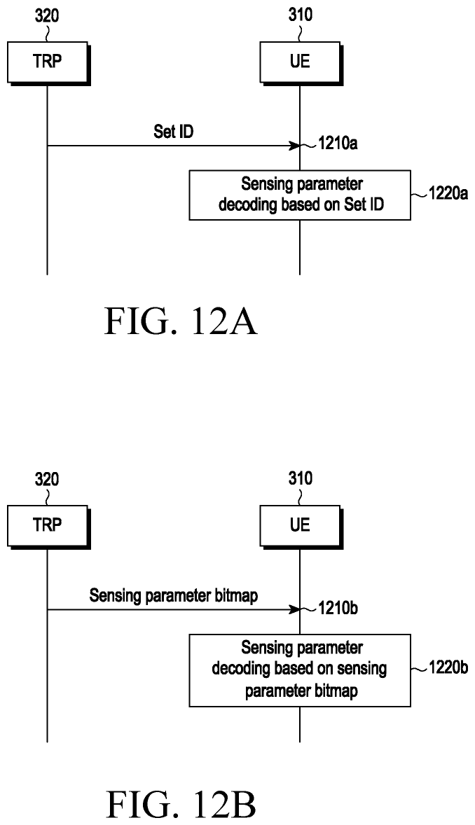

FIG. 12A illustrates a sensing configuration procedure using system information (SI) according to an embodiment of the disclosure.

FIG. 12A may illustrate a sensing configuration procedure using SI between the base station/TRP 320 and the UE 310. In an embodiment of FIG. 12A, the TRP 320 may be a transmission role TRP 420, a reception role TRP 430, or a monostatic TRP 440.

The embodiment of FIG. 12A corresponds to an embodiment in which set ID information (e.g., set ID information of FIG. 8B) is broadcast using SI as sensing configuration information.

Referring to FIG. 12A, in operation 1210a, the TRP 320 may broadcast set ID information using SI. For example, the TRP 320 may broadcast an SIB including set ID information. As an embodiment, the TRP 320 may periodically broadcast set ID information.

As an embodiment, the transmission role TRP 420 and the reception role TRP 430 may set the set ID of the set ID information based on the sensing configuration information (e.g., sensing configuration information of FIG. 8D) received from the SU 410.

When the set ID information is used as sensing configuration information, the TRP 320 and the UE 310 need to know, in advance, the configuration of the sensing parameter set for each set ID.

In operation 1220b, the UE 310 may receive the set ID information and obtain (or decode) a sensing parameter (sensing parameter set) based on the set ID information. For example, the UE 310 may obtain the configuration of the sensing parameter set corresponding to the set ID indicated by the received set ID information. For example, when the table of FIG. 8B is previously shared between the TRP 320 and the UE 310, and if the set ID indicated by the received set ID information has a value of 1, a slot repetition period having a value of 4, a slot offset having a value of 1, an OFDM symbol index for each slot having a value of 7, a start RE index having a value of 0, an end RE index having a value of 1024, a sensing waveform having an OFDM-based waveform, and a symbol count for Doppler processing having a count of 64 may be obtained as configurations of the sensing parameter set.

Thereafter, the TRP 320 and the UE 310 may perform a communication operation and/or a sensing operation based on the configuration of the sensing parameter set.

As such, when the set ID information is used as sensing configuration information, the signaling overhead may be reduced.

FIG. 12B illustrates a sensing configuration procedure using system information (SI) according to an embodiment of the disclosure.

FIG. 12B may illustrate a sensing configuration procedure using SI between the base station/TRP 320 and the UE 310. In an embodiment of FIG. 12B, the TRP 320 may be a transmission role TRP 420, a reception role TRP 430, or a monostatic TRP 440.

The embodiment of FIG. 12B corresponds to an embodiment in which a sensing parameter bitmap (e.g., the sensing parameter bitmap of FIG. 8C) is broadcast using SI as sensing configuration information.

Referring to FIG. 12B, in operation 1210B, the TRP 320 may broadcast the sensing parameter bitmap using SI. For example, the TRP 320 may broadcast an SIB including a sensing parameter bitmap. As an embodiment, the TRP 320 may periodically broadcast the sensing parameter bitmap.

As an embodiment, the transmission role TRP 420 and the reception role TRP 430 may set the set ID of the set ID information based on the sensing configuration information (e.g., sensing configuration information of FIG. 8D) received from the SU 410.

When the sensing parameter bitmap is used as sensing configuration information, the TRP 320 and the UE 310 need to know, in advance, the configuration of the sensing parameter set associated with the sensing parameter bitmap. For example, the TRP 320 and the UE 310 may already know the configuration of the sensing parameter bitmap.

In operation 1220c, the UE 310 may receive the sensing parameter bitmap and obtain (or decode) the sensing parameter (sensing parameter set) based on the sensing parameter bitmap.

For example, the UE 310 may obtain the configuration of the sensing parameter set corresponding to the setting value of the sensing parameter bitmap. For example, when the sensing parameter bitmap has the configuration of the sensing parameter bitmap of FIG. 9C, among the total nine bits of the sensing parameter bitmap, the two LSB bits may indicate the setting value (e.g., a setting value indicating one of the slot repetition periods {1, 2, 4, 8}) of the slot repetition period information, the next two bits may indicate the setting value (e.g., a setting value indicating one of the slot offsets {0, 1, 2, 3}) of the offset information, the next one bit may indicate the setting value (e.g., a setting value indicating one of the time domain allocations {0 or 1}) of the time domain allocation information, the next one bit may indicate the setting value (e.g., a setting value indicating one of the frequency domain allocations {0 or 1}) of the frequency domain allocation information, the next one bit may indicate the setting value (e.g., a setting value indicating one of the waveform types {FMCW (0), OFDM (1)} of the waveform type information, and the one MSB bit may indicate the setting value (e.g., a setting value indicating one of the symbol counts {32, 64, 128, 256}) of the symbol count information for Doppler processing.

Thereafter, the TRP 320 and the UE 310 may perform a communication operation and/or a sensing operation based on the configuration of the sensing parameter set.

As such, when the sensing parameter bitmap is used as the sensing configuration information, the signaling overhead may be reduced.

### [Sensing Resource Allocation for Periodic Transmission]

Hereinafter, an example of sensing resource allocation configured based on sensing configuration information is described.

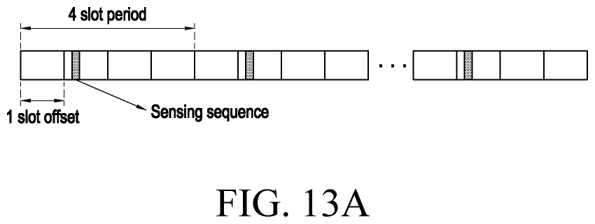

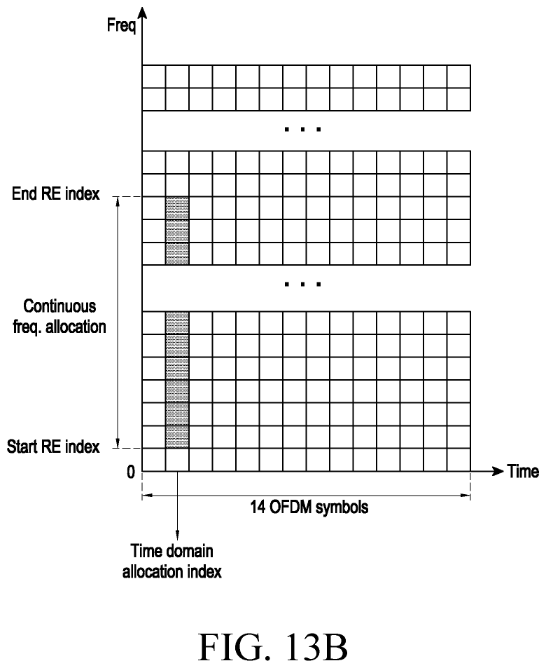

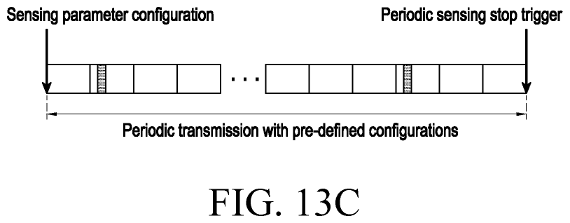

In the embodiments of FIGS. 13A to 13C, for convenience of description, it is assumed that the time-frequency domain structure follows the time-frequency domain structure of FIG. 2A, and the frame, subframe, and slot structure follow the frame, subframe, and slot structure of FIG. 2B, but the embodiments are not limited thereto.

FIG. 13A illustrates an example of sensing resource allocation according to an embodiment of the disclosure.

In the time domain, the time resource for sensing may be allocated in a slot-level. In this case, slot repetition period information, slot offset information, and/or time resource allocation information may be used as sensing configuration information to configure a time resource for sensing. As an embodiment, the time resource allocation information may be sensing symbol index information of FIG. 8B or time domain allocation information of FIG. 8C.

The embodiment of FIG. 13A may be an embodiment in which the value of slot repetition period information is set to a value indicating that the slot repetition period is 4, the value of slot offset information is set to a value indicating that the slot offset is 1, and the value of time resource allocation information is set to a value indicating the index of the second OFDM symbol in the slot where the sensing symbol including the sensing sequence (data) is allocated. In this case, as illustrated, the allocation of the sensing symbol (or the sensing resource) may be repeated in a period corresponding to the length of the four slots, the slot (the second slot of the corresponding period) one slot offset away from the start slot of the corresponding period may be allocated as the slot where the sensing symbol is allocated, and the second OFDM symbol in the corresponding slot may be allocated as the sensing symbol. Meanwhile, unlike shown, a plurality of OFDM symbols in one slot may be allocated as sensing symbols.

FIG. 13B illustrates an example of sensing resource allocation according to an embodiment of the disclosure.

In the time domain, the time resource for sensing may be allocated in an OFDM symbol-level. Further, in the frequency domain, the time resource for sensing may be allocated in an RE-level.

In the case of OFDM symbol-level allocation, time resources may be allocated on a per-OFDM symbol basis in the slot. In this case, time resource allocation information may be used as sensing configuration information to configure a time resource for sensing. As an embodiment, the time resource allocation information may be sensing symbol index information of FIG. 8B or time domain allocation information of FIG. 8C.

In the case of RE-level allocation, for continuous frequency resource allocation (continuous frequency allocation) on a per-RE basis, the start RE index information and the end RE index information of FIG. 8B may be used as sensing configuration information.

The embodiment of FIG. 13B may be an embodiment in which the value of time resource allocation information is set to a value indicating the index of the second OFDM symbol in the slot where the sensing symbol is allocated, start RE index information is set to a value indicating the index of the RE corresponding to the second subcarrier of the corresponding OFDM symbol, and end RE index information is set to a value indicating the index of the nth RE of the corresponding OFDM symbol. In this case, as illustrated, the RE (start RE) corresponding to start RE index information of the second OFDM symbol in the corresponding slot to the RE (end RE) corresponding to end RE index information may be allocated as the frequency resource (area) for sensing in the continuous RE. Meanwhile, unlike shown, a plurality of OFDM symbols in one slot may be allocated as sensing symbols. Further, according to an embodiment, it is also possible to allocate continuous frequencies for sensing in the RB-level rather than the RE-level. In this case, information indicating the index of the start RB (start RB index information) and information indicating the index of the end RB (end RB index information) may be used as sensing configuration information.

FIG. 13C illustrates an example of sensing resource allocation according to a periodic transmission mode according to an embodiment of the disclosure.

The sensing resource allocation according to the periodic transmission mode of FIG. 13C may be an example of sensing resource allocation according to the periodic transmission mode in the multistatic sensing structure/mode.

Referring to FIG. 13C, from the time when sensing configuration information (sensing parameter configuration) for the periodic transmission mode is configured to the time when the periodic sensing stop trigger is transmitted, a sensing signal (or a sensing sequence) may be transmitted repeatedly (or periodically) using the sensing resource set by the sensing configuration information.

Like the embodiment of FIG. 13A, the embodiment of FIG. 13C may be an embodiment in which the value of slot repetition period information is set to a value indicating that the slot repetition period is 4, the value of slot offset information is set to a value indicating that the slot offset is 1, and the value of time resource allocation information is set to a value indicating the index of the second OFDM symbol in the slot where the sensing symbol including the sensing sequence (data) is allocated. In this case, as illustrated, the allocation of the sensing symbol (or the sensing resource) for sensing may be repeated in a period corresponding to the length of the four slots, the slot (the second slot of the corresponding period) one slot offset away from the start slot of the slot repetition period may be allocated as the slot where the sensing symbol is allocated, and the second OFDM symbol in the corresponding slot may be allocated as the sensing symbol. Meanwhile, unlike shown, a plurality of OFDM symbols in one slot may be allocated as sensing symbols.

According to an embodiment, in the periodic transmission mode, the start time of the first period (slot repetition period) may correspond to the time when sensing configuration information for the periodic transmission mode is transmitted by the SU.

As an embodiment, in the periodic transmission mode, the end time may correspond to the time when the periodic sensing stop trigger is transmitted by the SU.

### [Operation According to Periodic Transmission Mode]

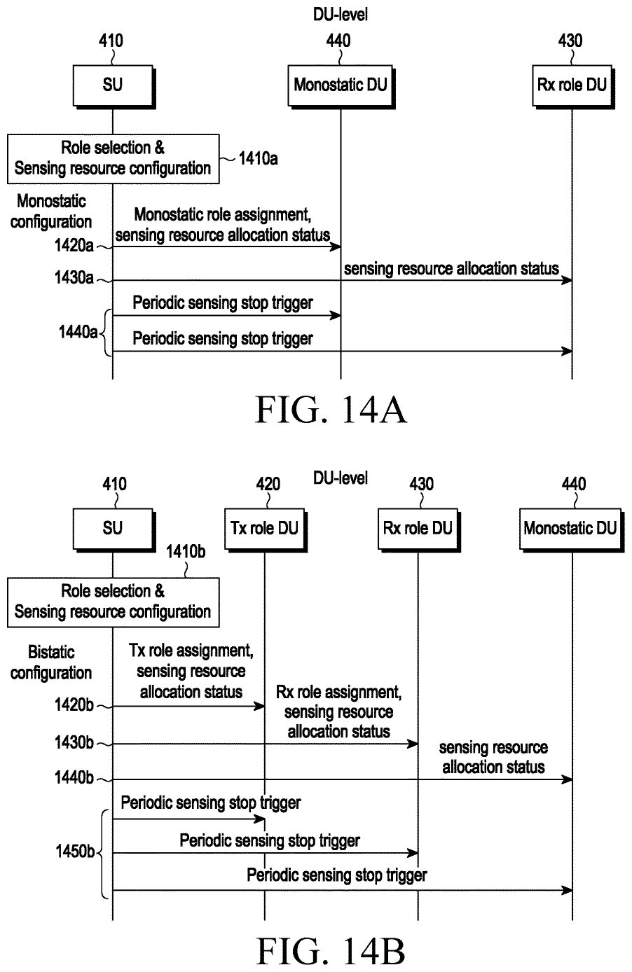

FIG. 14A illustrates a sensing procedure according to a periodic transmission mode according to an embodiment of the disclosure.

The sensing procedure according to the periodic transmission mode of FIG. 14A may be an example of a monostatic sensing procedure according to the periodic transmission mode in the multistatic sensing structure/mode.

The TRP type of FIG. 14A may be a DU-level TRP type.

Referring to FIG. 14A, in operation 1410a, the SU 410 may select a role and configure a sensing resource.

According to an embodiment, the SU 410 may select at least one of the DUs as the transmission role TRP 420, select at least one other DU as the reception role TRP 430, and select at least one other DU as the monostatic TRP 440. In the disclosure, the DU selected as the transmission role TRP may be referred to as a transmission role DU, and the DU selected as the reception role TRP may be referred to as a reception role DU.

According to an embodiment, the SU 410 may allocate sensing resources (e.g., time/frequency resources) for periodic transmission. An example of the allocated sensing resource may be as illustrated in FIGS. 13A, 13B, and/or 13C.

In operation 1420a, the SU 410 may transmit information about a monostatic role assignment (monostatic role assignment information) and information about sensing resource allocation to the monostatic DU/TRP 440.

According to an embodiment, the SU 410 may transmit monostatic role assignment information and information about sensing resource allocation to the transmission role DU using a predefined interface. As an embodiment, the monostatic role assignment information may be information for indicating that the corresponding DU is selected/set as a monostatic TRP. For example, the monostatic role assignment information may be the monostatic indicator information or the role indicator information described in connection with FIG. 8D.

According to an embodiment, the SU 410 may transmit sensing configuration information including monostatic role assignment information and information about sensing resource allocation to the monostatic DU. In an embodiment, the sensing configuration information may include all or some of the information included in FIGS. 8A, 8B, 8C, and/or 8D.

In operation 1430a, the SU 410 may transmit information about sensing resource allocation to the reception role DU/TRP 430. Operation 1420a and operation 1430a may be performed simultaneously.

According to an embodiment, the SU 410 may transmit information about sensing resource allocation to the reception role DU using a predefined interface.

According to an embodiment, the SU 410 may transmit sensing configuration information including information about sensing resource allocation to the reception role DU. In an embodiment, the sensing configuration information may include all or some of the information included in FIGS. 8A, 8B, 8C, and/or 8D.

In operation 1440a, the SU 410 may transmit a periodic sensing stop trigger for stopping periodic sensing to the monostatic DU/TRP 440 and the reception role DU/TRP 430.

According to an embodiment, the monostatic DU and the reception role DU may transmit the periodic sensing stop trigger to an associated UE at the time of receiving the periodic sensing stop trigger, and may terminate the sensing operation (e.g., the sensing signal transmission operation). In this case, the UE may identify that the sensing signal is not transmitted from the time when the periodic sensing stop trigger is received.

According to an embodiment, when a preset condition is met, the SU 410 may transmit a periodic sensing stop trigger.

For example, the SU 410 may transmit a periodic sensing stop trigger when a change in the multistatic sensing structure (or a multistatic configuration) is required. For example, the SU 410 may transmit a periodic sensing stop trigger when it is necessary to change the role of the TRP in the multistatic sensing structure.

For example, when it is necessary to end the sensing operation of the monostatic DU/TRP 440, the SU 410 may transmit a periodic sensing stop trigger to the monostatic TRP 440. In this case, the SU 410 may transmit the periodic sensing stop trigger to another reception role TRP 430 together with the monostatic TRP 440. Accordingly, the other reception role TRP 430 may be notified that there is no interference by the corresponding monostatic TRP 440.

For example, when it is necessary to end the sensing operation of the transmission role DU/TRP 420, the SU 410 may transmit a periodic sensing stop trigger to the transmission role TRP 420. In this case, the SU 410 may transmit the periodic sensing stop trigger to the reception role TRP 430 and the monostatic TRP 440 together with the monostatic TRP 440. Accordingly, the reception role TRP 430 and the monostatic TRP 440 may be notified that there is no interference by the corresponding transmission role TRP 420.

According to an embodiment, the monostatic DU/TRP 440 may periodically transmit a sensing signal (or a sensing sequence) from the time when the SU 410 transmits the sensing configuration information to the time when the SU 410 transmits the periodic sensing stop trigger, and receive a sensing signal (or a sensing sequence) reflected by the target. The monostatic DU may obtain sensing data and/or a sensing result based on a sensing signal. As an embodiment, the start time of the first period may correspond to the time when the SU 410 transmits the sensing configuration information.

FIG. 14B illustrates a sensing procedure according to a periodic transmission mode according to an embodiment of the disclosure.

The sensing procedure according to the periodic transmission mode of FIG. 14B may be an example of a bistatic sensing procedure according to the periodic transmission mode in the multistatic sensing structure/mode.

The TRP type of FIG. 14B may be a DU-level TRP type.

Referring to FIG. 14B, in operation 1410B, the SU 410 may select a role and configure a sensing resource.

According to an embodiment, the SU 410 may select at least one of the DUs as the transmission role TRP 420, select at least one other DU as the reception role TRP 430, and select at least one other DU as the monostatic TRP 440. In the disclosure, the DU selected as the transmission role TRP may be referred to as a transmission role DU, and the DU selected as the reception role TRP may be referred to as a reception role DU.

According to an embodiment, the SU 410 may allocate sensing resources (e.g., time/frequency resources) for periodic transmission. An example of the allocated sensing resource may be as illustrated in FIGS. 13A, 13B, or 13C.

In operation 1420b, the SU 410 may transmit information about transmission role assignment (transmission role assignment information) and information about sensing resource allocation to the transmission role DU/TRP 420.

According to an embodiment, the SU 410 may transmit transmission role assignment information and information about sensing resource allocation to the transmission role DU using a predefined interface. As an embodiment, the transmission role assignment information may be information for indicating that the corresponding DU is selected/set as a transmission role DU (or a transmission role TRP). For example, the transmission role assignment information may be the transmission role indicator information or the role indicator information described in connection with FIG. 8D.

According to an embodiment, the SU 410 may transmit sensing configuration information including transmission role assignment information and information about sensing resource allocation to the transmission role DU. In an embodiment, the sensing configuration information may include all or some of the information included in FIGS. 8A, 8B, 8C, and/or 8D.

In operation 1430b, the SU 410 may transmit information about reception role assignment (reception role assignment information) and information about sensing resource allocation to the reception role DU/TRP 430. Operation 1420b and operation 1430b may be performed simultaneously.

According to an embodiment, the SU 410 may transmit reception role assignment information and information about sensing resource allocation to the reception role DU using a predefined interface. As an embodiment, the reception role assignment information may be information for indicating that the corresponding DU is selected/set as a reception role DU (or reception role TRP). For example, the reception role assignment information may be the reception role indicator information or the role indicator information of FIG. 8D.

According to an embodiment, the SU 410 may transmit sensing configuration information including reception role assignment information and information about sensing resource allocation to the reception role DU. In an embodiment, the sensing configuration information may include all or some of the information included in FIGS. 8A, 8B, 8C, and/or 8D.

In operation 1440b, the SU 410 may transmit information about sensing resource allocation to the monostatic DU/TRP 440. Operation 1440b may be performed simultaneously with operation 1420b and operation 1430b.

According to an embodiment, the SU 410 may transmit information about sensing resource allocation to the monostatic DU using a predefined interface.

According to an embodiment, the SU 410 may transmit sensing configuration information including information about sensing resource allocation to the monostatic DU. In an embodiment, the sensing configuration information may include all or some of the information included in FIGS. 8A, 8B, 8C, and/or 8D.

In operation 1450b, the SU 410 may transmit a periodic sensing stop trigger for stopping periodic sensing to the transmission role DU/TRP 420, the reception role DU/TRP 430, and the monostatic DU/TRP 440.

According to an embodiment, the transmission role DU, the reception role DU, and the monostatic DU may transmit the periodic sensing stop trigger to an associated UE at the time of receiving the periodic sensing stop trigger, and may terminate the sensing operation (e.g., the sensing signal transmission operation). In this case, the UE may identify that the sensing signal is not transmitted from the time when the periodic sensing stop trigger is received.

According to an embodiment, when a preset condition is met, the SU 410 may transmit a periodic sensing stop trigger.

For example, the SU 410 may transmit a periodic sensing stop trigger when a change in the multistatic sensing structure (or a multistatic configuration) is required. For example, the SU 410 may transmit a periodic sensing stop trigger when it is necessary to change the role of the TRP in the multistatic sensing structure.

For example, when it is necessary to end the sensing operation of the monostatic DU/TRP 440, the SU 410 may transmit a periodic sensing stop trigger to the monostatic TRP 440. In this case, the SU 410 may transmit the periodic sensing stop trigger to another reception role TRP 430 together with the monostatic TRP 440. Accordingly, the other reception role TRP 430 may be notified that there is no interference by the corresponding monostatic TRP 440.

For example, when it is necessary to end the sensing operation of the transmission role DU/TRP 420, the SU 410 may transmit a periodic sensing stop trigger to the transmission role TRP 420. In this case, the SU 410 may transmit the periodic sensing stop trigger to the reception role TRP 430 and the monostatic TRP 440 together with the monostatic TRP 440. Accordingly, the reception role TRP 430 and the monostatic TRP 440 may be notified that there is no interference by the corresponding transmission role TRP 420.

According to an embodiment, the transmission role DU/TRP 420 may periodically transmit a sensing signal (or a sensing sequence) from the time when the SU 410 transmits the sensing configuration information to the time when the SU 410 transmits the periodic sensing stop trigger. As an embodiment, the start time of the first period may correspond to the time when the SU 410 transmits the sensing configuration information.

According to an embodiment, the reception role DU/TRP 430 may receive a sensing signal (or a sensing sequence) reflected by the target.

According to an embodiment, the reception role DU/TRP 430 may obtain sensing data and/or a sensing result based on the sensing signal.

According to an embodiment, the reception role DU/TRP 430 may transmit a report (sensing result report) including the sensing data and/or the sensing results to the SU 410, and the SU 410 may transmit a sensing result report to the transmission role the DU/TRP 420.

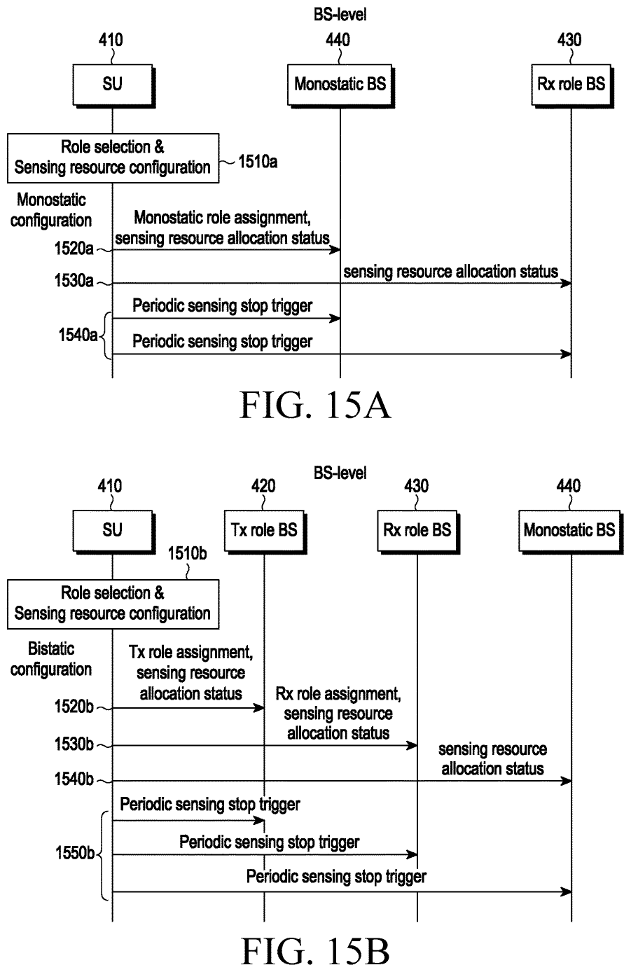

FIG. 15A illustrates a sensing configuration procedure according to an embodiment of the disclosure.

The sensing procedure according to the periodic transmission mode of FIG. 15A may be an example of a monostatic sensing procedure according to the periodic transmission mode in the multistatic sensing structure/mode.

The TRP type of FIG. 15A may be a base station-level TRP type.

Referring to FIG. 15A, in operation 1510b, the SU 410 may select a role and configure a sensing resource.

According to an embodiment, the SU 410 may select at least one of the base stations (e.g., gNB) as the transmission role TRP 420, select at least one other base station as the reception role TRP 430, and select at least one other base station as the monostatic TRP 440. In the disclosure, the base station selected as the transmission role TRP may be referred to as a transmission role base station, and the base station selected as the reception role TRP may be referred to as a reception role base station.

According to an embodiment, the SU 410 may allocate sensing resources (e.g., time/frequency resources) for periodic transmission. An example of the allocated sensing resource may be as illustrated in FIGS. 13A, 13B, or 13C.

In operation 1520a, the SU 410 may transmit information about a monostatic role assignment (monostatic role assignment information) and information about sensing resource allocation to the monostatic base station/TRP 440.

According to an embodiment, the SU 410 may transmit monostatic role assignment information and information about sensing resource allocation to the monostatic base station using a predefined interface. According to an embodiment, the monostatic role assignment information may be information for indicating that the corresponding base station is selected/set as the monostatic TRP. For example, the monostatic role assignment information may be the monostatic indicator information or the role indicator information described in connection with FIG. 8D.

According to an embodiment, the SU 410 may transmit sensing configuration information including monostatic role assignment information and information about sensing resource allocation to the monostatic base station. In an embodiment, the sensing configuration information may include all or some of the information included in FIGS. 8A, 8B, 8C, and/or 8D.

In operation 1530a, the SU 410 may transmit information about sensing resource allocation to the reception role base station/TRP 430. Operation 1520a and operation 1530a may be performed simultaneously.

According to an embodiment, the SU 410 may transmit information about sensing resource allocation to the reception role base station using a predefined interface.

According to an embodiment, the SU 410 may transmit sensing configuration information including information about sensing resource allocation to the reception role base station. In an embodiment, the sensing configuration information may include all or some of the information included in FIGS. 8A, 8B, 8C, and/or 8D.

In operation 1540a, the SU 410 may transmit a periodic sensing stop trigger for stopping periodic sensing to the monostatic base station/TRP 440 and the reception role base station/TRP 430.

According to an embodiment, the monostatic base station and the reception role base station may transmit the periodic sensing stop trigger to an associated UE at the time of receiving the periodic sensing stop trigger, and may terminate the sensing operation (e.g., the sensing signal transmission operation). In this case, the UE may identify that the sensing signal is not transmitted from the time when the periodic sensing stop trigger is received.

According to an embodiment, when a preset condition is met, the SU 410 may transmit a periodic sensing stop trigger.

For example, the SU 410 may transmit a periodic sensing stop trigger when a change in the multistatic sensing structure (or a multistatic configuration) is required. For example, the SU 410 may transmit a periodic sensing stop trigger when it is necessary to change the role of the TRP in the multistatic sensing structure.

For example, when it is necessary to end the sensing operation of the monostatic base station/TRP 440, the SU 410 may transmit a periodic sensing stop trigger to the monostatic TRP 440. In this case, the SU 410 may transmit the periodic sensing stop trigger to another reception role TRP 430 together with the monostatic TRP 440. Accordingly, the other reception role TRP 430 may be notified that there is no interference by the corresponding monostatic TRP 440.

For example, when it is necessary to end the sensing operation of the transmission role base station/TRP 420, the SU 410 may transmit a periodic sensing stop trigger to the transmission role TRP 420. In this case, the SU 410 may transmit the periodic sensing stop trigger to the reception role TRP 430 and the monostatic TRP 440 together with the monostatic TRP 440. Accordingly, the reception role TRP 430 and the monostatic TRP 440 may be notified that there is no interference by the corresponding transmission role TRP 420.

According to an embodiment, the monostatic base station/TRP 440 may periodically transmit a sensing signal (or a sensing sequence) from the time when the SU 410 transmits the sensing configuration information (e.g., the sensing configuration information of FIG. 8D) for multistatic sensing to the time when the SU 410 transmits the periodic sensing stop trigger, and receive a sensing signal (or a sensing sequence) reflected by the target. The monostatic base station may obtain sensing data and/or a sensing result based on a sensing signal. As an embodiment, the start time of the first period may correspond to the time when the SU 410 transmits the sensing configuration information.

FIG. 15B illustrates a sensing configuration procedure according to an embodiment of the disclosure.

The sensing procedure according to the periodic transmission mode of FIG. 15B may be an example of a bistatic sensing procedure according to the periodic transmission mode in the multistatic sensing structure/mode.

The TRP type of FIG. 15B may be a base station-level TRP type.

Referring to FIG. 15B, in operation 1510B, the SU 410 may select a role and configure a sensing resource.

According to an embodiment, the SU 410 may select at least one of the base stations (e.g., gNB) as the transmission role TRP 420, select at least one other base station as the reception role TRP 430, and select at least one other base station as the monostatic TRP 440. In the disclosure, the base station selected as the transmission role TRP may be referred to as a transmission role base station, and the base station selected as the reception role TRP may be referred to as a reception role base station.

According to an embodiment, the SU 410 may allocate sensing resources (e.g., time/frequency resources) for periodic transmission. An example of the allocated sensing resource may be as illustrated in FIGS. 13A, 13B, and/or 13C.

In operation 1520b, the SU 410 may transmit information about transmission role assignment (transmission role assignment information) and information about sensing resource allocation to the transmission role base station/TRP 420.

According to an embodiment, the SU 410 may transmit transmission role assignment information and information about sensing resource allocation to the transmission role base station using a predefined interface. As an embodiment, the transmission role assignment information may be information for indicating that the corresponding base station is selected/set as a transmission role base station (or a transmission role TRP). For example, the transmission role assignment information may be the transmission role indicator information or the role indicator information described in connection with FIG. 8D.

According to an embodiment, the SU 410 may transmit sensing configuration information including transmission role assignment information and information about sensing resource allocation to the transmission role base station. In an embodiment, the sensing configuration information may include all or some of the information included in FIGS. 8A, 8B, 8C, and/or 8D.

In operation 1530b, the SU 410 may transmit information about reception role assignment (reception role assignment information) and information about sensing resource allocation to the reception role base station/TRP 430. Operation 1520a and operation 1530a may be performed simultaneously.

According to an embodiment, the SU 410 may transmit reception role assignment information and information about sensing resource allocation to the reception role base station using a predefined interface. As an embodiment, the reception role assignment information may be information for indicating that the corresponding base station is selected/set as a reception role base station (or reception role TRP). For example, the reception role assignment information may be the reception role indicator information or the role indicator information of FIG. 8D.

According to an embodiment, the SU 410 may transmit sensing configuration information including reception role assignment information and information about sensing resource allocation to the reception role base station. In an embodiment, the sensing configuration information may include all or some of the information included in FIGS. 8A, 8B, 8C, and/or 8D.

In operation 1540b, the SU 410 may transmit information about sensing resource allocation to the monostatic base station/TRP 440. Operation 1540b may be performed simultaneously with operation 1520b and operation 1530b.

According to an embodiment, the SU 410 may transmit information about sensing resource allocation to the monostatic base station using a predefined interface.

According to an embodiment, the SU 410 may transmit sensing configuration information including information about sensing resource allocation to the monostatic base station. In an embodiment, the sensing configuration information may include all or some of the information included in FIGS. 8A, 8B, 8C, and/or 8D.

In operation 1550b, the SU 410 may transmit a periodic sensing stop trigger for stopping periodic sensing to the transmission role base station/TRP 420, the reception role base station/TRP 430, and the monostatic base station/TRP 440.

According to an embodiment, the transmission role base station, the reception role base station, and the monostatic base station may transmit the periodic sensing stop trigger to an associated UE at the time of receiving the periodic sensing stop trigger, and may terminate the sensing operation (e.g., the sensing signal transmission operation). In this case, the UE may identify that the sensing signal is not transmitted from the time when the periodic sensing stop trigger is received.

According to an embodiment, when a preset condition is met, the SU 410 may transmit a periodic sensing stop trigger.

For example, the SU 410 may transmit a periodic sensing stop trigger when a change in the multistatic sensing structure (or a multistatic configuration) is required. For example, the SU 410 may transmit a periodic sensing stop trigger when it is necessary to change the role of the TRP in the multistatic sensing structure.

For example, when it is necessary to end the sensing operation of the monostatic base station/TRP 440, the SU 410 may transmit a periodic sensing stop trigger to the monostatic TRP 440. In this case, the SU 410 may transmit the periodic sensing stop trigger to another reception role TRP 430 together with the monostatic TRP 440. Accordingly, the other reception role TRP 430 may be notified that there is no interference by the corresponding monostatic TRP 440.

For example, when it is necessary to end the sensing operation of the transmission role base station/TRP 420, the SU 410 may transmit a periodic sensing stop trigger to the transmission role TRP 420. In this case, the SU 410 may transmit the periodic sensing stop trigger to the reception role TRP 430 and the monostatic TRP 440 together with the monostatic TRP 440. Accordingly, the reception role TRP 430 and the monostatic TRP 440 may be notified that there is no interference by the corresponding transmission role TRP 420.

According to an embodiment, the transmission role base station/TRP 420 may periodically transmit a sensing signal (or a sensing sequence) from the time when the SU 410 transmits the sensing configuration information (e.g., the sensing configuration information of FIG. 8D) for multistatic sensing to the time when the SU 410 transmits the periodic sensing stop trigger. As an embodiment, the start time of the first period may correspond to the time when the SU 410 transmits the sensing configuration information.

According to an embodiment, the reception role base station/TRP 430 may receive a sensing signal (or a sensing sequence) reflected by the target.

According to an embodiment, the reception role base station/TRP 430 may obtain sensing data and/or a sensing result based on the sensing signal.

According to an embodiment, the reception role base station/TRP 430 may transmit a report (sensing result report) including the sensing data and/or the sensing results to the SU 410, and the SU 410 may transmit a sensing result report to the transmission role the base station/TRP 420.

### [Sensing Result Reporting Procedure]

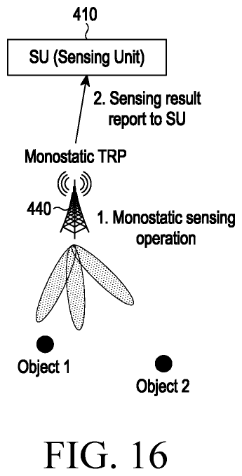

FIG. 16 illustrates a sensing result reporting procedure according to an embodiment of the disclosure.

The sensing result reporting procedure of FIG. 16 may be an example of the sensing result reporting procedure of the monostatic TRP in the multistatic sensing structure.

Referring to FIG. 16, in operation 1, the monostatic TRP 440 may perform a monostatic sensing operation.

According to an embodiment, the monostatic TRP 410 may transmit a sensing signal using a resource (e.g., time/frequency resource) configured/allocated based on sensing configuration information, receive a sensing signal reflected from a target (e.g., objects 1 and 2), and obtain sensing data and/or a sensing result based on the received sensing signal. In an embodiment, the sensing configuration information may include all or some of the information included in FIGS. 8A, 8B, 8C, and/or 8D.

According to an embodiment, the sensing data may include information (sensing information) that may be derived from the reflection signal. According to an embodiment, the sensing information may include information that may be measured from a signal strength, a delay, a timing, an angle of arrival (AoA), a time of flight (ToF), and/or other reflection signals.

According to an embodiment, the sensing data may further include a description of the sensing data, information for identifying a purpose of sensing, information for identifying information, etc.) on a target associated with the sensing data.

According to an embodiment, sensing data (or sensing information) may be used to generate a sensing result for the target.

According to an embodiment, the sensing result may include information about a distance, a location, and/or a speed (doppler) with respect to the target.

In operation 2, the monostatic TRP440 may transmit a report (sensing result report) including the sensing data and/or the sensing result to the SU 410.

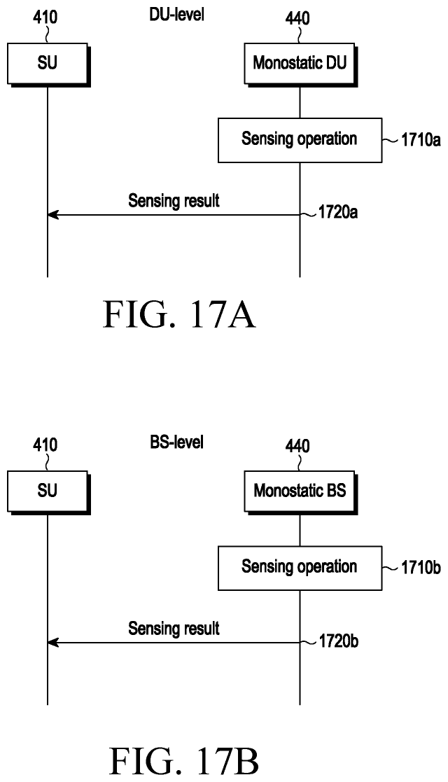

FIG. 17A illustrates a sensing result reporting procedure according to an embodiment of the disclosure.

The sensing result reporting procedure of FIG. 17A may be an example of the sensing result reporting procedure of the DU-level monostatic TRP (monostatic DU) in the multistatic sensing structure.

Referring to FIG. 17A, in operation 1710a, the monostatic DU/TRP 440 may perform a sensing operation. According to an embodiment, the monostatic TRP 440 may transmit a sensing signal using a resource (e.g., time/frequency resource) configured/allocated based on sensing configuration information, receive a sensing signal reflected from a target (e.g., objects 1 and 2), and obtain sensing data and/or a sensing result based on the received sensing signal. In an embodiment, the sensing configuration information may include all or some of the information included in FIGS. 8A, 8B, 8C, and/or 8D.

According to an embodiment, the sensing data may include information (sensing information) that may be derived from the reflection signal. According to an embodiment, the sensing information may include information that may be measured from a signal strength, a delay, a timing, an angle of arrival (AoA), a time of flight (ToF), and/or other reflection signals.

According to an embodiment, the sensing data may further include a description of the sensing data, information for identifying a purpose of sensing, information for identifying a source of sensing, and/or information (e.g., target identification information, target location information, etc.) on a target associated with the sensing data.

According to an embodiment, sensing data (or sensing information) may be used to generate a sensing result for the target.

According to an embodiment, the sensing result may include information about a distance, a location, and/or a speed (doppler) with respect to the target.

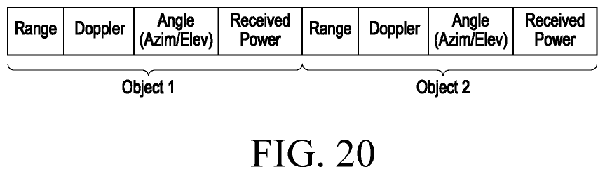

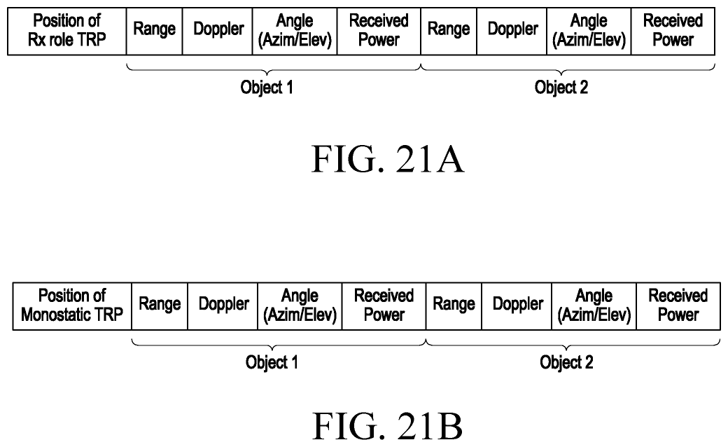

In operation 1720a, the monostatic DU/TRP440 may transmit a report (sensing result report) including the sensing data and/or the sensing result to the SU 410. According to an embodiment, the monostatic TRP 440 may transmit the sensing result report to the SU 410 using a predefined interface (e.g., the F1 interface). As an embodiment, the sensing result report may have the configuration of FIG. 20 or FIG. 21B, but is not limited thereto, and may be various combinations of the above-described sensing data and/or sensing results.

FIG. 17B illustrates a sensing result reporting procedure according to an embodiment of the disclosure.

The sensing result reporting procedure of FIG. 17B may be an example of the sensing result reporting procedure of the base station-level (e.g., gNB-level) monostatic TRP (monostatic base station) in the multistatic sensing structure.

Referring to FIG. 17B, in operation 1710b, the monostatic base station/TRP 440 may perform a sensing operation. According to an embodiment, the monostatic TRP 440 may transmit a sensing signal using a resource (e.g., time/frequency resource) configured/allocated based on sensing configuration information, receive a sensing signal reflected from a target (e.g., objects 1 and 2), and obtain sensing data and/or a sensing result based on the received sensing signal. In an embodiment, the sensing configuration information may include all or some of the information included in FIGS. 9A, 9B, 9C, and/or 9D.

According to an embodiment, the sensing data may include information (sensing information) that may be derived from the reflection signal. According to an embodiment, the sensing information may include information that may be measured from a signal strength, a delay, a timing, an angle of arrival (AoA), a time of flight (ToF), and/or other reflection signals.

According to an embodiment, the sensing data may further include a description of the sensing data, information for identifying a purpose of sensing, information for identifying a source of sensing, and/or information (e.g., target identification information, target location information, etc.) on a target associated with the sensing data.

According to an embodiment, sensing data (or sensing information) may be used to generate a sensing result for the target.

According to an embodiment, the sensing result may include information about a distance, a location, and/or a speed (doppler) with respect to the target.

In operation 1720b, the monostatic base station/TRP440 may transmit a report (sensing result report) including the sensing data and/or the sensing result to the SU 410. According to an embodiment, the monostatic TRP 440 may transmit the sensing result report to the SU 410 using a predefined interface (e.g., the NG interface or X2 interface). As an embodiment, the sensing result report may have the configuration of FIG. 20 or FIG. 21B, but is not limited thereto, and may be various combinations of the above-described sensing data and/or sensing results.

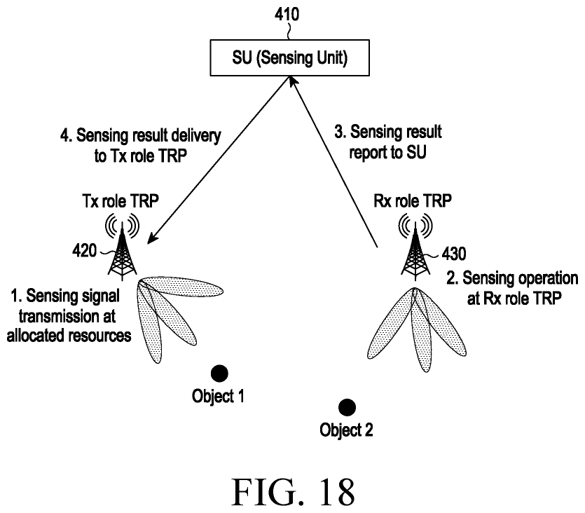

FIG. 18 illustrates a sensing result reporting procedure according to an embodiment of the disclosure.

The sensing result reporting procedure of FIG. 18 may be an example of the sensing result reporting procedure of the reception role TRP in the multistatic sensing structure.

Referring to FIG. 18, in operation 1, the transmission role TRP 420 may transmit a sensing signal using the resource (e.g., time/frequency resource) configured/allocated based on the sensing configuration information. In an embodiment, the sensing configuration information may include all or some of the information included in FIGS. 8A, 8B, 8C, and/or 8D.

In operation 2, the reception role TRP 430 may perform a sensing operation. According to an embodiment, the reception role TRP 430 may receive a sensing signal reflected from a target (e.g., objects 1 and 2) using the time/frequency resource configured based on the sensing configuration information, and obtain sensing data and/or a sensing result based on the received sensing signal.

According to an embodiment, the sensing data may include information (sensing information) that may be derived from the reflection signal. According to an embodiment, the sensing information may include information that may be measured from a signal strength, a delay, a timing, an angle of arrival (AoA), a time of flight (ToF), and/or other reflection signals.

According to an embodiment, the sensing data may further include a description of the sensing data, information for identifying a purpose of sensing, information for identifying a source of sensing, and/or information (e.g., target identification information, target location information, etc.) on a target associated with the sensing data.

According to an embodiment, sensing data (or sensing information) may be used to generate a sensing result for the target.

According to an embodiment, the sensing result may include information about a distance, a location, and/or a speed (doppler) with respect to the target.

In operation 3, the reception TRP 430 may transmit a report (sensing result report) including the sensing data and/or the sensing result to the SU 410.

In operation 4, the SU 410 may transmit the sensing result report to the transmission role TRP 410.

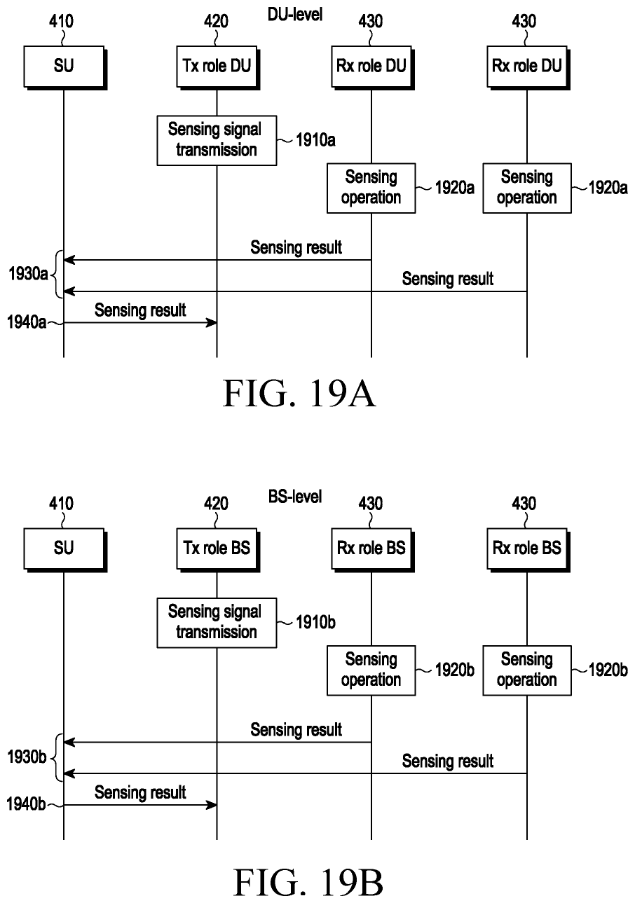

FIG. 19A illustrates a sensing result reporting procedure according to an embodiment of the disclosure.

The sensing result reporting procedure of FIG. 19A may be an example of the sensing result reporting procedure of the DU-level reception role TRP (reception role DU) in the multistatic sensing structure.

Referring to FIG. 19A, in operation 1910a, the transmission role DU/TRP 420 may transmit a sensing signal based on the sensing configuration information. According to an embodiment, the transmission role TRP 420 may transmit a sensing signal using time/frequency resources configured based on the sensing configuration information. In an embodiment, the sensing configuration information may include all or some of the information included in FIGS. 8A, 8B, 8C, and/or 8D.

In operation 1920a, at least one reception role DU/TRP 430 may perform a sensing operation based on the sensing configuration information. According to an embodiment, the reception role TRP 420 may receive a sensing signal reflected from a target (e.g., objects 1 and 2) using the time/frequency resource configured based on the sensing configuration information, and obtain sensing data and/or a sensing result based on the received sensing signal.

According to an embodiment, the sensing data may include information (sensing information) that may be derived from the reflection signal. According to an embodiment, the sensing information may include information that may be measured from a signal strength, a delay, a timing, an angle of arrival (AoA), a time of flight (ToF), and/or other reflection signals.

According to an embodiment, the sensing data may further include a description of the sensing data, information for identifying a purpose of sensing, information for identifying information, etc.) on a target associated with the sensing data.

According to an embodiment, sensing data (or sensing information) may be used to generate a sensing result for the target.

According to an embodiment, the sensing result may include information about a distance, a location, and/or a speed (doppler) with respect to the target.

In operation 1930a, at least one reception role DU/TRP 430 may transmit a report (sensing result report) including the sensing data and/or the sensing result to the SU 410. According to an embodiment, the reception role TRP 430 may transmit the sensing result report to the SU 410 using a predefined interface (e.g., the F1 interface). As an embodiment, the sensing result report may have the configuration of FIG. 20 or FIG. 21A, but is not limited thereto, and may be various combinations of the above-described sensing data and/or sensing results.

In operation 1940a, the SU 410 may transmit a sensing result report to the transmission role DU/TRP 420. According to an embodiment, the SU 410 may transmit the sensing result report to the transmission role TRP 420 using a predefined interface (e.g., the F1 interface).

FIG. 19B illustrates a sensing result reporting procedure according to an embodiment of the disclosure.

The sensing result reporting procedure of FIG. 19B may be an example of the sensing result reporting procedure of the base station-level (e.g., gNB-level) reception role TRP (reception role base station) in the multistatic sensing structure.

Referring to FIG. 19B, in operation 1910b, the transmission role base station/TRP 420 may transmit a sensing signal based on the sensing configuration information. According to an embodiment, the transmission role TRP 420 may transmit a sensing signal using time/frequency resources configured based on the sensing configuration information. In an embodiment, the sensing configuration information may include all or some of the information included in FIGS. 8A, 8B, 8C, and/or 8D.

In operation 1920b, at least one reception role base station/TRP 430 may perform a sensing operation based on the sensing configuration information. According to an embodiment, the reception role TRP 430 may receive a sensing signal reflected from a target (e.g., objects 1 and 2) using the time/frequency resource configured based on the sensing configuration information, and obtain sensing data and/or a sensing result based on the received sensing signal.

According to an embodiment, the sensing data may include information (sensing information) that may be derived from the reflection signal. According to an embodiment, the sensing information may include information that may be measured from a signal strength, a delay, a timing, an angle of arrival (AoA), a time of flight (ToF), and/or other reflection signals.

According to an embodiment, the sensing data may further include a description of the sensing data, information for identifying a purpose of sensing, information for identifying a source of sensing, and/or information (e.g., target identification information, target location information, etc.) on a target associated with the sensing data.

According to an embodiment, sensing data (or sensing information) may be used to generate a sensing result for the target.

According to an embodiment, the sensing result may include information about a distance, a location, and/or a speed (doppler) with respect to the target.

In operation 1930b, at least one reception role base station/TRP 420 may transmit a report (sensing result report) including the sensing data and/or the sensing result to the SU 410. According to an embodiment, the reception role TRP 420 may transmit the sensing result report to the SU 410 using a predefined interface (e.g., the NG interface or X2 interface). As an embodiment, the sensing result report may have the configuration of FIG. 20 or FIG. 21A, but is not limited thereto, and may be various combinations of the above-described sensing data and/or sensing results.

In operation 1940b, the SU 410 may transmit a sensing result report to the transmission role base station/TRP 420. According to an embodiment, the SU 410 may transmit the sensing result report to the transmission role TRP 420 using a predefined interface (e.g., the NG interface or X2 interface).

### [Configuration of Sensing Result Report]

FIG. 20 illustrates a configuration of a sensing result report according to an embodiment of the disclosure.

In an embodiment of FIG. 20, for convenience of description, it is assumed that the sensing result report includes sensing results (or sensing data) for two objects (e.g., objects 1 and 2 of FIG. 15/FIG. 18), but the disclosure is not limited thereto. For example, sensing results for various numbers of objects may be included in the sensing result report.

Further, in the embodiment of FIG. 20, for convenience of description, it is assumed that the sensing results for each object included in the sensing results report include distance information, speed (doppler) information, AoA information, and received power information for the object, but are not limited thereto. For example, various types of sensing information may be included in the sensing result report.

The configuration of the sensing result report of FIG. 20 may be used when cooperative sensing is not applied, but the disclosure is not limited thereto.

Referring to FIG. 20, the sensing result report may include sensing results of at least one object. For example, the sensing result report may include a sensing result for the first object and a sensing result for the second object.

As an embodiment, the sensing result for each object may include distance information about the corresponding object, speed information about the corresponding object, AoA information about the sensing signal reflected from the corresponding object (e.g., AoA azimuth/AoA leveling), and/or received power information about the sensing signal reflected from the corresponding object.

As such, the sensing result report of the embodiment of FIG. 20 may include only relative sensing values (relative metric) (e.g., relative distance, relative position, relative speed).

FIG. 21A illustrates a configuration of a sensing result report according to an embodiment of the disclosure.

In the embodiment of FIG. 21A, for convenience of description, it is assumed that the sensing result report includes sensing results (or sensing data) for two objects (e.g., objects 1 and 2 of FIG. 18), but the disclosure is not limited thereto. For example, sensing results for various numbers of objects may be included in the sensing result report.

Further, in the embodiment of FIG. 21A, for convenience of description, it is assumed that the sensing results for each object included in the sensing results report include distance information, speed (doppler) information, AoA information, and received power information for the object, but are not limited thereto. For example, various types of sensing information may be included in the sensing result report.

The configuration of the sensing result report of FIG. 21A may be used when cooperative sensing is not applied, but the disclosure is not limited thereto.

The configuration of the sensing result report of FIG. 21A may be used by the reception role TRP for bistatic sensing, but the disclosure is not limited thereto. Referring to FIG. 21A, the sensing result report may include position information about the reception role TRP (e.g., the reception role DU of FIG. 19A or the reception role base station of FIG. 19B) that transmits the sensing result report and a sensing result for at least one object. For example, the sensing result report may include the position information about the reception role TRP that transmits the sensing result report, the sensing result for the first object, and the sensing result for the second object.

As an embodiment, the position information about the reception role TRP may be obtained by the reception role TRP based on a preset position acquisition method (e.g., a GPS-based method, etc.).

As an embodiment, the sensing result for each object may include distance information about the corresponding object, speed information about the corresponding object, AoA information about the sensing signal reflected from the corresponding object (e.g., AoA azimuth/AoA leveling), and/or received power information about the sensing signal reflected from the corresponding object.

As described above, compared to the sensing result report of the embodiment of FIG. 20A, the sensing result report of the embodiment of FIG. 21A may further include a position value of the reception role TRP as well as a relative sensing value (relative metric). In this case, the transmission role TRP (e.g., the transmission role DU of FIG. 19A, or the transmission role base station of FIG. 19B) or SU (e.g., the SU of FIG. 19A/19B) may calculate/obtain the absolute sensing value (absolute metric) (e.g., absolute distance, absolute position, absolute speed) for the corresponding object using the relative sensing value for the corresponding object and the positions of the transmission role TRP and the reception role TRP.

FIG. 21B illustrates a configuration of a sensing result report according to an embodiment of the disclosure.

In the embodiment of FIG. 21B, for convenience of description, it is assumed that the sensing result report includes sensing results (or sensing data) for two objects (e.g., objects 1 and 2 of FIG. 15), but the disclosure is not limited thereto. For example, sensing results for various numbers of objects may be included in the sensing result report.

Further, in the embodiment of FIG. 21B, for convenience of description, it is assumed that the sensing results for each object included in the sensing results report include distance information, speed (doppler) information, AoA information, and received power information for the object, but are not limited thereto. For example, various types of sensing information may be included in the sensing result report.

The configuration of the sensing result report of FIG. 21B may be used when cooperative sensing is not applied, but the disclosure is not limited thereto.

The configuration of the sensing result report of FIG. 21B may be used by the monostatic TRP for monostatic sensing, but the disclosure is not limited thereto.

Referring to FIG. 21B, the sensing result report may include position information about the monostatic TRP (e.g., the monostatic DU of FIG. 17A or the monostatic base station of FIG. 17B) that transmits the sensing result report and a sensing result for at least one object. For example, the sensing result report may include the position information about the monostatic TRP that transmits the sensing result report, the sensing result for the first object, and the sensing result for the second object.

As an embodiment, the position information about the monostatic TRP may be obtained by the monostatic TRP based on a preset position acquisition method (e.g., a GPS-based method, etc.).

As an embodiment, the sensing result for each object may include distance information about the corresponding object, speed information about the corresponding object, AoA information about the sensing signal reflected from the corresponding object (e.g., AoA azimuth/AoA leveling), and/or received power information about the sensing signal reflected from the corresponding object.

As described above, compared to the sensing result report of the embodiment of FIG. 20, the sensing result report of the embodiment of FIG. 21B may further include a position value of the monostatic TRP as well as a relative sensing value (relative metric). In this case, the SU (e.g., the SU of FIG. 17A/17B) may calculate/obtain an absolute sensing value (absolute metric) for the corresponding object using the position of the monostatic TRP and the received relative sensing value for the object.

[Sensing Result Reporting Procedure when Cooperative Sensing is Used]

In the multistatic sensing structure, the SU may perform cooperative sensing using the entire sensing result report. Each monostatic TRP and each reception role TRP should transfer the sensing result report to the SU in order to use such cooperative sensing.

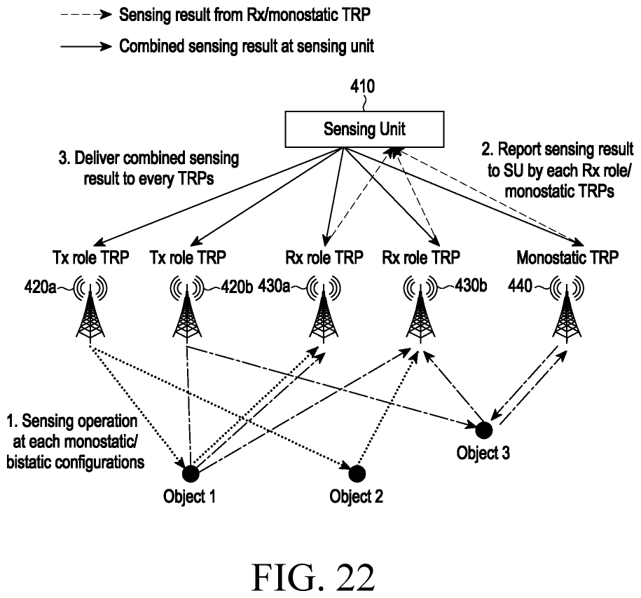

FIG. 22 illustrates a sensing result reporting procedure for cooperative sensing according to an embodiment of the disclosure.

The sensing result reporting procedure of FIG. 22 may be an example of the sensing result reporting procedure of each monostatic TRP and each reception role TRP in the multistatic sensing structure. For example, the sensing result reporting procedure of FIG. 22 may be a combination of the sensing result reporting procedure of FIG. 16 and the sensing result reporting procedure of FIG. 18.

Referring to FIG. 22, in operation 1, each monostatic TRP 440 and each transmission role TRP 420a, b/reception role TRP 430a, b may perform a sensing operation. For example, the monostatic TRP 440 may perform a sensing operation according to the monostatic configuration, and the transmission role TRP 420a, b/reception role TRP 430a, b may perform a sensing operation according to the bistatic configuration. For the description of the sensing operation of the monostatic TRP 440, the description of FIGS. 16 to 17A/B may be referred to and, for the description of the sensing operation of the transmission role TRPs 420a, b/the reception role TRPs 430a, b, the description of FIGS. 18 to 19A/B may be referred to.

in operation 2, each monostatic TRP 440 and each reception role TRP 430a, b may transmit its own sensing result report to the SU. For example, the first reception role TRP 430a may transmit a sensing result report including the sensing data and/or sensing result for object 1 to the SU 410, the second reception role TRP 430b may transmit a sensing result report including the sensing data and/or sensing result for object 1, object 2, and object 3 to the SU 410, and the monostatic TRP 440 may transmit a sensing result report including the sensing data and/or sensing result for object 3 to the SU 410. For the description of the sensing result report of the monostatic TRP 440, the description of FIGS. 16 to 17A/B may be referred to and, for the description of the sensing result report of the reception role TRP 430a, b, the description of FIGS. 18 to 19A/B may be referred to.

In operation 3, the SU 410 may generate a combined sensing result using the received sensing result report. The SU 430 may transmit the combined sensing result to all of the TRPs 420a, 420b, 430a, 430b, and 440. The sensing result report for reporting the combined sensing result may have a configuration of FIG. 20, 21A, 21B, or a combination thereof. For example, the sensing result report including the combined sensing result may include position information about the monostatic TRP 440, position information about the first reception role TRP 430a, position information about the second reception role TRP 430b, the sensing result for object 1, the sensing result for object 2, and/or the sensing result for object 3.

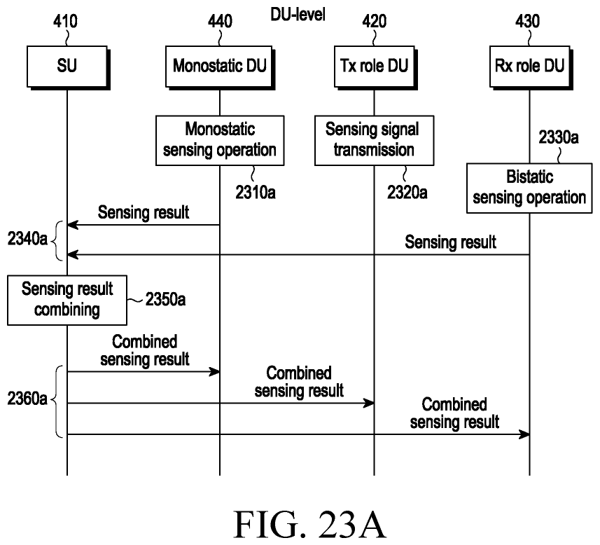

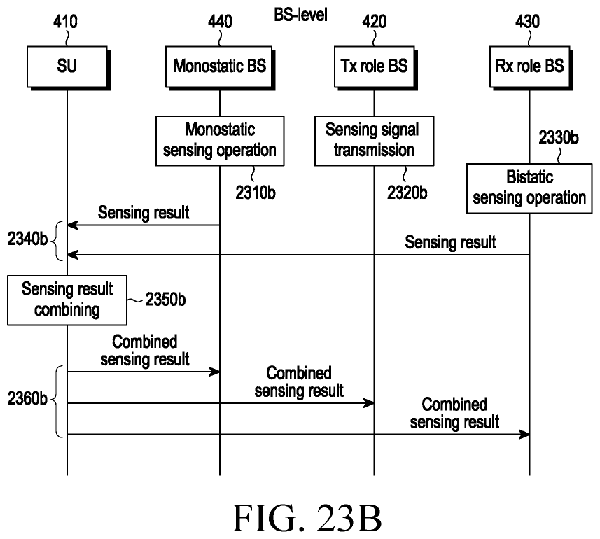

FIG. 23A illustrates a sensing result reporting procedure according to an embodiment of the disclosure.

The sensing result reporting procedure of FIG. 23A may be an example of the sensing result reporting procedure of the DU-level monostatic TRP (monostatic DU) and the reception role TRP (reception role DU) in the multistatic sensing structure.

Referring to FIG. 23A, in operation 2310a, the monostatic DU/TRP 440 may perform a sensing operation. For a description of the sensing operation of the monostatic TRP 440, the description of FIG. 17A may be referred to.

In operation 2320a, the transmission role DU/TRP 420 may transmit a sensing signal based on the sensing configuration information. For the description of the sensing signal transmission operation of the transmission role TRP 420, the description of FIG. 19A may be referred to.

In operation 2330a, at least one reception role DU/TRP 430 may perform a sensing operation based on the sensing configuration information. For the description of the sensing signal transmission operation of the reception role TRP 430, the description of FIG. 19A may be referred to.

In operation 2340a, the monostatic DU/TRP 440 may transmit a sensing result report to the SU 410. For a description of the sensing result reporting operation of the monostatic TRP 440, the description of FIG. 17A may be referred to.

In operation 2350a, the reception role DU/TRP 430 may transmit a sensing result report to the SU 410. For a description of the sensing result reporting operation of the monostatic TRP 440, the description of FIG. 19A may be referred to.

In operation 2360a, the SU 410 may generate a combined sensing result using the received sensing result report. The sensing result report for reporting the combined sensing result may have a configuration of FIG. 20, 21A, 21B, or a combination thereof.

In operation 2370a, the SU 410 may transmit the combined sensing result to the monostatic DU/TRP 440, the transmission role DU/TRP 420, and the reception role DU/TRP 430.

FIG. 23B illustrates a sensing result reporting procedure according to an embodiment of the disclosure.

The sensing result reporting procedure of FIG. 23B may illustrate an example of a sensing result reporting procedure of a base station-level (e.g., gNB-level) monostatic TRP (monostatic DU) and a reception role TRP (reception role DU) in a multistatic sensing structure.

Referring to FIG. 23B, in operation 2310B, the monostatic base station/TRP 440 may perform a sensing operation. For a description of the sensing operation of the monostatic TRP 440, the description of FIG. 17B may be referred to.

In operation 2320b, the transmission role base station/TRP 420 may transmit a sensing signal based on sensing configuration information. For the description of the sensing signal transmission operation of the transmission role TRP 420, the description of FIG. 19B may be referred to.

In operation 2330b, at least one reception role base station/TRP 430 may perform a sensing operation based on sensing configuration information. For the description of the sensing signal transmission operation of the reception role TRP 430, the description of FIG. 19B may be referred to.

In operation 2340b, the monostatic base station/TRP 440 may transmit a sensing result report to the SU 410. For a description of the sensing result reporting operation of the monostatic TRP 440, the description of FIG. 17B may be referred to.

In operation 2350b, the reception role base station/TRP 430 may transmit a sensing result report to the SU 410. For a description of the sensing result reporting operation of the monostatic TRP 440, the description of FIG. 19B may be referred to.

In operation 2360b, the SU 410 may generate a combined sensing result using the received sensing result report. The sensing result report for reporting the combined sensing result may have a configuration of FIG. 20, 21A, 21B, or a combination thereof.

In operation 2370b, the SU 410 may transmit the combined sensing result to the monostatic base station/TRP 440, the transmission role base station/TRP 420, and the reception role base station/TRP 430.

### [The Operation of the UE in the JCAS System]

Hereinafter, the operation (e.g., a communication operation) of the UE in the JCAS system having the multistatic sensing structure is described.

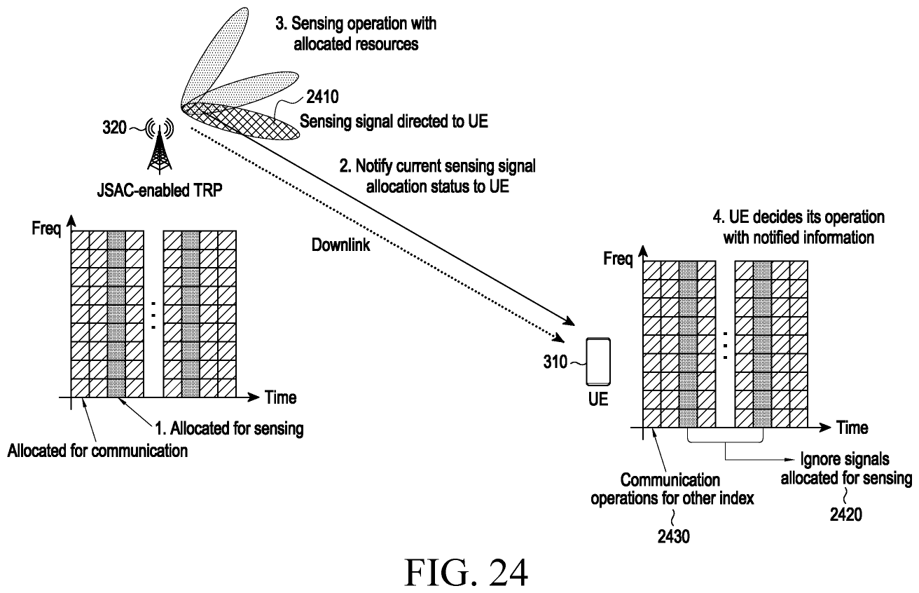

FIG. 24 is a view illustrating a downlink (DL) communication operation of a UE in a JCAS system according to an embodiment of the disclosure.

In the case of the JCAS system, in order to perform sensing together with communication, the base station or SU needs to allocate resources for sensing and resources for communication, and provide a notification of the allocated resources to the UE 310 through the TRP. In this case, unlike in a general communication system (e.g., the communication system 10 of FIG. 1), the UE 310 needs to perform an operation different from the existing communication operation in a resource area (or section) for notified sensing.

Hereinafter, the DL communication operation of the UE in the JCAS system is exemplarily described with reference to FIG. 24.

Referring to FIG. 24, in operation 1, the TRP (e.g., the transmission role TRP 420 or reception role TRP 430 or monostatic TRP 440) may identify resources allocated for sensing. For example, the TRP may identify time and frequency resources allocated for sensing (or sensing signals).

As an embodiment, the resource for sensing may be allocated by the SU 410, and the transmission role TRP 420, the reception role TRP 430, and the monostatic TRP 440 may be notified thereof.

Further, the TRP (e.g., the transmission role TRP 410 or reception role TRP 420 or monostatic TRP 440) may identify the resources allocated for communication. For example, the TRP may identify time and frequency resources allocated for communication (or communication signals). As illustrated in FIG. 24, resources allocated for sensing and resources allocated for communication may not overlap.

As an embodiment, the resources for communication may be allocated by the SU 410, and the transmission role TRP 420, the reception role TRP 430, and the monostatic TRP 440 may be notified thereof.

In operation 2, the TRP (e.g., the transmission role TRP 410 or the reception role TRP 420 or the monostatic TRP 440) may transmit sensing configuration information including information (sensing resource allocation information) about resource allocation for sensing to the UE 310. As an embodiment, the sensing resource allocation information may include information about time and frequency resources for sensing (or sensing signals) identified in operation 1. Accordingly, the UE 310 may be notified of a current sensing signal allocation status for the sensing signal.

According to an embodiment, the TRP (e.g., the transmission role TRP 410 or the reception role TRP 420, or the monostatic TRP 440) may transmit, to the UE 310, the communication configuration information including the information (DL communication resource allocation information) about resource allocation for DL communication, together with or separately from the sensing configuration information. According to an embodiment, the communication resource allocation information may include information about the time and frequency resources for the communication (or communication signals) identified in operation 1. Accordingly, the UE 310 may be notified of the current resource allocation status for the communication signal.

In operation 3, the TRP (e.g., the transmission role TRP 410 or the reception role TRP 420 or the monostatic TRP 440) may perform a sensing operation using resources (e.g., time and frequency resources) allocated for sensing.

According to an embodiment, the transmission role TRP 420 may transmit a sensing signal using the time and frequency resources allocated for sensing. As an embodiment, the transmission role TRP 420 may transmit a sensing signal through at least one beam. For example, the transmission role TRP 420 may transmit a sensing signal directed to the UE 310 through the beam 2410 directed toward the UE 310.

According to an embodiment, the reception role TRP 430 may receive a reflection (reflection signal) of a sensing signal reflected from a target (e.g., the UE 310, or the target 330 of FIG. 3) and obtain sensing data and/or a sensing result based on the reflection signal.

According to an embodiment, the monostatic TRP 440 may transmit a sensing signal using the time and frequency resources allocated for sensing, receive a reflection (reflection signal) of the sensing signal reflected from the target (e.g., the UE 310, or the target 330 of FIG. 3), and obtain sensing data and/or a sensing result based on the reflection signal. As an embodiment, the monostatic TRP 440 may transmit the sensing signal through at least one beam. For example, the monostatic TRP 440 may transmit a sensing signal directed to the UE 310 through the beam 2410 directed toward the UE 310.

According to an embodiment, the TRP (e.g., the transmission role TRP 410 or the reception role TRP 420 or the monostatic TRP 440) may perform a communication operation using resources (e.g., time and frequency resources) allocated for communication. For example, the TRP may transmit a communication signal (DL communication signal) through the PDSCH using the time and frequency resources allocated for communication. According to an embodiment, the TRP may transmit a DL communication signal through at least one beam.

In operation 4, the UE 310 may determine an operation to be performed using the received/notified information (e.g., sensing resource allocation information and sensing configuration information). For example, the UE 310 may identify the time and frequency resources allocated for sensing based on the sensing resource allocation information, and may perform an operation based on the identified time and frequency resources.

According to an embodiment, the UE 310 may disregard signals received through time and frequency resources allocated for sensing (2420).

According to an embodiment, the UE 310 may perform a communication operation using time and frequency resources other than the time and frequency resources allocated for sensing (2430). For example, the UE 310 may receive a communication signal (DL communication signal) through the PDSCH using the time and frequency resources allocated for DL communication different from the time and frequency resources allocated for sensing. For example, the UE 310 may receive the DL communication signal in the OFDM symbol(s) having the OFDM index allocated for DL communication, which is different from the index of the OFDM symbol allocated for sensing.

Meanwhile, according to an embodiment, some of the above-described operations 1 to 4 may be omitted, and/or additional operations may be further performed. Further, the operations may be performed in a different order from the illustrated order, or multiple operations may be performed simultaneously.

Meanwhile, in FIG. 24, for convenience of description, a procedure between the TRP 320 and one UE 310 has been described as an example, but embodiments are not limited thereto. For example, a plurality of UEs may be connected to the TRP 320, and in this case, each UE may perform the same procedure as the procedure between the TRP 320 and the UE 310 with the TRP 320.

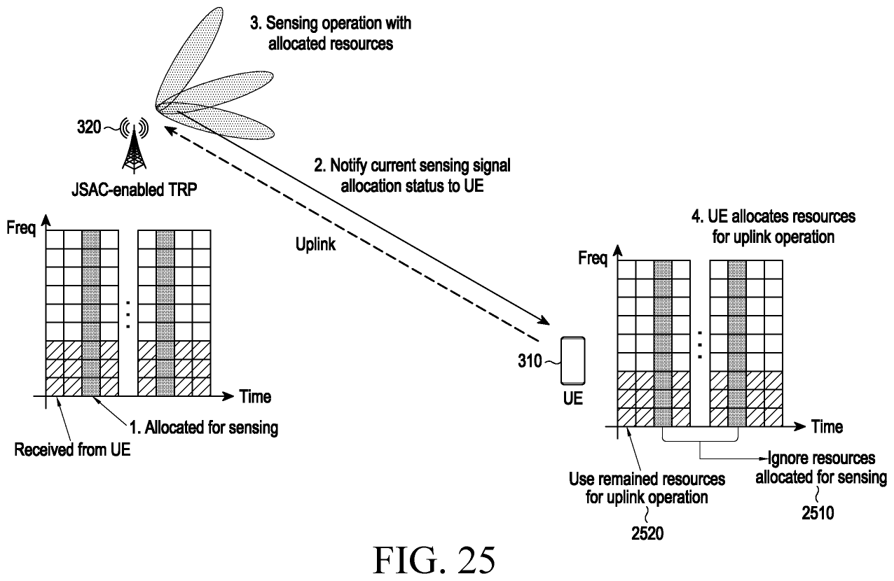

FIG. 25 is a view illustrating an uplink (UL) communication operation of a UE in a JCAS system according to an embodiment of the disclosure.

In the case of the JCAS system, in order to perform sensing together with communication, the base station or SU needs to allocate a resource for sensing and a resource for communication and provide a notification of the allocated resource to the UE 310 through the TRP. In this case, unlike in a general communication system (e.g., the communication system 10 of FIG. 1), the UE 310 needs to perform an operation different from the existing communication operation in a resource area (or section) for notified sensing.

Hereinafter, a UL communication operation of a UE in a JCAS system is exemplarily described with reference to FIG. 25.

Referring to FIG. 25, in operation 1, the TRP (e.g., the transmission role TRP 420 or reception role TRP 430 or monostatic TRP 440) may identify resources allocated for sensing. For example, the TRP may identify time and frequency resources allocated for sensing (or sensing signals).

As an embodiment, the resource for sensing may be allocated by the SU 410, and the transmission role TRP 420, the reception role TRP 430, and the monostatic TRP 440 may be notified thereof.

Further, the TRP (e.g., the transmission role TRP 420 or reception role TRP 430 or monostatic TRP 440) may identify the resources allocated for communication. For example, the TRP may identify time and frequency resources for communication (or communication signals). As illustrated in FIG. 25, resources allocated for sensing and resources allocated for communication may not overlap.

As an embodiment, the resources for communication may be allocated by the SU 410, and the transmission role TRP 420, the reception role TRP 430, and the monostatic TRP 440 may be notified thereof.

In operation 2, the TRP (e.g., the transmission role TRP 420 or the reception role TRP 430 or the monostatic TRP 440) may transmit sensing configuration information including information (sensing resource allocation information) about resource allocation for sensing to the UE 310. As an embodiment, the sensing resource allocation information may include information about time and frequency resources for sensing (or sensing signals) identified in operation 1. Accordingly, the UE 310 may be notified of a current sensing signal allocation status for the sensing signal.

According to an embodiment, the TRP (e.g., the transmission role TRP 420 or the reception role TRP 430) may transmit, to the UE 310, the communication configuration information including the information (UL communication resource allocation information) about resource allocation for UL communication, together with or separately from the sensing configuration information. According to an embodiment, the UL communication resource allocation information may include information about the time and frequency resources for the communication (or communication signals) identified in operation 1. Accordingly, the UE 310 may be notified of the current resource allocation status for the communication signal.

In operation 3, the TRP (e.g., the transmission role TRP 420 or the reception role TRP 430 or the monostatic TRP 440) may perform a sensing operation using resources (e.g., time and frequency resources) allocated for sensing.

According to an embodiment, the transmission role TRP 420 may transmit a sensing signal using the time and frequency resources allocated for sensing. As an embodiment, the transmission role TRP 420 may transmit a sensing signal through at least one beam. For example, the transmission role TRP 420 may transmit a sensing signal directed to the UE 310 through the beam directed toward the UE 310.

According to an embodiment, the reception role TRP 430 may receive a reflection (reflection signal) of a sensing signal reflected from a target (e.g., the UE 310, or the target 330 of FIG. 3, or the monostatic TRP 440) and obtain sensing data and/or a sensing result based on the reflection signal.

According to an embodiment, the monostatic TRP 440 may transmit a sensing signal using the time and frequency resources allocated for sensing, receive a reflection (reflection signal) of the sensing signal reflected from the target (e.g., the UE 310, or the target 330 of FIG. 3), and obtain sensing data and/or a sensing result based on the reflection signal. As an embodiment, the monostatic TRP 440 may transmit the sensing signal through at least one beam. For example, the monostatic TRP 440 may transmit a sensing signal directed to the UE 310 through the beam 2410 directed toward the UE 310.

According to an embodiment, the TRP (e.g., the transmission role TRP 420 or the reception role TRP 430 or the monostatic TRP 440) may perform a communication operation using resources (e.g., time and frequency resources) allocated for communication. For example, the TRP may receive a communication signal (UL communication signal) through the PUSCH using the time and frequency resources allocated for UL communication. According to an embodiment, the TRP may receive a UL communication signal through at least one beam.

In operation 4, the UE 310 may determine an operation to be performed using the received/notified information (e.g., sensing resource allocation information and sensing configuration information). For example, the UE 310 may perform an operation based on sensing resource allocation information.

According to an embodiment, the UE 310 may disregard sensing signals received through time and frequency resources allocated for sensing (2510).

According to an embodiment, the UE 310 may perform a communication operation using time and frequency resources other than the time and frequency resources allocated for sensing (2520). For example, the UE 310 may transmit a communication signal (UL communication signal) using the time and frequency resources allocated for UL communication, different from the time and frequency resources allocated for sensing. For example, the UE 310 may transmit the UL communication signal in the OFDM symbol(s) having the OFDM index allocated for UL communication, which is different from the index of the OFDM symbol allocated for sensing.

Meanwhile, according to an embodiment, some of the above-described operations 1 to 4 may be omitted, and/or additional operations may be further performed. Further, the operations may be performed in a different order from the illustrated order, or multiple operations may be performed simultaneously.

Meanwhile, in FIG. 25, for convenience of description, a procedure between the TRP 320 and one UE 310 has been described as an example, but embodiments are not limited thereto. For example, a plurality of UEs may be connected to the TRP 320, and in this case, each UE may perform the same procedure as the procedure between the TRP 320 and the UE 310 with the TRP 320.

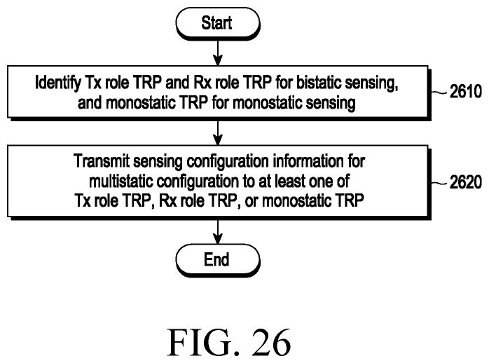

FIG. 26 illustrates a method of a sensing unit according to an embodiment of the disclosure.

In the disclosure, the sensing unit may also be referred to as a sensing management entity.

Referring to FIG. 26, the sensing unit (or sensing management entity) may identify a transmission role TRP and a reception role TRP for bistatic sensing, and a monostatic TRP for monostatic sensing (2610).

The sensing unit (or sensing management entity) may transmit sensing configuration information for monostatic configuration to at least one of the transmission role TRP, the reception role TRP, or the monostatic TRP (2610).

According to an embodiment, the sensing configuration information may include role information for the sensing and information about resource allocation for the sensing.

According to an embodiment, the role information may include at least one of information indicating whether the TRP is the transmission role TRP, information indicating whether the TRP is the reception role TRP, or information indicating whether the TRP is the monostatic TRP.

According to an embodiment, the information about resource allocation for sensing may include information for time resource allocation for sensing and information for frequency resource allocation for sensing, and the information for frequency resource allocation may designate continuous frequencies for sensing.

According to an embodiment, the information for frequency resource allocation may include start RE index information indicating the index of the start resource element (RE) and end RE index information indicating the index of the end RE, for the continuous frequencies.

According to an embodiment, it is possible to transmit second sensing configuration information based on the sensing configuration information to a UE by the transmission role TRP, the reception role TRP, and the monostatic TRP in response to receiving the sensing configuration information. As an embodiment, the second sensing information may include the whole or part of information included in the sensing configuration information. As an embodiment, the second sensing information may be information (e.g., set ID information or sensing parameter bitmap) generated based on the sensing configuration information.

According to an embodiment, the sensing configuration information may further include information about a transmission period of the sensing signal and information about a transmission offset where the sensing signal is transmitted within the transmission period. The transmission period and the transmission offset may be set on a per-slot basis.

According to an embodiment, the information about the transmission offset may be set to a different value for the transmission role TRP and the monostatic TRP.

According to an embodiment, the information about resource allocation for the sensing, the information about the transmission period of the sensing signal, and the information about the transmission offset may be set to the same value for each of the transmission role TRP and the monostatic TRP. A sensing sequence of the transmission role TRP may be set to a different sensing sequence from a sensing sequence of the monostatic TRP.

According to an embodiment, the sensing configuration information may further include transmission TRP ID information including an ID of the transmission role TRP and an ID of the monostatic TRP, associated bistatic transmission TRP information including a list of at least one transmission role TRP associated with the reception role TRP, and sensing sequence information indicating a type of the sensing sequence.

According to an embodiment, the sensing sequence information may further include seed set information including a set of seeds used for generating the sensing sequence.

According to an embodiment, the sensing unit (or the sensing management entity) may receive a sensing result report from the reception role TRP, and transmit the sensing result report to the at least one transmission role TRP associated with the reception role TRP.

According to an embodiment, the sensing unit (or sensing management entity) may receive a first sensing result report from the reception role TRP and receive a second sensing result report from the monostatic TRP, generate a combined result report based on the first sensing result report and the second sensing result report, and transmit the combined result report to the reception role TRP, the at least one transmission role TRP associated with the reception role TRP, and the monostatic TRP.

According to an embodiment, when the transmission role TRP, the reception role TRP, and the monostatic TRP are distribute unit (DU)-level TRPs, the sensing management entity may correspond to a central unit (CU) controlling a DU corresponding to the transmission role TRP, a DU corresponding to the reception role TRP, and a DU corresponding to the monostatic TRP.

In an embodiment, when the transmission role TRP, the reception role TRP and the monostatic TRP are base station-level TRPs, the sensing management entity may be an entity over a core network connected to a base station corresponding to the transmission role TRP, a base station corresponding to the reception role TRP, and a base station corresponding to the monostatic TRP, and the entity over the core network may be an access and mobility management function (AMF) entity or a network function (NF) entity defined for the sensing.

According to an embodiment, at least one of the transmission role TRP and the monostatic TRP may periodically transmit a sensing signal from a time when the sensing configuration information is transmitted, based on information about the transmission period and information about the transmission offset.

According to an embodiment, when a preset condition is met, the sensing unit (or the sensing management entity) may transmit a stop trigger to terminate the periodic transmission of the sensing signal to the transmission role TRP, the reception role TRP and the monostatic TRP. The transmission role TRP, the reception role TRP and the monostatic TRP may transmit the received stop trigger to the UE.

According to an embodiment, the preset condition may be met when all sensing operations related to the multistatic configuration are terminated, when some sensing operations related to the multistatic configuration are terminated, or when the sensing configuration information is changed, and the sensing operations may be operations of the monostatic sensing or operations of the bistatic sensing.

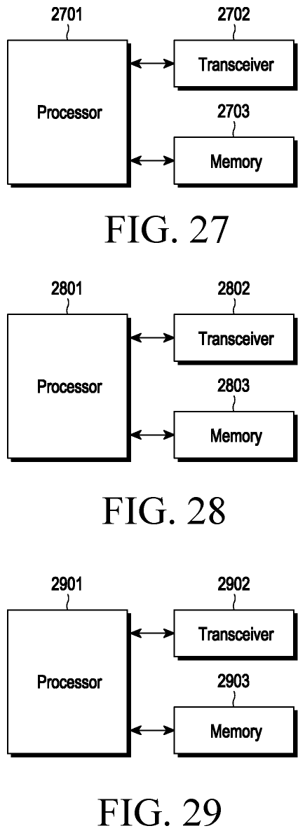

FIG. 27 is a view illustrating an example configuration of a UE according to an embodiment of the disclosure.

In FIG. 27, a UE may include a processor 2701, a transceiver 2702, and memory 2703. The processor 2701, transceiver 2702, and memory 2703 of the UE of FIG. 7 may be operated according to the method(s) described above in connection with FIGS. 1 to 26. However, the components of the UE are not limited thereto. For example, the UE may include more or fewer components than the above-described components. The processor 2701, the transceiver 2702, and the memory 2703 may be implemented in the form of at least one chip.

The transceiver 2702 collectively refers to a receiver and a transmitter and may transmit and receive signals to/from a UE or another network entity. The transmitted/received signals may include at least one of control information and data. To that end, the transceiver 2702 may include an RF transmitter for frequency-up converting and amplifying signals transmitted and an RF receiver for low-noise amplifying signals received and frequency-down converting the frequency of the received signals. This is merely an embodiment of the transceiver 2702, and the components of the transceiver 2702 are not limited to the RF transmitter and the RF receiver. Further, the transceiver 2702 may receive signals through a communication scheme defined in the 3GPP standard, output the signals to the processor 2701, and transmit the signals output from the processor 2701. Further, the transceiver 2702 may receive the signal and output it to the processor 2701 and transmit the signal output from the processor 2701 to another network entity through the network.

The memory 2703 may store programs and data necessary for the operation of the UE according to at least one of the embodiments of FIGS. 1 to 26. The memory 2703 may store control information and/or data that is included in the signal obtained by the UE. The memory 2703 may include a storage medium, such as ROM, RAM, hard disk, CD-ROM, and DVD, or a combination of storage media.

The processor 2701 may control a series of processes so that the UE may operate according to at least one of the embodiments of FIGS. 1 to 26. The processor 2701 may include at least one processor.

FIG. 28 is a view illustrating an example configuration of a base station according to an embodiment of the disclosure.

In FIG. 28, a base station may include a processor 2801, a transceiver 2802, and memory 2803. The processor 2801, transceiver 2802, and memory 2803 of the base station may be operated according to the method(s) described above in connection with FIGS. 1 to 26. However, the components of the base station are not limited thereto. For example, the base station may include more or fewer components than the above-described components. The processor 2801, the transceiver 2802, and the memory 2803 may be implemented in the form of at least one chip.

The transceiver 2802 collectively refers to a receiver and a transmitter and may transmit and receive signals to/from a UE or another network entity. The transmitted/received signals may include at least one of control information and data. To that end, the transceiver 2802 may include an RF transmitter for frequency-up converting and amplifying signals transmitted and an RF receiver for low-noise amplifying signals received and frequency-down converting the frequency of the received signals. This is merely an embodiment of the transceiver 2802, and the components of the transceiver 2802 are not limited to the RF transmitter and the RF receiver. Further, the transceiver 2802 may receive signals through a communication scheme defined in the 3GPP standard, output the signals to the processor 2801, and transmit the signals output from the processor 2801. Further, the transceiver 2802 may receive the signal and output it to the processor 2801 and transmit the signal output from the processor 2801 to another network entity through the network.

The memory 2803 may store programs and data necessary for the operation of the base station according to at least one of the embodiments of FIGS. 1 to 26. The memory 2803 may store control information and/or data that is included in the signal obtained by the base station. The memory 2803 may include a storage medium, such as ROM, RAM, hard disk, CD-ROM, and DVD, or a combination of storage media.

The processor 2801 may control a series of processes so that the base station may operate according to at least one of the embodiments of FIGS. 1 to 26. The processor 2801 may include at least one processor.

FIG. 29 is a view illustrating an example configuration of a sensing unit according to an embodiment of the disclosure.

In FIG. 29, a sensing unit may include a processor 2901, a transceiver 2902, and memory 2903. The processor 2901, transceiver 2902, and memory 2903 of the sensor unit may be operated according to the method(s) described above in connection with FIGS. 1 to 26. However, the components of the sensing unit are not limited thereto. For example, the sensing unit may include more or fewer components than the above-described components. The processor 2901, the transceiver 2902, and the memory 2903 may be implemented in the form of at least one chip.

The transceiver 2902 collectively refers to a receiver and a transmitter and may transmit and receive signals to/from a UE or another network entity. The transmitted/received signals may include at least one of control information and data. To that end, the transceiver 2902 may include an RF transmitter for frequency-up converting and amplifying signals transmitted and an RF receiver for low-noise amplifying signals received and frequency-down converting the frequency of the received signals. This is merely an embodiment of the transceiver 2902, and the components of the transceiver 2902 are not limited to the RF transmitter and the RF receiver. Further, the transceiver 2902 may receive signals through a communication scheme defined in the 3GPP standard, output the signals to the processor 2901, and transmit the signals output from the processor 2901. Further, the transceiver 2902 may receive the signal and output it to the processor 2901 and transmit the signal output from the processor 2901 to another network entity through the network.

The memory 2903 may store programs and data necessary for the operation of the sensing unit according to at least one of the embodiments of FIGS. 1 to 26. Further, the memory 2903 may store control information and/or data that is included in the signal obtained by the sensing unit. The memory 2903 may include a storage medium, such as ROM, RAM, hard disk, CD-ROM, and DVD, or a combination of storage media.

The processor 2901 may control a series of processes so that the sensing unit may operate according to at least one of the embodiments of FIGS. 1 to 26. The processor 2901 may include at least one processor.

In the above-described specific embodiments, the components included in the disclosure are represented in singular or plural forms depending on specific embodiments proposed. However, the singular or plural forms are selected to be adequate for contexts suggested for ease of description, and the disclosure is not limited to singular or plural components. As used herein, the singular forms “a,” “an,” and “the” are intended to include the plural forms as well, unless the context clearly indicates otherwise.

Although specific embodiments of the present invention have been described above, various changes may be made thereto without departing from the scope of the present invention. Thus, the scope of the disclosure should not be limited to the above-described embodiments, and should rather be defined by the following claims and equivalents thereof.

1. A method of a sensing management entity in a system supporting communication and sensing, the method comprising:
identifying a transmission role transmission and reception point (TRP) and a reception role TRP for a bistatic sensing operation, and a monostatic TRP for a monostatic sensing operation; and
transmitting, to at least one of the transmission role TRP, the reception role TRP, or the monostatic TRP, sensing configuration information for configuring a multistatic sensing operation,
wherein the sensing configuration information includes role information for the sensing and information on resource allocation for the sensing.

2. The method of claim 1, wherein the role information includes at least one of:
information indicating whether the TRP is the transmission role TRP, information indicating whether the TRP is the reception role TRP, or information indicating whether the TRP is the monostatic TRP.

3. The method of claim 1, further comprising:
in response to receiving the sensing configuration information, transmitting, to a UE, second sensing configuration information based on the sensing configuration information by the transmission role TRP, the reception role TRP, and the monostatic TRP.

4. The method of claim 1, wherein the sensing configuration information further includes information on a transmission period of a sensing signal, and information on a transmission offset at which the sensing signal is transmitted within the transmission period, and
wherein the transmission period and the transmission offset are set in slot units.

5. The method of claim 4, wherein the information on resource allocation for the sensing, the information on the transmission period of the sensing signal, and the information on the transmission offset are set to the same value for each of the transmission role TRP and the monostatic TRP, and
wherein a sensing sequence of the transmission role TRP is set to a different sensing sequence from a sensing sequence of the monostatic TRP.

6. The method of claim 5, wherein the sensing configuration information further includes at least one of:
transmission TRP identifier (ID) information including an ID of the transmission role TRP and an ID of the monostatic TRP, associated bistatic transmission TRP information including a list of at least one transmission role TRP associated with the reception role TRP, and sensing sequence information indicating a type of the sensing sequence.

7. The method of claim 6, further comprising:
receiving, from the reception role TRP, a sensing result report; and
transmitting, to the at least one transmission role TRP associated with the reception role TRP, the sensing result report.

8. The method of claim 6, further comprising:
receiving, from the reception role TRP, a first sensing result report and receiving, from the monostatic TRP, a second sensing result report;
generating a combined result report based on the first sensing result report and the second sensing result report; and
transmitting, to the reception role TRP, the at least one transmission role TRP associated with the reception role TRP, and the monostatic TRP, the combined result report.

9. A sensing management entity in a system supporting communication and sensing, comprising:
a transceiver; and
at least one processor, wherein the at least one processor is configured to:
identify a transmission role transmission and reception point (TRP) and a reception role TRP for a bistatic sensing operation, and a monostatic TRP for a monostatic sensing operation, and
transmit, to at least one of the transmission role TRP, the reception role TRP, or the monostatic TRP, sensing configuration information for configuring a multistatic sensing operation,
wherein the sensing configuration information includes role information for the sensing and information on resource allocation for the sensing.

10. The sensing management entity of claim 9, wherein the role information includes at least one of information indicating whether the TRP is the transmission role TRP, information indicating whether the TRP is the reception role TRP, or information indicating whether the TRP is the monostatic TRP.

11. The sensing management entity of claim 9, further comprising transmitting, to a UE, second sensing configuration information based on the sensing configuration information by the transmission role TRP, the reception role TRP, and the monostatic TRP in response to receiving the sensing configuration information.

12. The sensing management entity of claim 9, wherein the sensing configuration information further includes information on a transmission period of a sensing signal, and information on a transmission offset at which the sensing signal is transmitted within the transmission period, and
wherein the transmission period and the transmission offset are set in slot units.

13. The sensing management entity of claim 12, wherein the information on resource allocation for the sensing, the information on the transmission period of the sensing signal, and the information on the transmission offset are set to the same value for each of the transmission role TRP and the monostatic TRP, and
wherein a sensing sequence of the transmission role TRP is set to a different sensing sequence from a sensing sequence of the monostatic TRP.

14. The sensing management entity of claim 13, wherein the sensing configuration information further includes at least one of:
transmission TRP identifier (ID) information including an ID of the transmission role TRP and an ID of the monostatic TRP, associated bistatic transmission TRP information including a list of at least one transmission role TRP associated with the reception role TRP, and sensing sequence information indicating a type of the sensing sequence.

15. The sensing management entity of claim 14, wherein the at least one processor is configured to:
receive, from the reception role TRP, a sensing result report,
transmit, to the at least one transmission role TRP associated with the reception role TRP the sensing result report,
receive, from the reception role TRP, a first sensing result report and receiving, from the monostatic TRP, a second sensing result report,
generate a combined result report based on the first sensing result report and the second sensing result report, and
transmit, to the reception role TRP, the at least one transmission role TRP associated with the reception role TRP, and the monostatic TRP, the combined result report.
